(19) United States
(12) Patent Application Publication
(10) Pub. No.: US 2012/0147472 A1
(43) Pub. Date: Jun. 14, 2012

(54) CONDUCTIVE OPTICAL DEVICE, PRODUCTION METHOD THEREFOR, TOUCH PANEL DEVICE, DISPLAY DEVICE, AND LIQUID CRYSTAL DISPLAY APPARATUS

(75) Inventors: Shunichi Kajiya, Miyagi (JP); Masaki Takenouchi, Miyagi (JP); Sohmei Endoh, Miyagi (JP); Kazuya Hayashibe, Miyagi (JP); Kiyohiro Kimura, Miyagi (JP)

(73) Assignee: SONY CORPORATION, Tokyo (JP)

(21) Appl. No.: 13/126,828

(22) PCT Filed: Aug. 26, 2010
(86) PCT No.: PCT/JP2010/005252

§ 371 Date: Jul. 8, 2011

(30) Foreign Application Priority Data
Sep. 2, 2009 (JP) 2009-203180
Dec. 28, 2009 (JP) 2009-299004
Apr. 28, 2010 (JP) 2010-104619

(51) Int. Cl. G02B 1/11; B32B 3/30; B32B 15/00; B29D 11/00

(52) U.S. Cl. 359/601; 264/1.6; 428/156; 428/172

(57) ABSTRACT

A conductive optical device includes a base member and a transparent conductive film formed on the base member. A surface structure of the transparent conductive film includes a plurality of convex portions having antireflective properties and arranged at a pitch equal to or smaller than a wavelength of visible light.

### CROSS REFERENCES TO RELATED APPLICATIONS

The present application is a National Stage of International Application No. PCT/JP2010/005252 filed on Aug. 26, 2010 and which claims priority to Japanese Patent Application JP 2009-203180 filed on Sep. 2, 2009, Japanese Patent Application JP 2009-299004 filed on Dec. 28, 2009, and Japanese Patent Application JP 2010-104619 filed on Apr. 28, 2010, the entire content of which is hereby incorporated by reference.

### BACKGROUND

The present disclosure relates to a conductive optical device, a production method therefor, a touch panel, a display apparatus, and a liquid crystal display apparatus, more particularly, to a conductive optical device on a main surface of which a transparent conductive layer is formed.

In recent years, a resistance-film-type touch panel for inputting information is attached to a display apparatus such as a liquid crystal display device that is equipped in a mobile apparatus, a cellular phone, and the like.

The resistance-film-type touch panel has a structure in which two transparent electroconductive films are provided opposed to each other via a spacer formed of an insulation material such as an acrylic resin. The transparent electroconductive film functions as an electrode of the touch panel and includes a base material having a transparency, such as a polymer film, and a transparent conductive layer that is formed on the base material and formed of a material having a high refractive index (e.g., about 1.9 to 2.1), such as ITO (Indium Tin Oxide).

The transparent electroconductive film for the resistance-film-type touch panel is required to have a desired surface resistance value of, for example, about 300Ω/□ to 500Ω/□. Moreover, the transparent electroconductive film is required to have a high transmittance for avoiding deterioration of a display quality of the display apparatus such as a liquid crystal display device to which the resistance-film-type touch panel is attached.

For realizing a desired surface resistance value, the transparent conductive layer constituting the transparent electroconductive film needs to be as thick as about 20 nm to 30 nm, for example. However, if the transparent conductive layer formed of a material having a high refractive index is thickened, an amount of reflection of external light at an interface between the transparent conductive layer and the base material increases, and a transmittance of the transparent electroconductive film is lowered, thus resulting in a problem that a quality of the display apparatus is deteriorated.

To solve this, Japanese Patent Application Laid-open No. 2003-136625 (hereinafter, referred to as Patent Document 1), for example, discloses a transparent electroconductive film for a touch panel in which an antireflection film is provided between a base material and a transparent conductive layer. The antireflection film is formed by sequentially laminating a plurality of dielectric films having different refractive indices.

### CITATION LIST

### Patent Literature

[PTL 1]

Japanese Patent Application Laid-open No. 2003-136625.

### SUMMARY

However, since a reflection function of the antireflection film has a wavelength dependency in the transparent electroconductive film of Patent Document 1, a wavelength dispersion is caused in a transmittance of the transparent electroconductive film, thus making it difficult to realize a high transmittance in a wide wavelength range.

Therefore, there is a need for a conductive optical device, a production method therefor, a touch panel, a display apparatus, and a liquid crystal display apparatus that have excellent antireflection characteristics.

In an embodiment, a conductive optical device includes a base member and a transparent conductive film formed on the base member. A surface structure of the transparent conductive film includes a plurality of convex portions having antireflective properties and arranged at a pitch equal to or smaller than a wavelength of visible light.

In an embodiment, a touch panel device includes a first conductive base layer, and a second conductive base layer opposed to the first conductive base layer. In this embodiment, at least one of the first conductive base layer and the second conductive base layer includes a base member, and a transparent conductive film formed on the base member, a surface structure of the transparent conductive film including a plurality of convex structures having antireflective properties and arranged at a pitch equal to or smaller than a wavelength of visible light.

In another embodiment, a display device includes a display apparatus, and a touch panel device attached to the display apparatus. The touch panel device includes a first conductive base layer, and a second conductive base layer opposed to the first conductive base layer. At least one of the first conductive base layer and the second conductive base layer includes a base member, and a transparent conductive film formed on the base member. A surface structure of the transparent conductive film includes a plurality of convex structures having antireflective properties and arranged at a pitch equal to or smaller than a wavelength of visible light.

In one embodiment, a method of producing a conductive optical device includes forming a base member including a plurality of convex structures, and forming a transparent conductive film on the base member such that a surface structure of the transparent conductive film includes a plurality of convex portions corresponding to the convex structures of the base member. The convex structures have antireflective properties and arranged at a pitch equal to or smaller than a wavelength of visible light.

In an embodiment a transparent conductive film in provided including a surface structure including a plurality of convex portions having antireflective properties and arranged at a pitch equal to or smaller than a wavelength of visible light.

When the structures form a tetragonal lattice pattern or a quasi-tetragonal lattice pattern on the surface of the substrate, it is desirable for the structures to have an elliptic cone shape or an elliptic cone trapezoid shape that has a long-axis direction in the extension direction of the tracks and in which a tilt at a center portion is sharper than those at a tip end portion and a bottom portion. With such a configuration, antireflection characteristics and transmission characteristics can be improved.

When the structures form a tetragonal lattice pattern or a quasi-tetragonal lattice pattern on the surface of the substrate, it is desirable for the height or depth of each of the structures in a 45-degree direction or approximately 45-degree direction with respect to the tracks to be smaller than a height or depth of each of the structures in the row direction of the tracks. When such a relationship is not satisfied, the arrangement pitch in the 45-degree direction or approximately 45-degree direction with respect to the tracks needs to be elongated. As a result, a filling rate of the structures in the 45-degree direction or approximately 45-degree direction with respect to the tracks is lowered. Lowering of the filling rate as described above leads to deterioration of antireflection characteristics.

As described above, according to the embodiments, a conductive optical device having excellent antireflection characteristics can be realized.

Additional features and advantages are described herein, and will be apparent from the following Detailed Description and the figures.

### BRIEF DESCRIPTION OF FIGURES

FIG. 1A is a schematic plan view showing a structural example of a conductive optical device according to a first embodiment. FIG. 1B is a partially-enlarged plan view of the conductive optical device shown in FIG. 1A. FIG. 1C is a cross-sectional diagram of tracks T1, T3, . . . of FIG. 1B. FIG. 1D is a cross-sectional diagram of tracks T2, T4, . . . of FIG. 1B. FIG. 1E is a schematic diagram showing a modulation waveform of laser light used for forming latent images corresponding to the tracks T1, T3, . . . of FIG. 1B. FIG. 1F is a schematic diagram showing a modulation waveform of laser light used for forming latent images corresponding to the tracks T2, T4, . . . of FIG. 1B.

FIG. 2 is a partially-enlarged perspective view of the conductive optical device shown in FIG. 1A.

FIG. 3A is a cross-sectional diagram of the conductive optical device shown in FIG. 1A in a track extension direction. FIG. 3B is a cross-sectional diagram of the conductive optical device shown in FIG. 1A in a θ direction.

FIG. 4 is a partially-enlarged perspective view of the conductive optical device shown in FIG. 1A.

FIG. 5 is a partially-enlarged perspective view of the conductive optical device shown in FIG. 1A.

FIG. 6 is a partially-enlarged perspective view of the conductive optical device shown in FIG. 1A.

FIG. 7 is a diagram for explaining a method of setting a structure bottom surface in a case where boundaries among structures are unclear.

FIGS. 8A to 8D are diagrams each showing a bottom surface configuration at a time an ellipticity of the bottom surface of the structure is changed.

FIG. 9A is a diagram showing an arrangement example of the structures each having a cone shape or a cone trapezoid shape. FIG. 9B is a diagram showing an arrangement example of the structures each having an elliptic cone shape or an elliptic cone trapezoid shape.

FIG. 10A is a perspective view showing a structural example of a roll master for producing a conductive optical device. FIG. 10B is a partially-enlarged plan view of the roll master shown in FIG. 10A.

FIG. 11 is a schematic diagram showing a structural example of a roll matrix exposure apparatus.

FIGS. 12A to 12C are process diagrams for explaining a method of producing a conductive optical device according to the first embodiment.

FIGS. 13A to 13C are process diagrams for explaining the method of producing a conductive optical device according to the first embodiment.

FIGS. 14A and 14B are process diagrams for explaining the method of producing a conductive optical device according to the first embodiment.

FIG. 15A is a schematic plan view showing a structural example of a conductive optical device according to a second embodiment. FIG. 15B is a partially-enlarged plan view of the conductive optical device shown in FIG. 15A. FIG. 15C is a cross-sectional diagram of tracks T1, T3, . . . of FIG. 15B. FIG. 15D is a cross-sectional diagram of tracks T2, T4, . . . of FIG. 15B. FIG. 15E is a schematic diagram showing a modulation waveform of laser light used for forming latent images corresponding to the tracks T1, T3, . . . of FIG. 15B. FIG. 15F is a schematic diagram showing a modulation waveform of laser light used for forming latent images corresponding to the tracks T2, T4, . . . of FIG. 15B.

FIG. 16 is a diagram showing a bottom surface configuration at a time an ellipticity of bottom surfaces of structures is changed.

FIG. 17A is a perspective view showing a structural example of a roll master for producing a conductive optical device. FIG. 17B is a partially-enlarged plan view of the roll master shown in FIG. 17A.

FIG. 18A is a schematic plan view showing a structural example of a conductive optical device according to a third embodiment. FIG. 18B is a partially-enlarged plan view of the conductive optical device shown in FIG. 18A. FIG. 18C is a cross-sectional diagram of tracks T1, T3, . . . of FIG. 18B. FIG. 18D is a cross-sectional diagram of tracks T2, T4, . . . of FIG. 18B.

FIG. 19A is a plan view showing a structural example of a disc master for producing a conductive optical device. FIG. 19B is a partially-enlarged plan view of the disc master shown in FIG. 19A.

FIG. 20 is a schematic diagram sowing a structural example of a disc matrix exposure apparatus.

FIG. 21A is a schematic plan view showing a structural example of a conductive optical device according to a fourth embodiment. FIG. 21B is a partially-enlarged plan view showing the conductive optical device shown in FIG. 21A.

FIG. 22A is a schematic plan view showing a structural example of a conductive optical device according to a fifth embodiment. FIG. 22B is a partially-enlarged plan view of the conductive optical device shown in FIG. 22A. FIG. 22C is a cross-sectional diagram of tracks T1, T3, . . . of FIG. 22B. FIG. 22D is a cross-sectional diagram of tracks T2, T4, . . . of FIG. 22B.

FIG. 23 is a partially-enlarged perspective view of the conductive optical device shown in FIG. 22A.

FIG. 24A is a schematic plan view showing a structural example of a conductive optical device according to a sixth embodiment. FIG. 24B is a partially-enlarged plan view of the conductive optical device shown in FIG. 24A. FIG. 24C is a cross-sectional diagram of tracks T1, T3, . . . of FIG. 24B. FIG. 24D is a cross-sectional diagram of tracks T2, T4, . . . of FIG. 24B.

FIG. 25 is a partially-enlarged perspective view of the conductive optical device shown in FIG. 24A.

FIG. 26 is a graph showing an example of a refractive index profile of the conductive optical device according to the sixth embodiment.

FIG. 27 is a cross-sectional diagram showing an example of a structure configuration.

FIGS. 28A to 28C are diagrams for explaining a definition of a change point.

FIG. 29 is a cross-sectional diagram showing a structural example of a conductive optical device according to a seventh embodiment.

FIG. 30 is a cross-sectional diagram showing a structural example of a conductive optical device according to an eighth embodiment.

FIG. 31A is a cross-sectional diagram showing a structural example of a touch panel according to a ninth embodiment. FIG. 31B is a cross-sectional diagram showing a modified example of the structure of the touch panel according to the ninth embodiment.

FIG. 32A is a perspective view showing a structural example of a touch panel according to a tenth embodiment. FIG. 32B is a cross-sectional diagram showing an example of the structure of the touch panel according to the tenth embodiment.

FIG. 33A is a perspective view showing a structural example of a touch panel according to an eleventh embodiment. FIG. 33B is a cross-sectional diagram showing an example of the structure of the touch panel according to the eleventh embodiment.

FIG. 34 is a cross-sectional diagram showing a structural example of a touch panel according to a twelfth embodiment.

FIG. 35 is a cross-sectional diagram showing a structural example of a liquid crystal display apparatus according to a thirteenth embodiment.

FIG. 36A is a cross-sectional diagram showing a first example of a structure of a touch panel according to a fourteenth embodiment. FIG. 36B is a cross-sectional diagram showing a second example of the structure of the touch panel according to the fourteenth embodiment.

FIG. 37A is a graph showing reflection characteristics in Examples 1 to 3 and Comparative Examples 1 and 2. FIG. 37B is a graph showing transmission characteristics in Examples 1 to 3 and Comparative Examples 1 and 2.

FIG. 38A is a graph showing a relationship between an aspect ratio and a surface resistance in Examples 4 to 7. FIG. 38B is a graph showing a relationship between a structure height and the surface resistance in Examples 4 to 7.

FIG. 39A is a graph showing transmission characteristics in Examples 4 to 7. FIG. 39B is a graph showing reflection characteristics in Examples 4 to 7.

FIG. 40A is a graph showing transmission characteristics in Examples 4 and 6. FIG. 40B is a graph showing reflection characteristics in Examples 4 and 6.

FIG. 41A is a graph showing transmission characteristics in Examples 3 and 4. FIG. 41B is a graph showing reflection characteristics in Examples 3 and 4.

FIG. 42A is a graph showing transmission characteristics in Examples 8 to 10 and Comparative Example 6. FIG. 42B is a graph showing reflection characteristics in Examples 8 to 10 and Comparative Example 6.

FIG. 43 is a graph showing transmission characteristics in Examples 11 and 12 and Comparative Examples 7 to 9.

FIG. 44A is a graph showing transmission characteristics of conductive optical sheets in Examples 13 and 14. FIG. 44B is a graph showing reflection characteristics of the conductive optical sheets in Examples 13 and 14.

FIG. 45A is a graph showing reflection characteristics in Example 15 and Comparative Example 10. FIG. 45B is a graph showing reflection characteristics in Example 16 and Comparative Example 11.

FIG. 46A is a graph showing reflection characteristics in Example 17 and Comparative Example 12. FIG. 46B is a graph showing reflection characteristics in Example 18 and Comparative Example 13.

FIG. 47A is a diagram for explaining a filling rate at a time the structures are arranged in a hexagonal lattice pattern. FIG. 47B is a diagram for explaining the filling rate at a time the structures are arranged in a tetragonal lattice pattern.

FIG. 48 is a graph showing a simulation result of Experiment Example 3.

FIG. 49A is a perspective view showing a structure of a resistance-film-type touch panel of Comparative Example 14. FIG. 49B is a cross-sectional diagram showing the structure of the resistance-film-type touch panel of Comparative Example 14.

FIG. 50A is a perspective view showing a structure of a resistance-film-type touch panel of Comparative Example 15. FIG. 50B is a cross-sectional diagram showing the structure of the resistance-film-type touch panel of Comparative Example 15.

FIG. 51A is a perspective view showing a structure of a resistance-film-type touch panel of Comparative Example 16. FIG. 49B is a cross-sectional diagram showing the structure of the resistance-film-type touch panel of Comparative Example 16.

FIG. 52A is a perspective view showing a structure of a resistance-film-type touch panel of Example 19. FIG. 52B is a cross-sectional diagram showing the structure of the resistance-film-type touch panel of Example 19.

FIG. 53A is a perspective view showing a structure of a resistance-film-type touch panel of Example 20. FIG. 53B is a cross-sectional diagram showing the structure of the resistance-film-type touch panel of Example 20.

FIG. 54A is a perspective view showing a structure of a resistance-film-type touch panel of Example 21. FIG. 54B is a cross-sectional diagram showing the structure of the resistance-film-type touch panel of Example 21.

FIG. 55A is a perspective view showing a structure of a resistance-film-type touch panel of Example 22. FIG. 55B is a cross-sectional diagram showing the structure of the resistance-film-type touch panel of Example 22.

FIG. 56 is a graph showing reflection characteristics of the resistance-film-type touch panels of Examples 19 and 20 and Comparative Example 15.

FIG. 57 is a schematic diagram for explaining a method of obtaining mean film thicknesses Dm1, Dm2, and Dm3 of the transparent conductive layer formed on the structures each as a convex portion.

### DETAILED DESCRIPTION

Hereinafter, embodiments will be described in the following order with reference to the drawings.

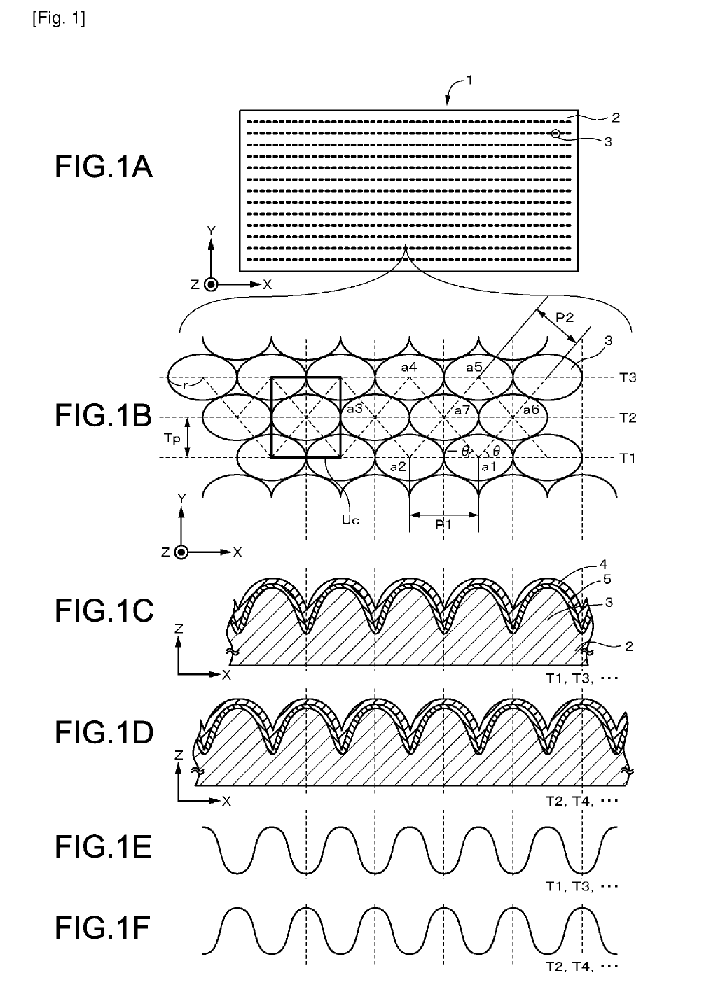

1. First embodiment (example in which structures are arranged linearly and two-dimensionally in hexagonal lattice pattern: see FIG. 1)

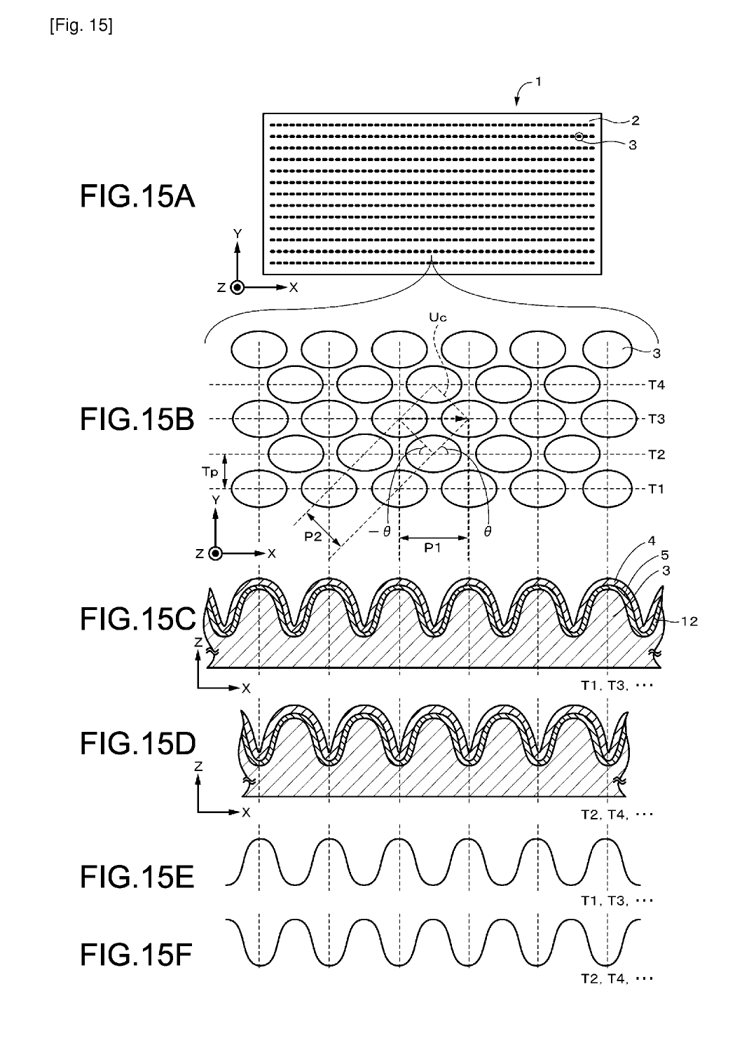

2. Second embodiment (example in which structures are arranged linearly and two-dimensionally in tetragonal lattice pattern: see FIG. 15)

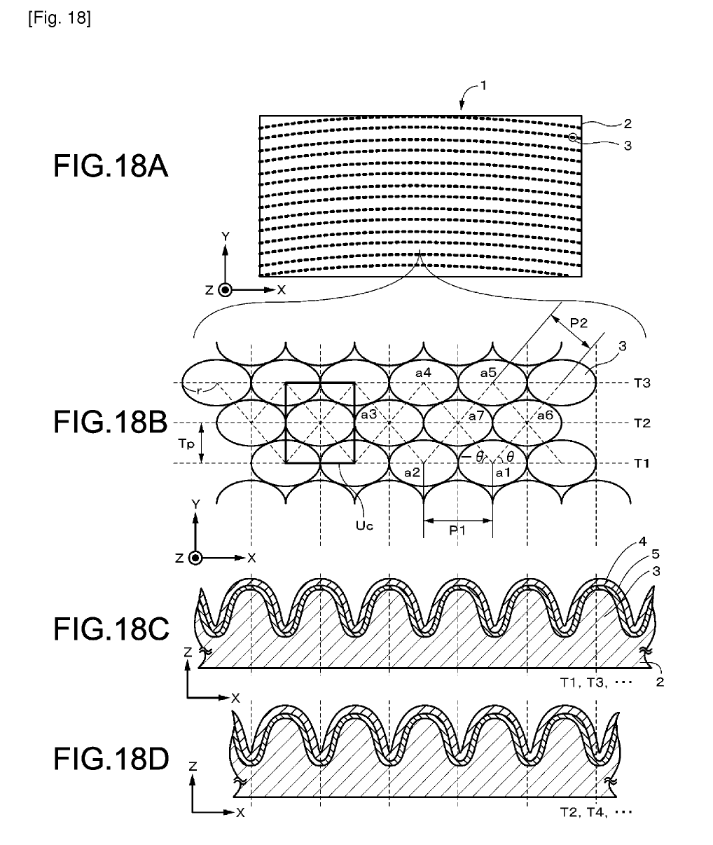

3. Third embodiment (example in which structures are arranged two-dimensionally in arc and in hexagonal lattice pattern: see FIG. 18)

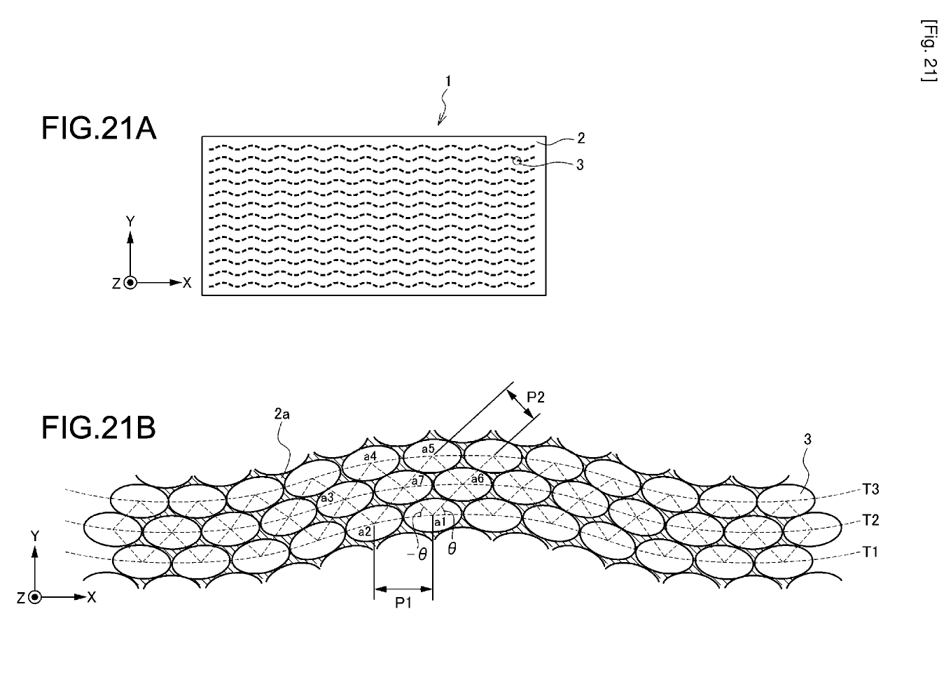

4. Fourth embodiment (example in which structures are arranged meanderingly: see FIG. 21)

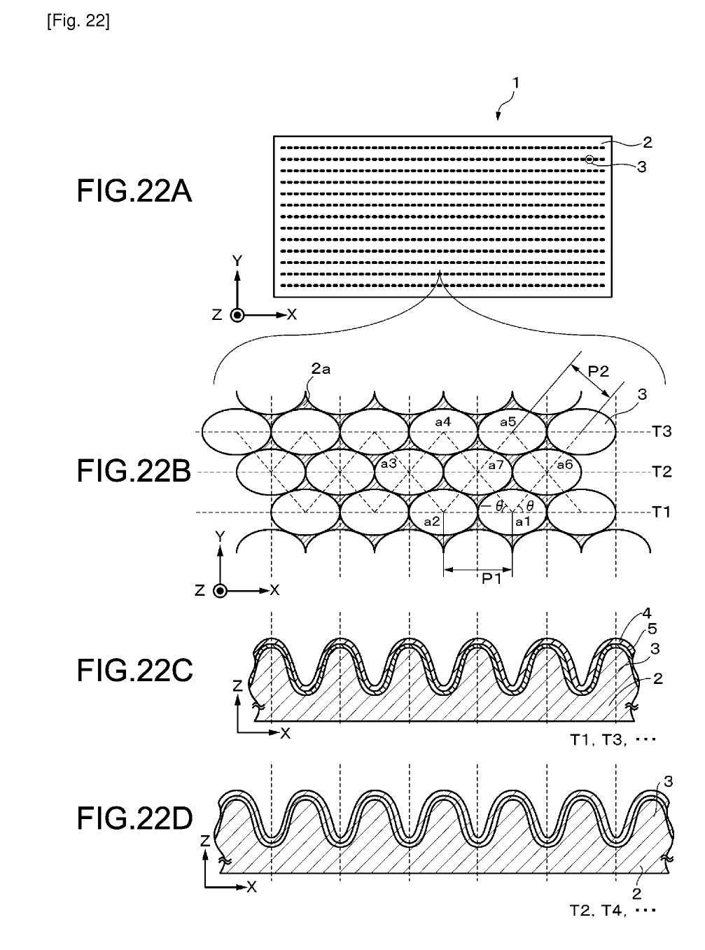

5. Fifth embodiment (example in which convex structures are arranged on substrate surface: see FIG. 22)

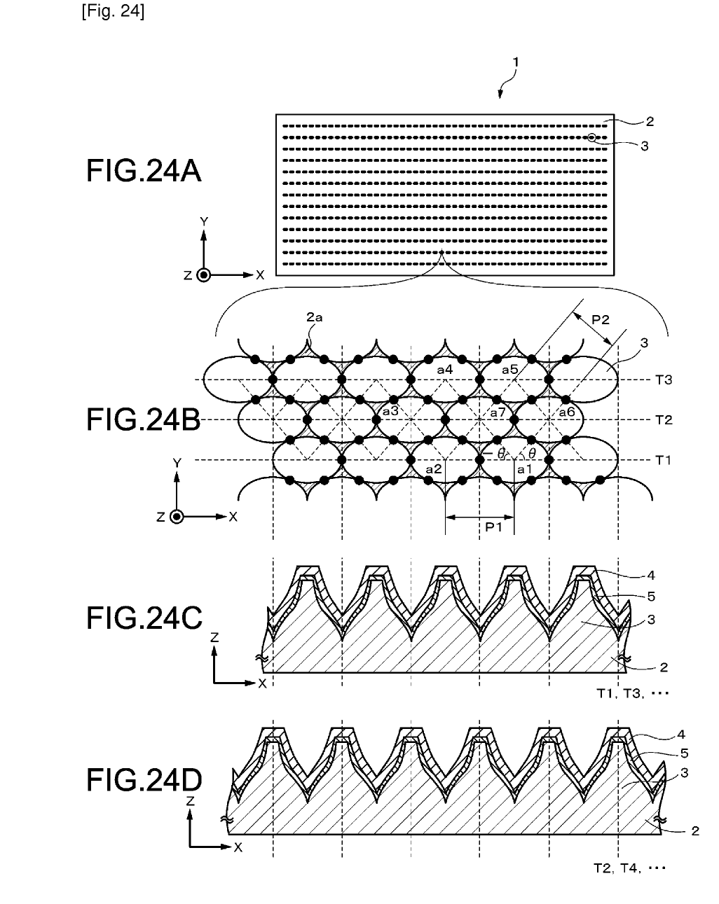

6. Sixth embodiment (example in which refractive index profile is S-shaped: see FIG. 24)

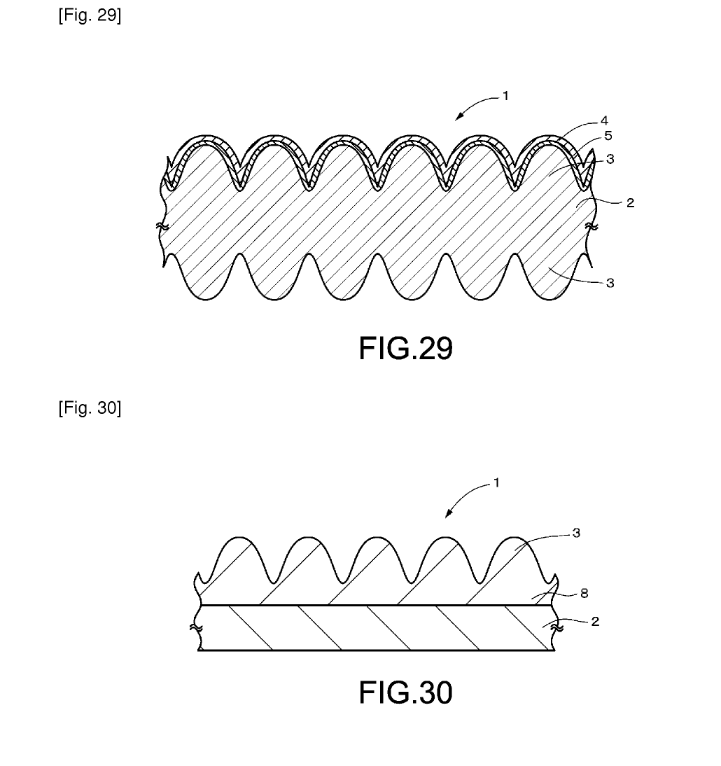

7. Seventh embodiment (example in which structures are formed on both main surfaces of conductive optical device: see FIG. 29)

8. Eighth embodiment (example in which structures having transparent electrical conductivity are arranged on transparent conductive layer: see FIG. 30)

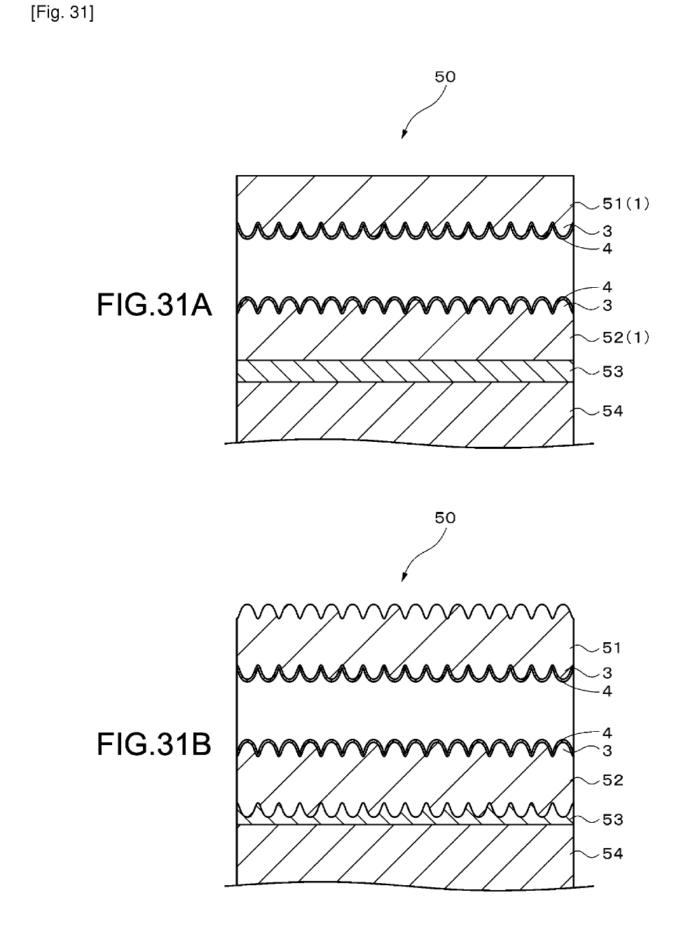

9. Ninth embodiment (application example with respect to resistance-film-type touch panel: see FIG. 31)

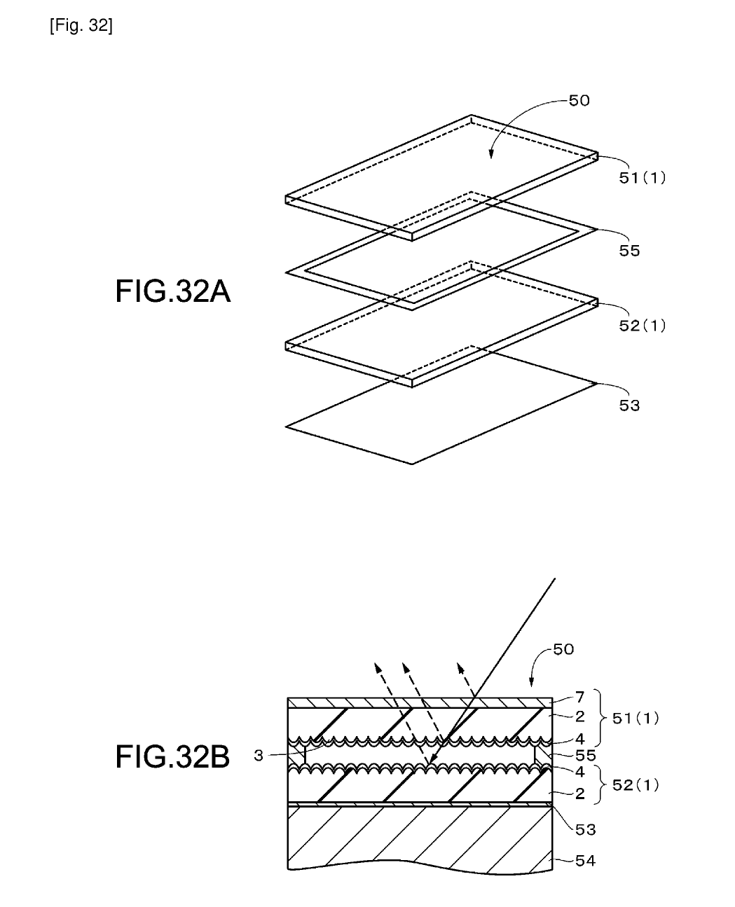

10. Tenth embodiment (example in which hard coat layer is formed on touch surface of touch panel: see FIG. 32)

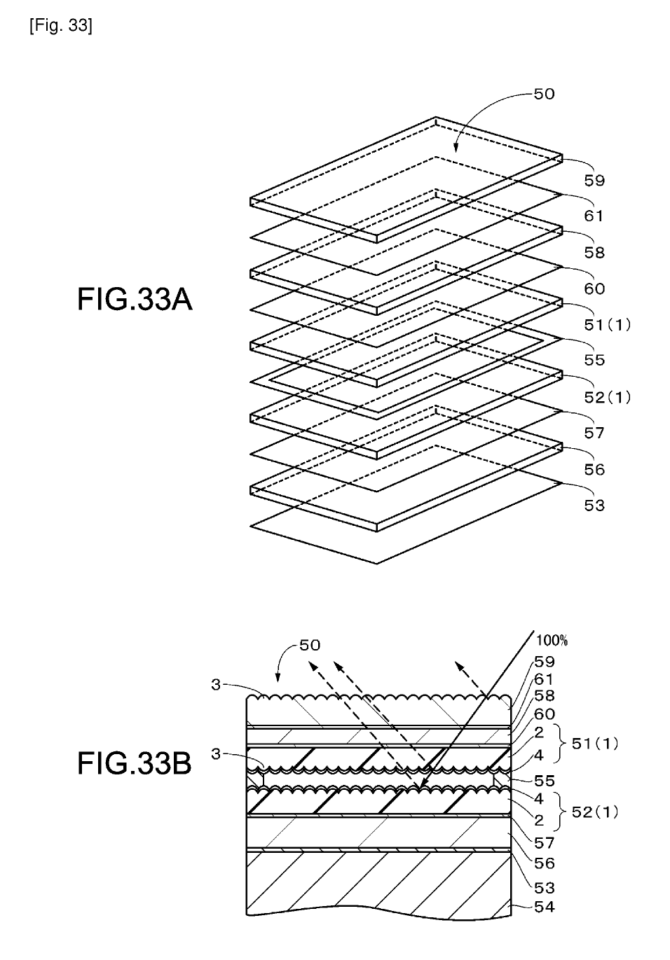

11. Eleventh embodiment (example in which polarizer or front panel is formed on touch surface of touch panel: see FIG. 33)

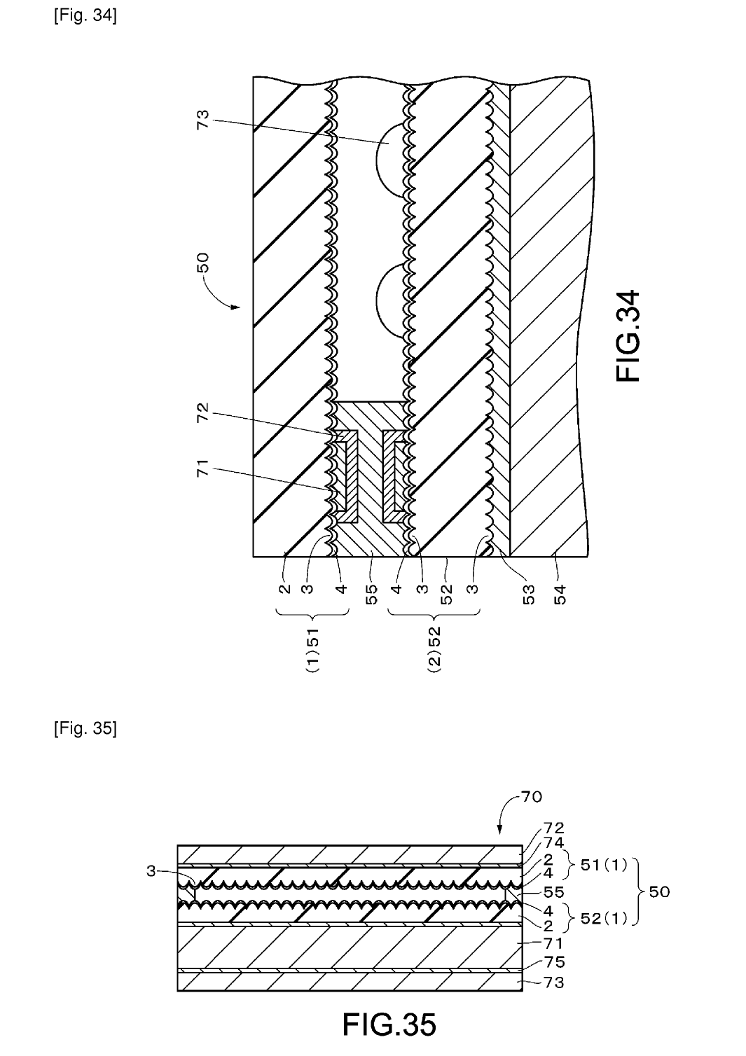

12. Twelfth embodiment (example in which structures are arranged at peripheral portion of touch panel: see FIG. 34)

13. Thirteenth embodiment (example of inner touch panel: see FIG. 35)

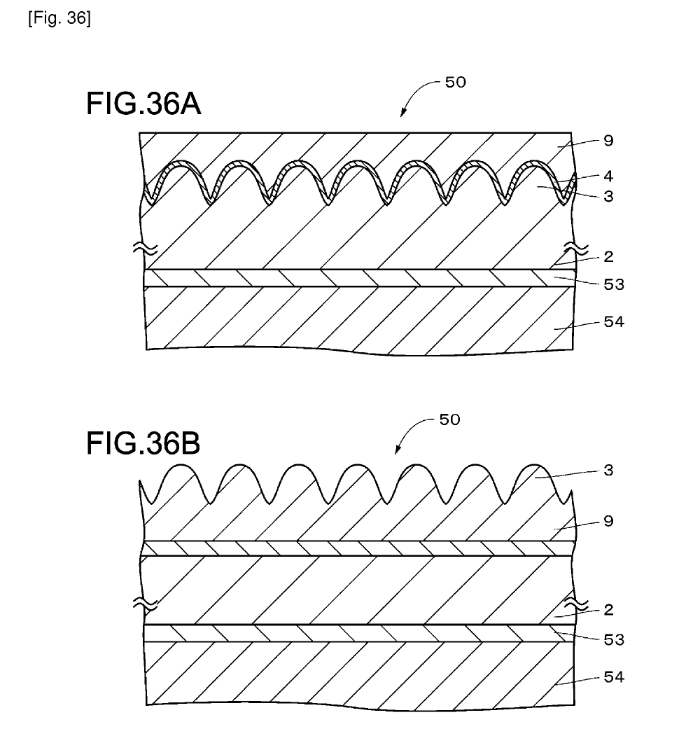

14. Fourteenth embodiment (application example with respect to capacitance-type touch panel: see FIG. 36)

### 1. First Embodiment

(Structure of Conductive Optical Device)

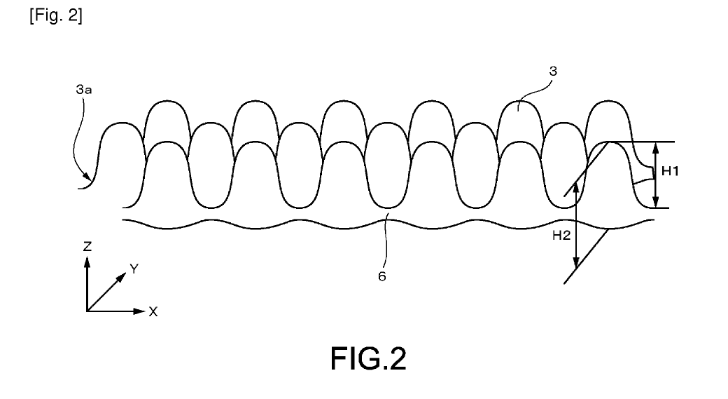

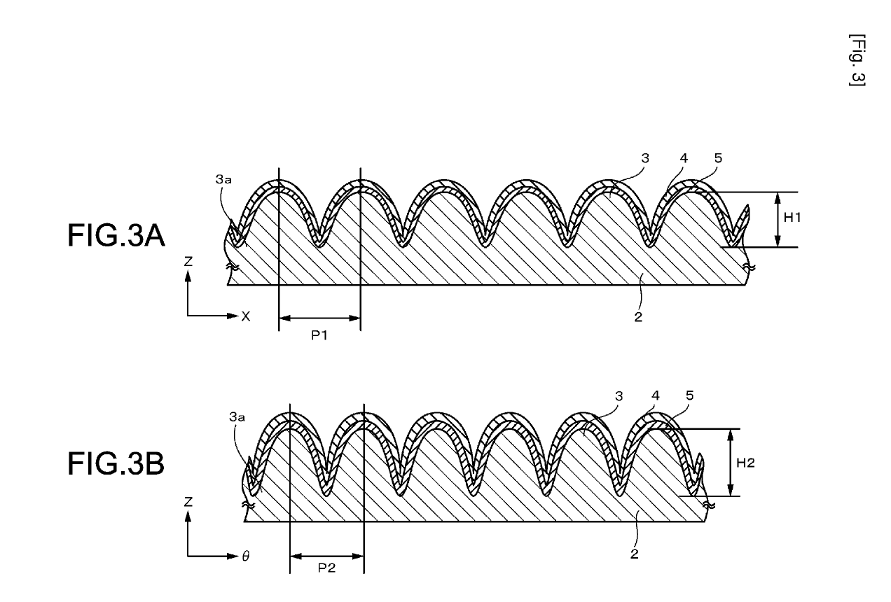

FIG. 1A is a schematic plan view showing a structural example of a conductive optical device 1 according to a first embodiment. FIG. 1B is a partially-enlarged plan view of the conductive optical device shown in FIG. 1A. FIG. 1C is a cross-sectional diagram of tracks T1, T3, . . . of FIG. 1B. FIG. 1D is a cross-sectional diagram of tracks T2, T4, . . . of FIG. 1B. FIG. 1E is a schematic diagram showing a modulation waveform of laser light used for forming a latent image, that corresponds to the tracks T1, T3, . . . of FIG. 1B. FIG. 1F is a schematic diagram showing a modulation waveform of laser light used for forming a latent image, that corresponds to the tracks T2, T4, . . . of FIG. 1B. FIGS. 2 and 4 to 6 are each a partially-enlarged perspective view of the conductive optical device 1 shown in FIG. 1A. FIG. 3A is a cross-sectional diagram of the conductive optical device 1 shown in FIG. 1A in a track extension direction (X direction (hereinafter, also referred to as track direction as appropriate)). FIG. 3B is a cross-sectional diagram of the conductive optical device shown in FIG. 1A in a θ direction.

The conductive optical device 1 includes a substrate 2 including main surfaces opposing each other, a plurality of convex structures 3 arranged on one of the main surfaces at a minute pitch equal to or smaller than a wavelength of light for suppressing a reflection, and a transparent conductive layer 4 formed on the structures 3. Further, for reducing a surface resistance, it is desirable to additionally provide a metal film (conductive film) 5 between the structures 3 and the transparent conductive layer 4. The conductive optical device 1 has a function of preventing light that has transmitted through the substrate 2 in a Z direction of FIG. 2 from being reflected at an interface between the structures 3 and ambient air.

Hereinafter, the substrate 2, the structures 3, the transparent conductive layer 4, and the metal film 5 included in the conductive optical device I will be described sequentially.

An aspect ratio of the structures 3 (height H/mean arrangement pitch P) is desirably 0.2 or more and 1.78 or less, more desirably 0.2 or more and 1.28 or less, furthermore desirably 0.63 or more and 1.28 or less. A mean film thickness of the transparent conductive layer 4 is desirably 9 nm or more and 50 nm or less. If the aspect ratio of the structures 3 falls below 0.2 and the mean film thickness of the transparent conductive layer 4 exceeds 50 nm, since concave portions between the adjacent structures 3 are filled with the transparent conductive layer 4, antireflection characteristics and transmission characteristics tend to deteriorate. On the other hand, if the aspect ratio of the structures 3 exceeds 1.78 and the mean film thickness of the transparent conductive layer 4 falls below 9 nm, since a slanted surface of each of the structures 3 becomes sharp and the mean film thickness of the transparent conductive layer 4 becomes thin, the surface resistance tends to increase. In other words, by the aspect ratio and mean film thickness satisfying the numerical ranges described above, excellent antireflection characteristics and transmission characteristics as well as a surface resistance of a wide range (e.g., 100Ω/□ or more and 5000Ω/□ or less) can be obtained. Here, the mean film thickness of the transparent conductive layer 4 is a mean film thickness Dm1 of the transparent conductive layer 4 at an apex portion of the structures 3.

When the mean film thickness of the transparent conductive layer 4 at an apex portion of the structure 3 is represented by Dm1, the mean film thickness of the transparent conductive layer 4 at a slanted surface of the structure 3 is represented by Dm2, and the mean film thickness of the transparent conductive layer 4 between adjacent structures is represented by Dm3, it is desirable to satisfy a relationship of D1>D3>D2. The mean film thickness Dm2 at the slanted surface of the structure 3 is desirably 9 nm or more and 30 nm or less. By the mean film thicknesses Dm1, Dm2, and Dm3 of the transparent conductive layer 4 satisfying the above relationship and the mean film thickness Dm2 of the transparent conductive layer 4 satisfying the above numerical range, excellent antireflection characteristics and transmission characteristics as well as a surface resistance of a wide range can be obtained. It should be noted that whether the mean film thicknesses Dm1, Dm2, and Dm3 satisfy the above relationship can be confirmed by obtaining each of the mean film thicknesses Dm1, Dm2, and Dm3 as will be described later.

It is desirable for the transparent conductive layer 4 to have a surface formed along the shape of the structures 3, and the mean film thickness Dm1 of the transparent conductive layer 4 at the apex portion of the structure 3 to be 5 nm or more and 80 nm or less. It should be noted that the mean film thickness Dm1 of the transparent conductive layer 4 at the apex portion of the structure 3 is substantially the same as a plate conversion film thickness. The plate conversion film thickness is a film thickness obtained at a time a transparent conductive layer 4 is formed on a plate under the same condition as the transparent conductive layer 4 formed on the structures.

For obtaining excellent antireflection characteristics and transmission characteristics as well as a surface resistance of a wide range, the mean film thickness Dm1 at the apex portion of the structure 3 is desirably 25 nm or more and 50 nm or less, the mean film thickness Dm2 at the slanted surface of the structure 3 is desirably 9 nm or more and 30 nm or less, and the mean film thickness Dm3 between adjacent structures is desirably 9 nm or more and 50 nm or less.

FIG. 57 is a schematic diagram for explaining a method of obtaining the mean film thicknesses Dm1, Dm2, and Dm3 of the transparent conductive layer formed on the structures each as a convex portion. Hereinafter, the method of obtaining the mean film thicknesses Dm1, Dm2, and Dm3 will be described.

First, the conductive optical device 1 is cut in a track extension direction so as to include the apex portions of the structures 3, and a cross section thereof is photographed by TEM. Next, the film thickness D1 of the transparent conductive layer 4 at the apex portion of the structure 3 is measured from the taken TEM photograph. Then, the film thickness D2 at half the height (H/2) of the structure 3 is measured out of the positions on the slanted surface of the structure 3. Subsequently, the film thickness D3 at a position at which the depth of the concave portion becomes largest out of the positions of the concave portion between the structures is measured. Then, the film thicknesses D1, D2, and D3 are repetitively measured at 10 spots randomly selected from the conductive optical device 1, and the measured values D1, D2, and D3 are simply averaged (arithmetic mean) to obtain mean film thicknesses Dm1, Dm2, and Dm3.

The surface resistance of the transparent conductive layer 4 is desirably 100Ω/□ or more and 5000Ω/□ or less, more desirably 270Ω/□ or more and 4000Ω/□ or less. By setting the surface resistance within such a range, the conductive optical device 1 can be used as an upper or lower electrode of various types of touch panels. Here, the surface resistance of the transparent conductive layer 4 is obtained by a four-terminal measurement (JIS K 7194).

An average arrangement pitch P of the structures 3 is desirably 180 nm or more and 350 nm or less, more desirably 100 nm or more and 320 nm or less, furthermore desirably 110 nm or more and 280 nm or less. If the arrangement pitch falls below 180 nm, a production of the structures 3 tends to become difficult. On the other hand, if the arrangement pitch exceeds 350 nm, a diffraction of visible light tends to occur.

A height (depth) H of the structure 3 is desirably 70 nm or more and 320 nm or less, more desirably 100 nm or more and 320 nm or less, furthermore desirably 110 nm or more and 280 nm or less. If the height of the structure 3 falls below 70 nm, a reflectance tends to increase. If the height of the structure 3 exceeds 320 nm, realization of a predetermined resistance tends to become difficult.

(Substrate)

The substrate 2 is a transparent substrate having a transparency, for example. Examples of the material of the substrate 2 include a plastic material having a transparency and a material containing glass as a main component, though not limited thereto.

As the glass, soda-lime glass, lead glass, hard glass, quartz glass, and liquid crystal glass (see “Chemistry Handbook” Introduction, P. I-537, The Chemical Society of Japan) are used, for example. As the plastic material, in view of optical characteristics such as a transparency, refractive index, and dispersion and various characteristics such as an impact resistance, heat resistance, and durability, an (metha)acrylic resin such as polymethylmethacrylate, a copolymer of methyl methacrylate and another alkyl acrylata or vinyl monomer such as styrene; a polycarbonate resin such as polycarbonate and diethylene glycol-bis-allyl carbonate (CR-39); a heat-curable (metha)acrylic resin such as a homopolymer and a copolymer of di(metha)acrylate of (brominated)bisphenol A, and a polymer and a copolymer of urethane modified monomer of (brominated)bisphenol A mono(metha)acrylate; polyester, particularly polyethylene terephthalate, polyethylene naphthalate, and unsaturated polyester, acrylonitrile-styrene copolymer, polyvinyl chloride, polyurethane, an epoxy resin, polyarylate, polyether sulphone, polyether ketone, cyclo olefin polymer (product name: ARTON, ZEONOR®) are desirable. In addition, an aramid resin can also be used regarding a heat resistance.

When using the plastic material as the substrate 2, for additionally improving surface energy, a coating property, a slip property, flatness, and the like of a plastic surface, a basecoat layer may be provided as surface processing. As the basecoat layer, for example, an organo alkoxy metal compound, polyester, acryl-modified polyester, and polyurethane can be used. Moreover, for obtaining the same effect as in the case of providing the basecoat layer, a corona discharge and UV irradiation processing may be carried out on the surface of the substrate 2.

When the substrate 2 is a plastic film, the substrate 2 can be obtained by a method of stretching the resins described above or diluting the resins in a solvent, forming the resultant into a film, and drying it. Moreover, a thickness of the substrate 2 is, for example, about 25 μm to 500 μm.

Examples of the configuration of the substrate 2 include shapes of a sheet, a plate, and a block, though not particularly limited thereto. The sheet used herein include a film. The configuration of the substrate 2 is desirably selected as appropriate based on a configuration of a portion that is required to have a predetermined antireflection function in an optical apparatus such as a camera.

(Structure)

On the surface of the substrate 2, a large number of convex structures 3 are arranged. The structures 3 are cyclically and two-dimensionally arranged at an arrangement pitch equal to or smaller than a wavelength band of light for suppressing a reflection, such as an arrangement pitch that is of the same level as a wavelength of visible light. Here, the arrangement pitch refers to arrangement pitches P1 and P2. The wavelength band of light for suppressing a reflection is a wavelength band of ultraviolet light, visible light, or infrared light. Here, the wavelength band of ultraviolet light refers to a wavelength band of 10 nm to 360 nm, the wavelength band of visible light refers to a wavelength band of 360 nm to 830 nm, and the wavelength band of infrared light refers to a wavelength band of 830 nm to 1 mm. Specifically, the arrangement pitch is desirable 180 nm or more and 350 nm or less, more desirably 190 nm or more and 280 nm or less. If the arrangement pitch falls below 180 nm, the production of the structures 3 tends to become difficult. On the other hand, if the arrangement pitch exceeds 350 nm, a diffraction of visible light tends to occur.

The structures 3 of the conductive optical device 1 are arranged so as to form a plurality of rows of tracks T1, T2, T3, (Hereinafter, also collectively referred to as “track T”) on the surface of the substrate 2. In the present application, the track refers to a portion in which the structures 3 are coupled linearly in a row. Moreover, a row direction refers to a direction orthogonal to a track extension direction (X direction) on the formation surface of the substrate 2.

The structures 3 are arranged such that the structures 3 of two adjacent tracks T are deviated a half pitch. Specifically, across the two adjacent tracks T, the structures 3 of one track (e.g., T1) are respectively arranged at intermediate positions (positions each deviated a half pitch) among the structures 3 arranged in the other track (e.g., T2). As a result, as shown in FIG. 1B, the structures 3 are arranged so as to form a hexagonal lattice pattern or a quasi-hexagonal lattice pattern in which centers of the structures 3 are respectively positioned at points a1 to a7 across the three adjacent tracks (T1 to T3). In the first embodiment, the hexagonal lattice pattern refers to a regular hexagonal lattice pattern, whereas the quasi-hexagonal lattice pattern refers to a hexagonal lattice pattern that is different from the regular hexagonal lattice pattern and stretched and distorted in the track extension direction (X direction).

When the structures 3 are arranged so as to form a quasi-hexagonal lattice pattern, the arrangement pitch P1 (distance between a1 and a2) of the structures 3 in the same track (e.g., T1) is desirably longer than the arrangement pitch of the structures 3 across the two adjacent tracks (e.g., T1 and T2), that is, the arrangement pitch P2 (e.g., distance between a1 and a7 and distance between a2 and a7) of the structures 3 in a ±θ direction with respect to the track extension direction as shown in FIG. 1B. By thus arranging the structures 3, a filling density of the structures 3 can be additionally increased.

In view of formability, it is desirable for the structures 3 to have a pyramid shape or a pyramid shape stretched or contracted in the track direction. It is desirable for the structures 3 to have an axisymmetrical pyramid shape or an axisymmetrical pyramid shape stretched or contracted in the track direction. When the adjacent structures 3 are bonded to each other, it is desirable for the structures 3 to have a pyramid shape that is axisymmetrical except lower portions thereof bonded to each other or an axisymmetrical pyramid shape stretched or contracted in the track direction. Examples of the pyramid shape include a cone shape, a cone trapezoid shape, an elliptic cone shape, and an elliptic cone trapezoid shape. Here, the pyramid shape conceptually includes, in addition to the cone shape and the cone trapezoid shape, the elliptic cone shape and the elliptic cone trapezoid shape as described above. Moreover, the cone trapezoid shape refers to a shape obtained by cutting of an apex portion of the cone shape, and the elliptic cone trapezoid shape refers to a shape obtained by cutting off an apex portion of an elliptic cone.

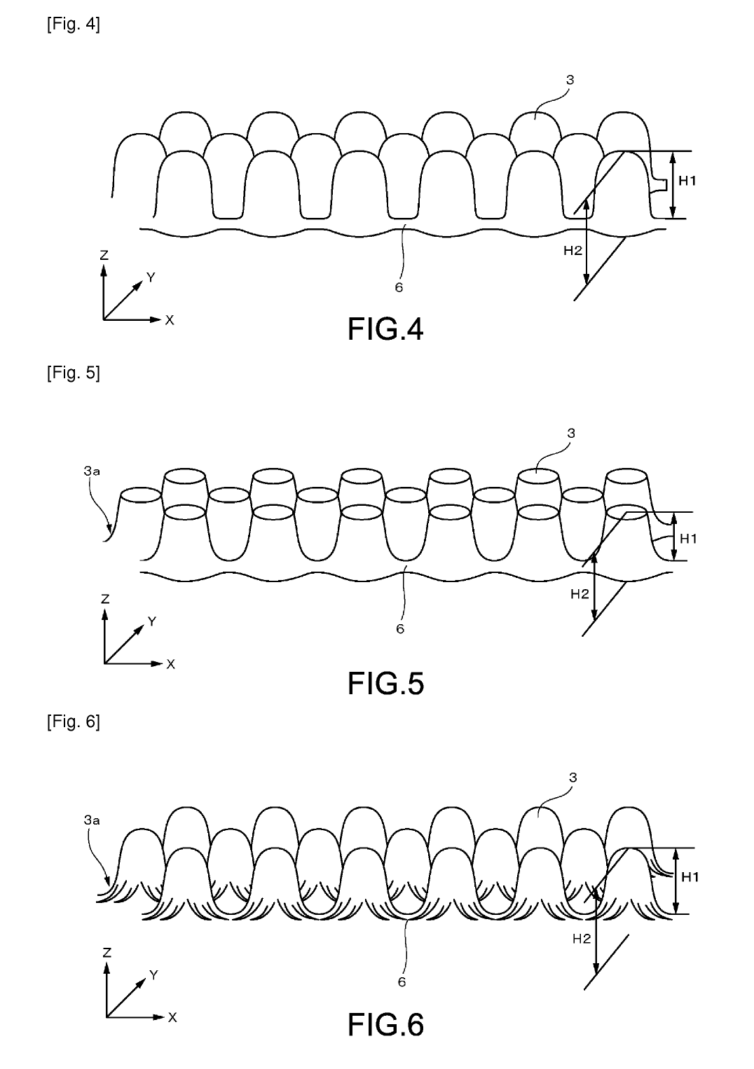

It is desirable for the structure 3 to have a pyramid shape including a bottom surface in which a width in the track extension direction is larger than a width in the row direction orthogonal to the extension direction. Specifically, it is desirable for the structures 3 to have an elliptic cone shape in which a bottom surface has an oval shape or an egg shape having long and short axes and an apex portion is curved as shown in FIGS. 2 and 4. Alternatively, an elliptic cone trapezoid shape in which a bottom surface has an oval shape or an egg shape having long and short axes and an apex portion is flat as shown in FIG. 5 is desirable. With the configurations as described above, a filling rate in the row direction can be increased.

In view of improving reflection characteristics, it is desirable for the structures 3 to have a pyramid shape in which the tilt at the apex portion is gradual and the tilt gradually becomes sharper from the center portion toward the bottom portion (see FIG. 4).

Further, in view of improving reflection characteristics and transmission characteristics, it is desirable for the structures 3 to have a pyramid shape in which the tilt at the center portion is sharper than that at the bottom portion and the apex portion (see FIG. 2) or a pyramid shape in which the apex portion is flat (see FIG. 5). When the structures 3 have an elliptic cone shape or an elliptic cone trapezoid shape, it is desirable for the long-axis direction of the bottom surface to be parallel to the track extension direction. Although the structures 3 have the same shape in FIG. 2 and the like, the shape of the structures 3 is not limited thereto, and two or more different shapes may be used for the structures 3 to be formed on the surface of the substrate. Moreover, the structures 3 may be formed integrally with the substrate 2.

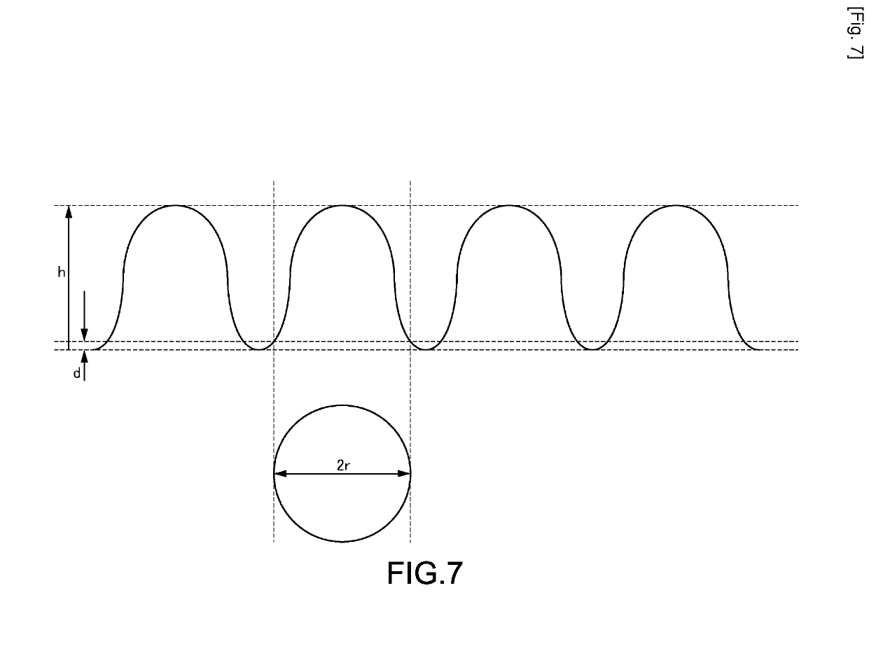

Further, as shown in FIGS. 2 and 4 to 6, it is desirable to form protrusion portions 6 on a partial or entire circumference of the structures 3. With this structure, even when the filling rate of the structures 3 is low, reflectance can be suppressed low. Specifically, each of the protrusion portions 6 is provided between adjacent structures 3 as shown in FIGS. 2, 4, and 5, for example. Alternatively, elongated protrusion portions 6 may be provided on a partial or entire circumference of the structures 3, as shown in FIG. 6. Each of the elongated protrusion portions 6 extends from the apex portion of the structure 3 to the lower portion, for example. As a shape of the protrusion portions 6, a shape having a triangular cross section, a shape having a quadrangular cross section, and the like may be used. However, the shape of the protrusion portions 6 is not particularly limited thereto and can be selected in consideration of formability or the like. Moreover, the partial or entire circumferential surface of the structures 3 may be roughened to form minute asperities thereon. Specifically, the surface between adjacent structures 3 may be roughened so that minute asperities are formed thereon, for example. Alternatively, minute holes may be formed on the surface of the structures 3 like the apex portion.

The structures 3 are not limited to the convex structures 3 shown in the figures and may instead be formed of concave portions formed on the surface of the substrate 2. The height of the structures 3 is not particularly limited and is, for example, about 420 nm, more specifically, 415 nm to 421 nm. It should be noted that when the structures 3 are formed of concave portions, the height of the structures 3 become a depth of the structures 3.

A height H1 of the structures 3 in the track extension direction is desirably smaller than a height H2 of the structures 3 in the row direction. In other words, it is desirable for the heights H1 and H2 to satisfy a relationship of H1<H2. When the structures 3 are arranged to satisfy a relationship of H1≧H2, the arrangement pitch P1 in the track extension direction needs to be elongated, with the result that the filling rate of the structures 3 in the track extension direction is lowered. Lowering of the filling rate as described above leads to deterioration of reflection characteristics.

It should be noted that the aspect ratios of the structures 3 do not need to be the same, and the structures 3 may be structured to have a certain height distribution (e.g., aspect ratio within range of 0.5 to 1.46). By thus providing the structures 3 having a height distribution, a wavelength dependency of the reflection characteristics can be suppressed. Therefore, a conductive optical device 1 having excellent antireflection characteristics can be realized.

The height distribution used herein means that the structures 3 are formed in two or more different heights (depths) on the surface of the substrate 2. In other words, structures 3 having a reference height and structures 3 having a height different from the reference height are formed on the surface of the substrate 2. The structures 3 having the height different from the reference height are formed cyclically or non-cyclically (randomly) on the surface of the substrate 2, for example. As a cyclic direction, the track extension direction and the row direction are conceivable, for example.

It is desirable to form a hem portion 3a at a peripheral portion of each of the structures 3 since it becomes possible to easily peel the structures 3 from a die or the like in a production process of the conductive optical device. The hem portion 3a used herein refers to a protrusion portion formed at a peripheral portion of the bottom portion of the structure 3. In view of the peeling characteristics, it is desirable for the hem portion 3a to be curved so that a height thereof gradually decreases from the apex portion to the lower portion of the structure 3. It should be noted that the hem portion 3a may be provided only at a part of the peripheral portion of the structure 3, but is desirably provided on the entire peripheral portion of the structure 3 in view of improving the peeling characteristics. Moreover, when the structures 3 are constituted of concave portions, the hem portion 3a is a curved surface formed on a periphery of an opening of the concave portion as the structure 3.

The height (depth) of the structures 3 is not particularly limited and is set as appropriate to be within a range of, for example, 100 nm to 280 nm, desirably 110 nm to 280 nm based on a wavelength range of light to be transmitted. Here, the height (depth) of the structures 3 is a height (depth) of the structures 3 in the track row direction. When the height of the structures 3 is below 100 nm, the reflectance tends to increase, whereas when the height of the structures 3 exceeds 280 nm, securement of a predetermined resistance tends to become difficult. The aspect ratio (height/arrangement pitch) of the structures 3 is desirably within the range of 0.5 to 1.46, more desirably 0.6 to 0.8. When the aspect ratio is below 0.5, the reflection characteristics and transmission characteristics tend to deteriorate, whereas when the aspect ratio exceeds 1.46, the peeling characteristics of the structures 3 tend to deteriorate in the production process of the conductive optical device, with the result that a replica cannot be copied beautifully.

Further, in view of improving the reflection characteristics, it is desirable for the aspect ratio of the structures 3 to be within the range of 0.54 to 1.46. In view of improving the transmission characteristics, it is desirable for the aspect ratio of the structures 3 to be within the range of 0.6 to 1.0.

It should be noted that in the present application, the aspect ratio is defined by Expression (1) below.

Aspect ratio=H/P (1)

Here, H represents a height of the structure, and P represents a mean arrangement pitch (mean cycle).

Here, the mean arrangement pitch P is defined by Expression (2) below.

Mean arrangement pitch P=(P1+P2+P2)/3 (2)

Here, P1 represents an arrangement pitch in the track extension direction (track extension direction cycle), and P2 represents an arrangement pitch in a ±θ direction (provided that θ=60°−δ, where δ is desirably 0°<♭≦11°, more desirably 3°≦δ≦6°) with respect to the track extension direction (θ direction cycle).

Moreover, the height H of the structures 3 is a height of the structures 3 in the row direction. The height of the structures 3 in the track extension direction (X direction) is smaller than that in the row direction (Y direction), and the height of the structures 3 at portions other than the portions in the track extension direction is substantially the same as that in the row direction. Therefore, the height of the subwavelength structure is represented by the height in the row direction. When the structures 3 are constituted of concave portions, the height H of the structures in Expression (1) is a depth H of the structures.

When the arrangement pitch of the structures 3 in the same track is represented by P1 and the arrangement pitch of the structures 3 between two adjacent tracks is represented by P2, a ratio P1/P2 desirably satisfies the relationship of 1.00≦P1/P2≦1.1 or 1.00<P1/P2≦1.1. By thus setting the numerical value range, the filling rate of the structures 3 each having an elliptic cone shape or an elliptic cone trapezoid shape can be increased, with the result that the antireflection characteristics can be improved.

The filling rate of the structures 3 on the surface of the substrate is 65% or more, desirably 73% or more, more desirably 86% or more with 100% as an upper limit. By thus setting the filling rate within those ranges, the antireflection characteristics can be improved. For increasing the filling rate, it is desirable to bond the lower portions of the adjacent structures 3 or distort the structures 3 by adjusting an ellipticity of the bottom surface of the structures.

Here, the filling rate of the structures 3 (mean filling rate) is a value obtained as follows.

First, a surface of the conductive optical device 1 is photographed in Top View using an SEM (Scanning Electron Microscope). Next, a unit cell Uc is randomly selected from the photographed SEM photograph to thus measure the arrangement pitch P1 and a track pitch Tp of the unit cell Uc (see FIG. 1B). Then, an area S of the bottom surface of the structure 3 positioned at the center of the unit cell Uc is measured by image processing. Subsequently, the measured arrangement pitch P1, track pitch Tp, and area S of the bottom surface are used to obtain the filling rate by Expression (3) below.

Filling rate=(S(hex.)/S(unit))*100 (3)

Unit cell area: S(unit)=P1*2Tp

Area of bottom surface of structure within unit cell: S(hex.)=2S

The processing of calculating a filling rate as described above is carried out for 10 unit cells randomly selected from the photographed SEM photograph. After that, the measurement values are simply averaged (arithmetic mean) to obtain a mean rate of the filling rate, and the obtained value is used as the filling rate of the structures 3 on the surface of the substrate.

The filling rate at a time the structures 3 overlap or a time a sub-structure such as a protrusion portion 6 is provided between the structures 3 can be obtained by a method of judging an area ratio with a portion corresponding to 5% the height of the structure 3 as a threshold value.

FIG. 7 is a diagram for explaining a method of calculating a filling rate in a case where boundaries of the structures 3 are unclear. When the boundaries of the structures 3 are unclear, the filling rate is obtained by converting, using a portion corresponding to 5% the height h of the structure 3 (=(d/h)*100) as a threshold value as shown in FIG. 7, a diameter of the structure 3 by the height d by a cross section SEM observation. When the bottom surface of the structure 3 is an oval, the same processing is carried out using long and short axes.

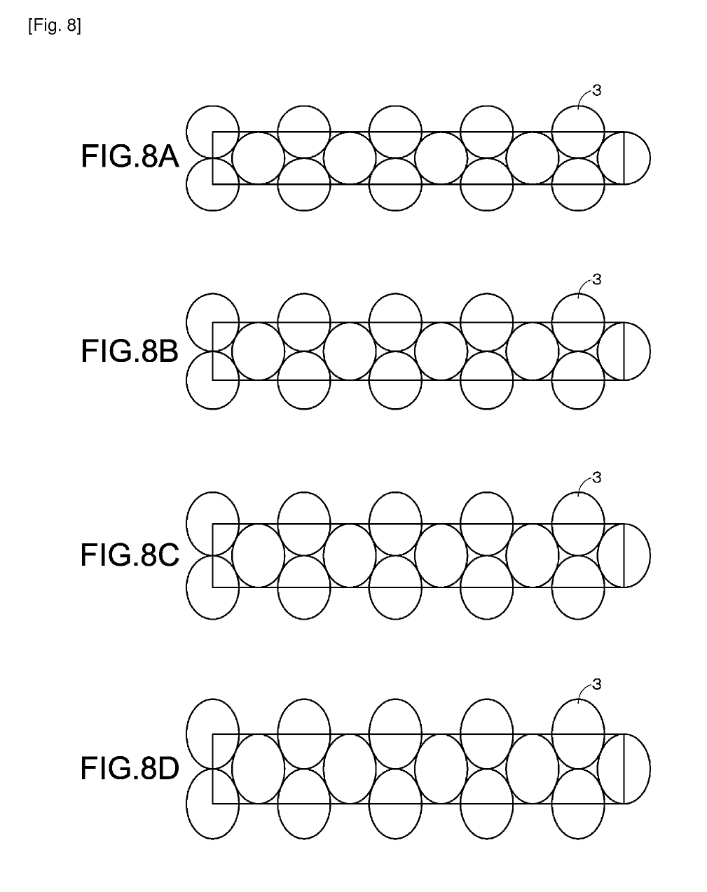

FIG. 8 are diagrams each showing a bottom surface configuration at a time an ellipticity of the bottom surface of the structures 3 is changed. The ellipticities of the ovals shown in FIGS. 8A to 8D are 100%, 110%, 120%, and 141%, respectively. By thus changing the ellipticity, the filling rate of the structures 3 on the surface of the substrate can be changed. When the structures 3 form a quasi-hexagonal lattice pattern, an ellipticity e of the bottom surface of the structure is desirably 100%<e<150% or less. This is because, within the range, the filling rate of the structures 3 can be increased, and excellent antireflection characteristics can be obtained.

Here, when a diameter of the bottom surface of the structure in the track direction (X direction) is represented by a and a diameter in the row direction orthogonal thereto (Y direction) is represented by b, the ellipticity e is defined by (a/b)*100. It should be noted that the diameters a and b of the structure 3 are values obtained as follows. First, a surface of the conductive optical device 1 is photographed in Top View using an SEM (Scanning Electron Microscope), and 10 structures 3 are randomly extracted from the photographed SEM photograph. Next, the diameters a and b of the bottom surfaces of the extracted structures 3 are measured. Then, the measurement values a and b are simply averaged (arithmetic mean) to obtain diameters a and b of the structures 3.

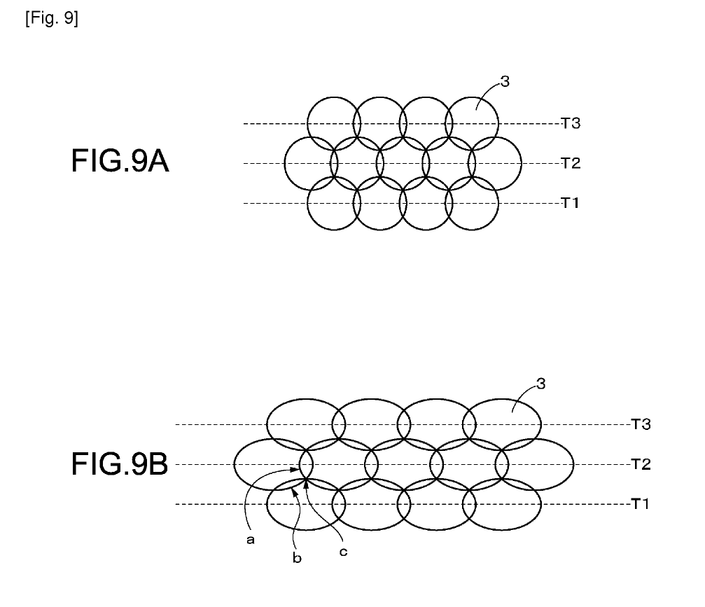

FIG. 9A shows an arrangement example of the structures 3 each having a cone shape or a cone trapezoid shape. FIG. 9B shows an arrangement example of the structures 3 each having an elliptic cone shape or an elliptic cone trapezoid shape. As shown in FIGS. 9A and 9B, it is desirable for the lower portions of the structures 3 to be bonded in an overlapping manner. Specifically, it is desirable for the lower portions of the structures 3 to be partially or entirely bonded with the lower portions of the adjacent structures 3. More specifically, it is desirable to bond the lower portions of the structures 3 in the track direction, the θ direction, or both of the two directions. FIGS. 9A and 9B each show an example in which all the lower portions of the adjacent structures 3 are bonded. By thus bonding the structures 3, the filling rate of the structures 3 can be increased. It is desirable for the structures to be bonded at portions corresponding to ¼ or less the maximum value of the wavelength band of light under a usage environment in an optical path length that takes a refractive index into account. As a result, excellent antireflection characteristics can be obtained.

When the lower portions of the structures 3 each having an elliptic cone shape or an elliptic cone trapezoid shape are bonded to each other as shown in FIG. 9B, heights of the bonding portions a, b, and c become smaller in the stated order of the bonding portions a, b, and c. Specifically, the lower portions of the adjacent structures 3 in the same track are superimposed to form a first bonding portion a, and the lower portions of the adjacent structures 3 between the adjacent tracks are superimposed to form a second bonding portion b. An intersection portion c is formed at an intersection of the first bonding portion a and the second bonding portion b. A position of the intersection portion c is, for example, lower than the positions of the first bonding portion a and the second bonding portion b. When the lower portions of the structures 3 each having an elliptic cone shape or an elliptic cone trapezoid shape are bonded, heights of the first bonding portion a, the second bonding portion b, and the intersection portion c become smaller in the stated order.

A ratio of a diameter 2r to the arrangement pitch P1 ((2r/P1)*100) is 85% or more, desirably 90% or more, more desirably 95% or more. By thus setting those ranges, the filling rate of the structures 3 can be increased, and the antireflection characteristics can be improved. If the ratio ((2r/P1)*100) becomes large and the overlap of the structures 3 becomes too large, the antireflection characteristics tend to deteriorate. Therefore, it is desirable to set an upper limit value of the ratio ((2r/P1)*100) such that the structures are bonded to each other at portions corresponding to 1/4 or less the maximum value of the wavelength band of light under a usage environment in the optical path length that takes a refractive index into account. Here, the arrangement pitch P1 is an arrangement pitch of the structures 3 in the track direction, and the diameter 2r is a diameter of the bottom surface of the structure in the track direction. It should be noted that when the bottom surface of the structure is circular, the diameter 2r becomes a diameter, and when the bottom surface of the structure is oval, the diameter 2r becomes a longest diameter.

(Transparent Conductive Layer)

It is desirable for the transparent conductive layer 4 to contain a transparent oxide semiconductor as a main component. Examples of the transparent oxide semiconductor include a binary compound such as SnO2, InO2, ZnO, and CdO, a ternary compound including at least one element selected from the group consisting of Sn, In, Zn, and Cd as constituent elements of the binary compound, and a multi-component (complex) oxide. Examples of the material forming the transparent conductive layer 4 include ITO (In2O3, SnO2), AZO (Al2O3, ZnO: aluminum dope zinc oxide), SZO, FTO (fluorine dope tin oxide), SnO2 (tin oxide), GZO (gallium dope zinc oxide), and IZO (In2O3, ZnO: indium zinc oxide). Of those, ITO is desirable in view of high reliability and a low resistance. It is desirable for the material constituting the transparent conductive layer 4 to be in an amorphous-polycrystalline mixed state for enhancing an electrical conductivity. The transparent conductive layer 4 is formed along the surface configuration of the structures 3, and it is desirable for the surface configurations of the structures 3 and the transparent conductive layer 4 to be almost the same. This is because a change of a refractive index profile due to formation of the transparent conductive layer 4 can be suppressed, and excellent antireflection characteristics and transmission characteristics can be maintained.

(Metal Film)

It is desirable to form the metal film (conductive film) 5 as a base layer of the transparent conductive layer 4 since it becomes possible to reduce a resistance, reduce a thickness of the transparent conductive layer 4, and compensate for electroconductivity when the electroconductivity does not reach a sufficient value with only the transparent conductive layer 4. The film thickness of the metal film 5 is not particularly limited and set to, for example, about several nm. Since the metal film 5 has high electroconductivity, a sufficient surface resistance can be obtained with a film thickness of several nm. Moreover, with the film thickness of about several nm, there is almost no optical influence such as absorption and reflection by the metal film 5. As the material forming the metal film 5, it is desirable to use a metal material having high electroconductivity. Examples of such a material include Ag, Al, Cu, Ti, Nb, and a doped Si. Of those, Ag is desirable considering high electroconductivity and actual use performance. Although a surface resistance can be secured with only the metal film 5, if the metal film 5 is extremely thin, the metal film 5 becomes an island-like structure, with the result that it becomes difficult to secure electroconductivity. In this case, for electrically connecting island-like metal films 5, formation of the transparent conductive layer 4 to be the upper layer of the metal film 5 becomes important.

(Structure of Roll Master)

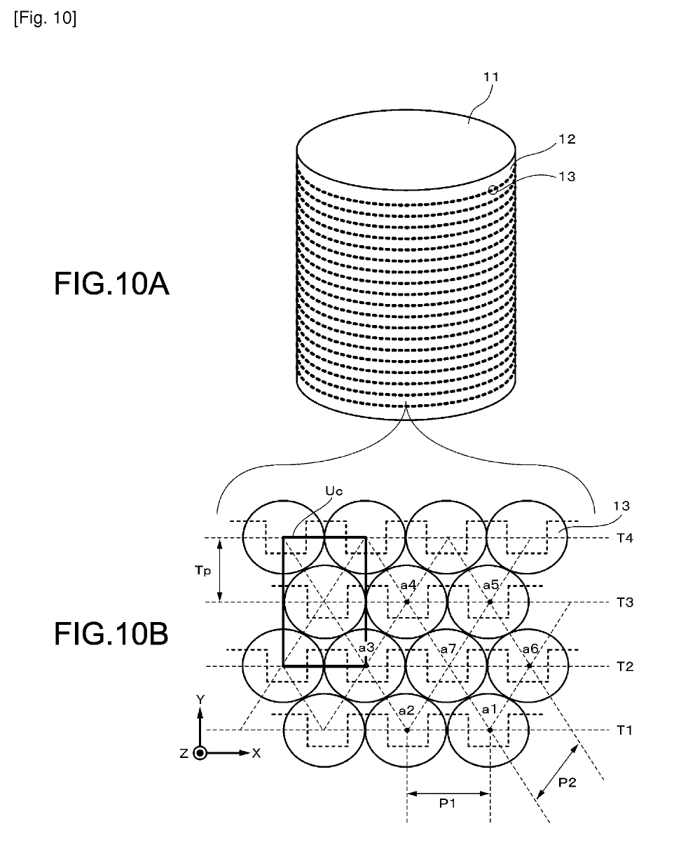

FIG. 10 show a structural example of a roll master for producing a conductive optical device having the above structure. As shown in FIG. 10, a roll master 11 has a structure in which a large number of structures 13 as concave portions are arranged on a surface of a matrix 12 at about the same pitch as a wavelength of light such as visible light. The matrix 12 has a columnar shape or a cylindrical shape. As a material of the matrix 12, glass can be used, for example, though not particularly limited thereto. Using a roll matrix exposure apparatus to be described later, two-dimensional patterns are spatially linked, a polarity reversion formatter signal and a rotation controller of a recording apparatus are synchronized for each track to generate a signal, and a pattern is patterned at an appropriate feeding pitch by CAV. As a result, a hexagonal lattice pattern or a quasi-hexagonal lattice pattern can be recorded. By appropriately setting a frequency of the polarity reversion formatter signal and an rpm of the roll, a lattice pattern having a uniform spatial frequency is formed in a desired recording area.

(Production Method for Conductive Optical Device)

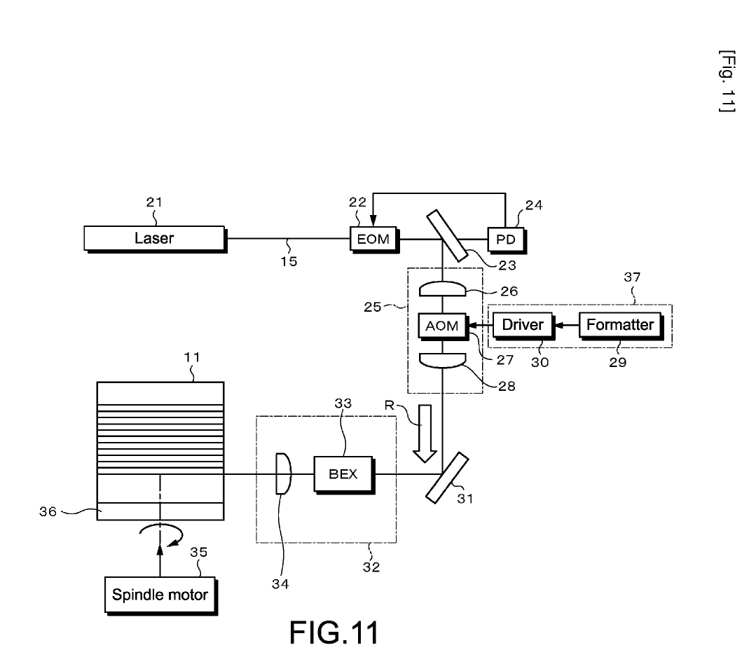

Next, referring to FIGS. 11 to 14, a production method for the conductive optical device 1 structured as described above will be described.

The production method for the conductive optical device 1 according to the first embodiment includes a resist deposition step of forming a resist layer on a matrix, an exposure step of forming a latent image of a moth-eye pattern on the resist layer using a roll matrix exposure apparatus, and a development step of developing the resist layer on which the latent image is formed. The method also includes an etching step of producing a roll master using plasma etching, a copy step of producing a copy substrate by an ultraviolet-curable resin, and a deposition step of depositing a transparent conductive layer on the copy substrate.

(Structure of Exposure Apparatus)

First, referring to FIG. 11, a structure of the roll matrix exposure apparatus used in the moth-eye pattern exposure step will be described. The roll matrix exposure apparatus is structured on the basis of an optical disc recording apparatus.

A laser light source 21 is a light source for exposing a resist deposited on a surface of the matrix 12 as a recording medium and emits recording laser light 15 having a wavelength λ of, for example, 266 nm. The laser light 15 emitted from the laser light source 21 travels straight on as a parallel beam and enters an electro-optical device (EOM: Electro Optical Modulator) 22. The laser light 15 that has transmitted through the electro-optical device 22 is reflected by a mirror 23 and guided to a modulation optical system 25.

The mirror 23 is constituted of a polarization beam splitter and has a function of reflecting one polarization component and causing the other polarization component to transmit therethrough. The polarization component that has transmitted through the mirror 23 is received by a photodiode 24, and a light-receiving signal is used to control the electro-optical device 22 so that a phase modulation of the laser light 15 is performed.

In the modulation optical system 25, the laser light 15 is collected by an acoustic optical device (AOM: Acoustic-Optic Modulator) 27 formed of glass (SiO2) via a collective lens 26. After being intensity-modulated by the acoustic optical device 27 and spread, the laser light 15 is made a parallel beam by a lens 28. The laser light 15 emitted from the modulation optical system 25 is reflected by a mirror 31 and horizontally guided to a moving optical table 32 as the parallel beam.

The moving optical table 32 includes a beam expander 33 and an objective lens 34. The laser light 15 guided to the moving optical table 32 is shaped into a predetermined beam shape by the beam expander 33 and irradiated onto a resist layer on the matrix 12 via the objective lens 34 after that. The matrix 12 is placed on a turntable 36 connected to a spindle motor 35. Then, while causing the matrix 12 to rotate and moving the laser light 15 in a height direction of the matrix 12, the laser light 15 is intermittently irradiated onto the resist layer. Thus, the resist layer exposure step is performed. The formed latent image has approximately an oval shape that has a long axis in a circumferential direction. The movement of the laser light 15 is performed by a movement of the moving optical table 32 in a direction indicated by the arrow R.

The exposure apparatus includes a control mechanism 37 for forming a latent image corresponding to a two-dimensional hexagonal lattice or quasi-hexagonal lattice pattern shown in FIG. 1B on the resist layer. The control mechanism 37 includes a formatter 29 and a driver 30. The formatter 29 includes a polarity reversion portion which controls an irradiation timing of the laser light 15 with respect to the resist layer. The driver 30 controls the acoustic optical device 27 upon receiving an output of the polarity reversion portion.

In the roll matrix exposure apparatus, a polarity reversion formatter signal and a rotation controller of a recording apparatus are synchronized to generate a signal for each track so as to spatially link the two-dimensional patterns, and an intensity of the signal is modulated by the acoustic optical device 27. By performing patterning at a constant angular velocity (CAV), an appropriate rpm, an appropriate modulation frequency, and an appropriate feeding pitch, the hexagonal lattice pattern or the quasi-hexagonal lattice pattern can be recorded. For example, the feeding pitch only needs to be set to be 251 nm for setting the cycle in the circumferential direction to be 315 nm and a cycle in a direction about 60 degrees with respect to the circumferential direction (about −60-degree direction) to be 300 nm (the Pythagorean theorem) as shown in FIG. 10B. A frequency of the polarity reversion formatter signal is changed by the rpm of the roll (e.g., 1800 rpm, 900 rpm, 450 rpm, and 225 rpm). For example, the frequencies of the polarity reversion formatter signal corresponding to 1800 rpm, 900 rpm, 450 rpm, and 225 rpm of the roll are 37.70 MHz, 18.85 MHz, 9.34 MHz, and 4.71 MHz, respectively. The quasi-hexagonal lattice pattern having a uniform spatial frequency (315-nm-circumference cycle, 300-nm cycle in about 60-degree direction with respect to circumferential direction (about −60-degree direction)) in a desired recording area is obtained by expanding a beam diameter of far-ultraviolet laser light into 5 times the beam diameter by the beam expander (BEX) 33 on the moving optical table 32, irradiating the laser light onto the resist layer on the matrix 12 via the objective lens 34 having an NA (Numerical Aperture) of 0.9, and forming a minute latent image.

(Resist Deposition Step)

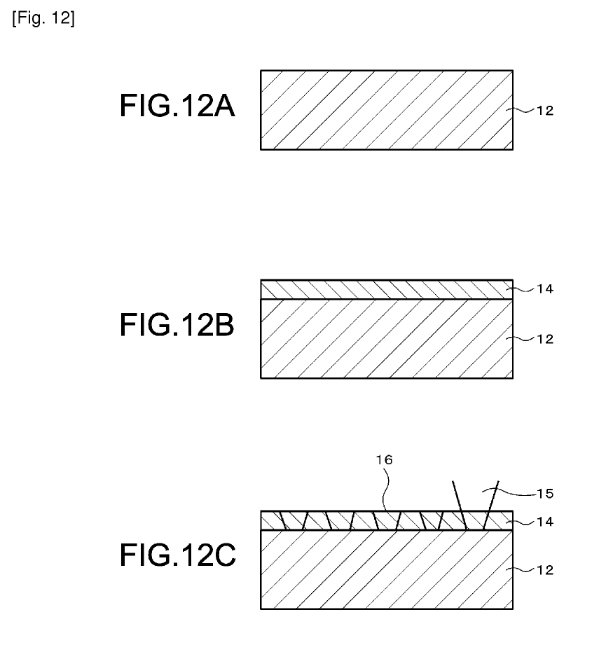

First, as shown in FIG. 12A, a columnar matrix 12 is prepared. The matrix 12 is, for example, a glass matrix. Next, as shown in FIG. 12B, a resist layer 14 is formed on a surface of the matrix 12. As the material of the resist layer 14, either an organic resist or an inorganic resist may be used, for example. As the organic resist, a novolac resist or a chemically-amplified resist can be used, for example. As the inorganic resist, a metal oxide consisting of one or two or more types of transition metal can be used, for example.

(Exposure Step)

Subsequently, as shown in FIG. 12C, using the roll matrix exposure apparatus described above, the laser light (exposure light beam) 15 is irradiated onto the resist layer 14 while causing the matrix 12 to rotate. At this time, by intermittently irradiating the laser light 15 while moving the laser light 15 in a height direction of the matrix 12 (direction parallel to center axis of columnar or cylindrical matrix 12), the entire surface of the resist layer 14 is exposed. As a result, latent images 16 corresponding to a trajectory of the laser light 15 are formed on the entire surface of the resist layer 14 at about the same pitch as the wavelength of visible light.

The latent images 16 are arranged so as to form a plurality of rows of tracks on the surface of the matrix and thus form a hexagonal lattice pattern or a quasi-hexagonal lattice pattern. The latent images 16 each have an oval shape that has a long-axis direction in the track extension direction.

(Development Step)

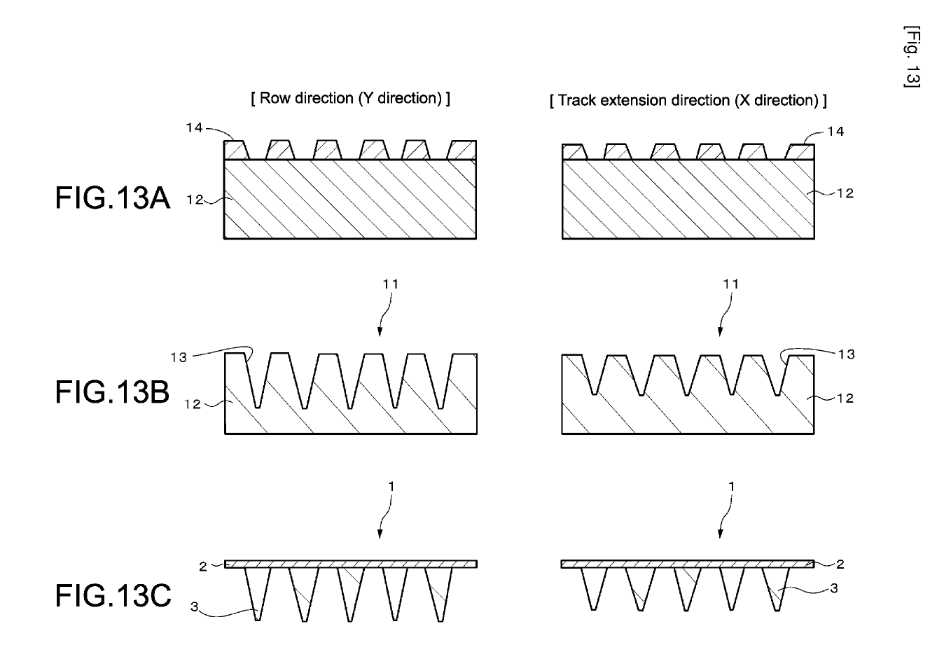

Next, a developer is dropped onto the resist layer 14 while causing the matrix 12 to rotate, and the resist layer 14 is thus subjected to development processing as shown in FIG. 13A. When the resist layer 14 is formed as a positive-type resist as shown in the figure, a solubility rate with respect to the developer increases at an exposed portion exposed by the laser light 15 as Compared to an unexposed portion, with the result that a pattern corresponding to the latent images (exposed portion) 16 is formed on the resist layer 14.

(Etching Step)

Next, the surface of the matrix 12 is subjected to etching processing using a pattern (resist pattern) on the resist layer 14 formed on the matrix 12 as a mask. Accordingly, as shown in FIG. 13B, concave portions having an elliptic cone shape or an elliptic cone trapezoid shape that has a long-axis direction in the track extension direction, that is, the structures 13 can be obtained. The etching is carried out by, for example, dry etching. At this time, by alternately carrying out the etching processing and ashing processing, the pattern of the conic structures 13 can be formed. Moreover, it is possible to produce a glass master having 3 times or more the depth of the resist layer 14 (selectivity of 3 or more) and increase an aspect ratio of the structures 3. As the dry etching, plasma etching that uses a roll etching apparatus is favorable.

By performing the steps described above, a roll master 11 having a hexagonal lattice pattern or a quasi-hexagonal lattice pattern constituted of concave portions each having a depth of about 120 nm to 350 nm can be obtained.

(Copy Step)

Next, the roll master 11 and the substrate 2 such as a sheet onto which a transfer material has been applied are brought into close contact with each other and irradiated with ultraviolet rays to be cured and peeled. As a result, a plurality of structures as convex portions are formed on one main surface of the substrate 2 as shown in FIG. 13C, and a conductive optical device 1 such as a moth-eye ultraviolet-curable copy sheet is produced.

The transfer material is constituted of, for example, an ultraviolet-curable material and an initiator and includes a filler, a functional additive, and the like as necessary.

The ultraviolet-curable material is constituted of, for example, a monofunctional monomer, a bifunctional monomer, a multifunctional monomer, or the like. Specifically, the ultraviolet-curable material is obtained by singularly using the materials described above or mixing the plurality of materials.

Examples of the monofunctional monomer include carboxylic acids (acrylic acid), hydroxy(2-hydroxyethyl acrylate, 2-hydroxypropyl acrylate, 4-hydroxybutyl acrylate), alkyl, alicyclics (isobutyl acrylate, t-butyl acrylate, isooctyl acrylate, lauryl acrylate, stearyl acrylate, isobonyl acrylate, cyclohexyl acrylate), other functional monomers (2-methoxyethyl acrylate, methoxyethylene glycol acrylate, 2-ethoxyethyl acrylate, tetrahydrofurfuryl acrylate, benzyl acrylate, ethylcarbitol acrylate, phenoxyethyl acrylate, N,N-dimethylaminoethyl acrylate, N,N-dimethylaminopropyl acrylamide, N,N-dimethylacrylamide, acryloyl morpholine, N-isopropyl acrylamide, N,N-diethylacrylamide, N-vinylpyrolidone, 2-(perfluorooctyl)ethyl acrylate, 3-perfluorohexyl-2-hydroxypropyl acrylate, 3-perfluorooctyl-2-hydroxypropyl acrylate, 2-(perfluorodecyl)ethyl acrylate, 2-(perfluoro-3-methylbutyl)ethyl acrylate), 2,4,6-tribromophenol acrylate, 2,4,6-tribromophenol methacrylate, 2-(2,4,6-tribromophenoxy)ethyl acrylate, and 2-ethylhexyl acrylate.

Examples of the bifunctional monomer include tri(propylene glycol)diacrylate, trimethylolpropane diarylether, and urethane acryl ate.

Examples of the multifunctional monomer include trimethylolpropane triacrylate, dipentaerythritolpenta and hexaacrylate, and ditrimethylolpropane tetraacrylate.

Examples of the initiator include 2,2-dimethoxy-1,2-diphenylethane-1-one, 1-hydroxy-cyclohexyl phenyl ketone, and 2-hydroxy-2-methyl-1-phenylpropane-1-one.

As the filler, either inorganic particles or organic particles can be used, for example. Examples of the inorganic particles include metal oxide particles of SiO2, TiO2, ZrO2, SnO2, Al2O3, and the like.

Examples of the functional additive include a leveling agent, a surface conditioner, and a defoamer. Examples of the material of the substrate 2 include methyl methacrylate(co)polymer, polycarbonate, styrene(co)polymer, methyl methacrylate-styrene copolymer, cellulose diacetate, cellulose triacetate, cellulose acetate butyrate, polyester, polyamide, polyimide, polyether sulfone, polysulfone, polypropylene, polymethylpentene, polyvinyl chloride, polyvinyl acetal, polyether ketone, polyurethane, and glass.

The method of forming a substrate 2 is not particularly limited and may be injection molding, extrusion molding, or cast molding. Surface processing such as corona treatment may be performed on the surface of the substrate as necessary.

(Metal Film Deposition Step)

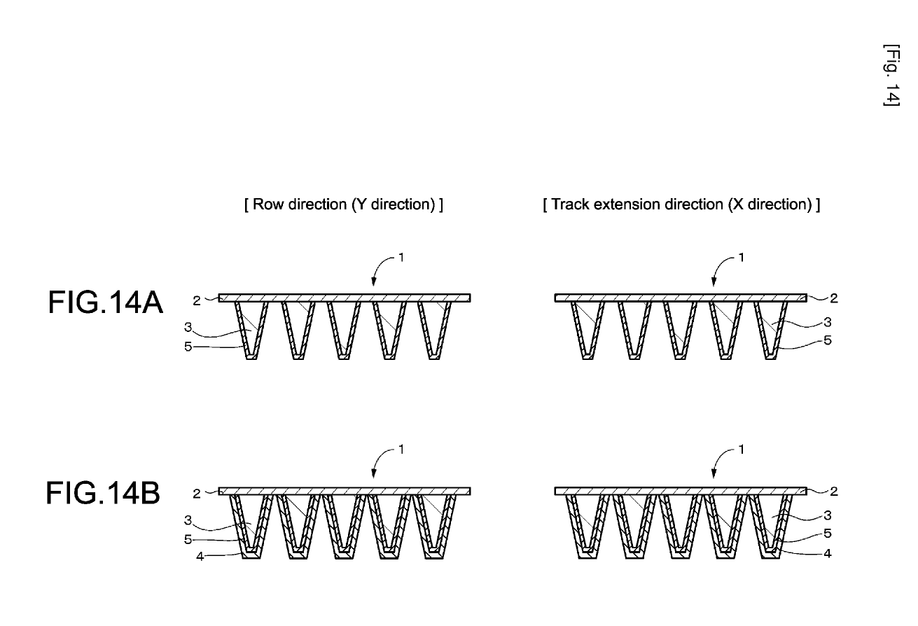

Next, as shown in FIG. 14A, a metal film is deposited on the concavoconvex surface of the substrate 2 on which the structures 3 have been formed as necessary. As a deposition method for a metal film, a PVD method (Physical Vapor Deposition: technique of forming thin film by aggregating material physically gasified in vacuum on substrate) such as vacuum vapor deposition, plasma-assisted vapor deposition, sputtering, and ion plating can be used in addition to a CVD method (Chemical Vapor Deposition: technique of depositing thin film from gas phase using chemical reaction) such as thermal CVD, plasma CVD, and optical CVD.

(Conductive Film Deposition Step)

Next, as shown in FIG. 14B, a transparent conductive layer is deposited on the concavoconvex surface of the substrate 2 on which the structures 3 have been formed. As the method of depositing a transparent conductive layer, a method that is the same as the method of depositing a metal film described above can be used, for example.

According to the first embodiment, a conductive optical device 1 having an extremely-high transmittance and less reflection can be provided. Since the antireflection function is realized by forming the plurality of structures 3 on the surface, a wavelength dependency is low and an angle dependency is lower than that of an optical-film-type transparent conductive layer. An excellent productivity and low costs can be realized by using a nanoimprint technology and adopting a high-throughput film structure without using a multilayer optical film.

### 2. Second Embodiment

(Structure of Conductive Optical Device)

FIG. 15A is a schematic plan view showing a structural example of a conductive optical device according to a second embodiment. FIG. 15B is a partially-enlarged plan view of the conductive optical device shown in FIG. 15A. FIG. 15C is a cross-sectional diagram of tracks T1, T3, . . . of FIG. 15B. FIG. 15D is a cross-sectional diagram of tracks T2, T4, . . . of FIG. 15B. FIG. 15E is a schematic diagram showing a modulation waveform of laser light used for forming latent images corresponding to the tracks T1, T3, . . . of FIG. 15B. FIG. 15F is a schematic diagram showing a modulation waveform of laser light used for forming latent images corresponding to the tracks T2, T4, . . . of FIG. 15B.

The conductive optical device 1 of the second embodiment is different from that of the first embodiment in that the structures 3 form a tetragonal lattice pattern or a quasi-tetragonal lattice pattern across three adjacent tracks. In the present embodiments, the quasi-tetragonal lattice pattern is different from a regular tetragonal lattice pattern and refers to a regular tetragonal lattice pattern obtained by extending the regular tetragonal lattice pattern in the track extension direction (X direction) to distort it.

The height or depth of the structures 3 is not particularly limited and set within the range of, for example, 100 nm to 280 nm, desirably 110 nm to 280 nm. Here, the height (depth) of the structures 3 is a height (depth) of the structures 3 in the track extension direction. When the height of the structures 3 is below 100 nm, the reflectance tends to increase, whereas when the height of the structures 3 exceeds 280 nm, securement of a predetermined resistance tends to become difficult. The arrangement pitch P2 in a (about) 45-degree direction with respect to the tracks is, for example, about 200 nm to 300 nm. The aspect ratio (height/arrangement pitch) of the structures 3 is desirably within the range of about 0.54 to 1.13. Furthermore, the aspect ratios of the structures 3 do not need to be the same, and the structures 3 may be structured to have a certain height distribution.

The arrangement pitch P1 of the structures 3 in the same tracks is desirably longer than the arrangement pitch P2 of the structures 3 between two adjacent tracks. Moreover, when the arrangement pitch of the structures 3 in the same track is represented by P1 and the arrangement pitch of the structures 3 between two adjacent tracks is represented by P2, it is desirable for a ratio P1/P2 to satisfy a relationship of 1.4<P1/P2≦1.5. By setting such a numerical value range, a filling rate of the structures 3 each having an elliptic cone shape or an elliptic cone trapezoid shape can be improved, with the result that the antireflection characteristics can be improved. Further, it is desirable for the height or depth of the structures 3 in a 45-direction or approximately-45-degree direction with respect to the tracks to be smaller than the height or depth of the structures 3 in the track extension direction.

It is desirable for the height H2 of the structures 3 in the array direction (θ direction) oblique to the track extension direction to be smaller than the height H1 of the structures 3 in the track extension direction. In other words, it is desirable for the heights H1 and H2 to satisfy a relationship of H1>H2.

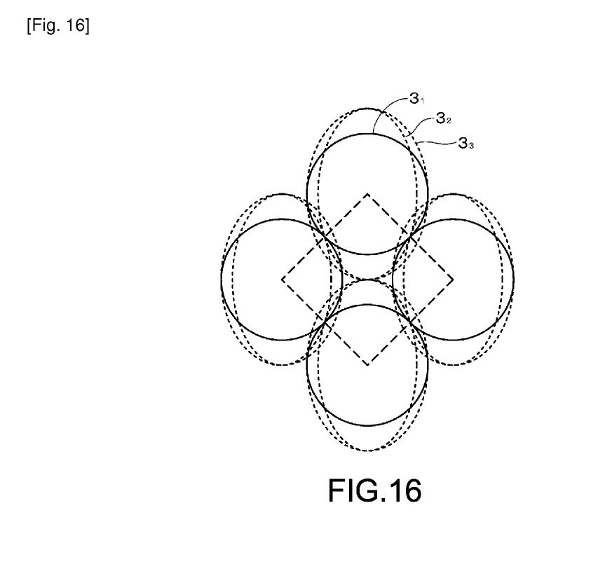

FIG. 16 is a diagram showing a bottom surface configuration at a time an ellipticity of the bottom surfaces of the structures 3 is changed. Ellipticities of ovals 31, 32, and 33 are 100%, 163.3%, and 141%, respectively. By thus changing the ellipticity, the filling rate of the structures 3 on the surface of the substrate can be changed. When the structures 3 form a tetragonal lattice pattern or a quasi-tetragonal lattice pattern, an ellipticity e of the bottom surface of the structure is desirably 150%≦e≦180%. This is because, within the range, the filling rate of the structures 3 can be increased, and excellent antireflection characteristics can be obtained.

The filling rate of the structures 3 on the surface of the substrate is 65% or more, desirably 73% or more, more desirably 86% or more with 100% as an upper limit. By thus setting the filling rate within those ranges, the antireflection characteristics can be improved.

Here, the filling rate of the structures 3 (mean filling rate) is a value obtained as follows.

First, the surface of the conductive optical device 1 is photographed in Top View using an SEM (Scanning Electron Microscope). Next, a unit cell Uc is randomly selected from the photographed SEM photograph to thus measure the arrangement pitch P1 and the track pitch Tp of the unit cell Uc (see FIG. 15B). Then, an area S of the bottom surface of any of the four structures 3 in the unit cell Uc is measured by image processing. Subsequently, the measured arrangement pitch P1, track pitch Tp, and area S of the bottom surface are used to obtain the filling rate by Expression (4) below.

Filling rate=(S(tetra)/S(unit))*100 (4)

Unit cell area: S(unit)=2*((P1*Tp)*(½))=P1*Tp

Area of bottom surface of structure within unit cell: S(tetra)=S

The processing of calculating a filling rate described above is carried out for 10 unit cells randomly selected from the photographed SEM photograph. After that, the measurement values are simply averaged (arithmetic mean) to obtain a mean rate of the filling rate, and the obtained value is used as the filling rate of the structures 3 on the surface of the substrate.

The ratio of the diameter 2r to the arrangement pitch P1 ((2r/P1)*100) is 64% or more, desirably 69% or more, more desirably 73% or more. By thus setting those ranges, the filling rate of the structures 3 can be increased, and the antireflection characteristics can be improved. Here, the arrangement pitch P1 is an arrangement pitch of the structures 3 in the track direction, and the diameter 2r is a diameter of the bottom surface of the structure in the track direction. It should be noted that when the bottom surface of the structure is circular, the diameter 2r becomes a diameter, and when the bottom surface of the structure is oval, the diameter 2r becomes a longest diameter.

(Structure of Roll Master)

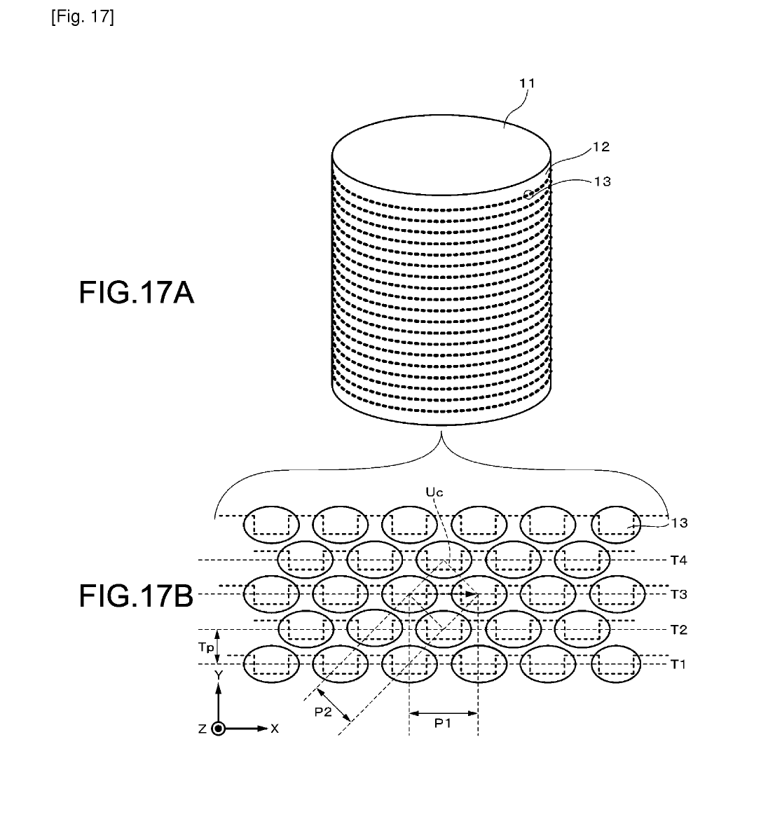

FIG. 17 show a structural example of a roll master for producing a conductive optical device having the structure described above. The roll master is different from that of the first embodiment in that the concave structures 13 form a tetragonal lattice pattern or a quasi-tetragonal lattice pattern on the surface.

Using the roll matrix exposure apparatus, two-dimensional patterns are spatially linked, a polarity reversion formatter signal and a rotation controller of a recording apparatus are synchronized for each track to generate a signal, and a pattern is patterned at an appropriate feeding pitch by CAV. As a result, a tetragonal lattice pattern or a quasi-tetragonal lattice pattern can be recorded. It is desirable to form, by appropriately setting a frequency of the polarity reversion formatter signal and an rpm of the roll, a lattice pattern having a uniform spatial frequency in a desired recording area of the resist on the matrix 12 by irradiating laser light.

### 3. Third Embodiment

(Structure of Conductive Optical Device)

FIG. 18A is a schematic plan view showing a structural example of a conductive optical device according to a third embodiment. FIG. 18B is a partially-enlarged plan view of the conductive optical device shown in FIG. 18A. FIG. 18C is a cross-sectional diagram of tracks T1, T3, . . . of FIG. 18B. FIG. 18D is a cross-sectional diagram of tracks T2, T4, . . . of FIG. 18B.

The conductive optical device 1 of the third embodiment is different from that of the first embodiment in that the tracks T are formed in an arc and the structures 3 are arranged along the arc. As shown in FIG. 18B, the structures 3 are arranged so as to form a quasi-hexagonal lattice pattern in which centers of the structures 3 are respectively positioned at points a1 to a7 across the three adjacent tracks (T1 to T3). Here, the quasi-hexagonal lattice pattern refers to a hexagonal lattice pattern that is different from the regular hexagonal lattice pattern and stretched and distorted along the arc of the tracks T, or refers to a hexagonal lattice pattern that is different from the regular hexagonal lattice pattern and stretched and distorted in the track extension direction (X direction).

Since structures of the conductive optical device 1 other than that described above are the same as those of the first embodiment, descriptions thereof will be omitted.

(Structure of Disc Master)

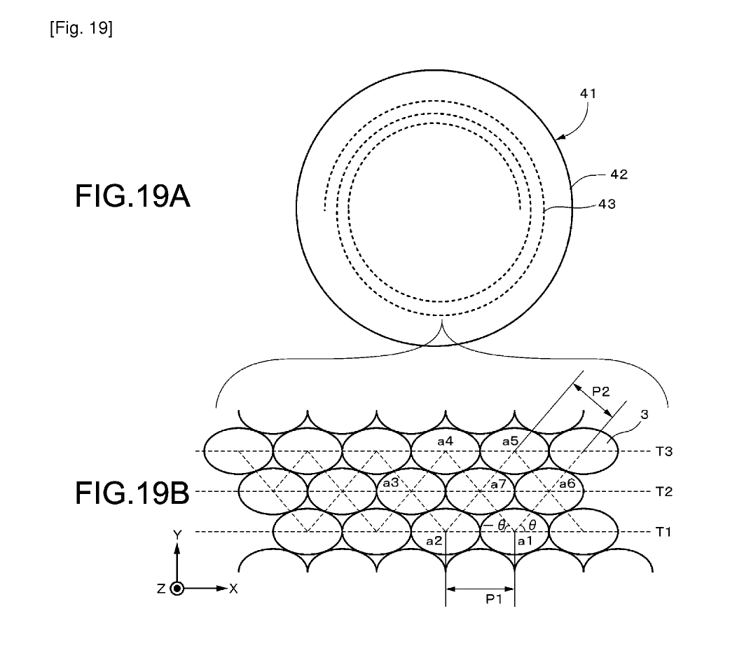

FIGS. 19A and 19B show a structural example of a disc master for producing a conductive optical device having the structure described above. As shown in FIGS. 19A and 19B, a disc master 41 has a structure in which a large number of structures 43 as concave portions are arranged on a surface of a disc-like matrix 42. The structures 43 are cyclically and two-dimensionally arranged at an arrangement pitch equal to or smaller than a wavelength band of light under a usage environment of the conductive optical device 1, such as an arrangement pitch that is of the same level as a wavelength of visible light. The structures 43 are arranged on, for example, concentric or spiral tracks.

Since structures of the disc master 41 other than that described above are the same as those of the roll master 11 of the first embodiment, descriptions thereof will be omitted.

(Method of Producing Conductive Optical Device)

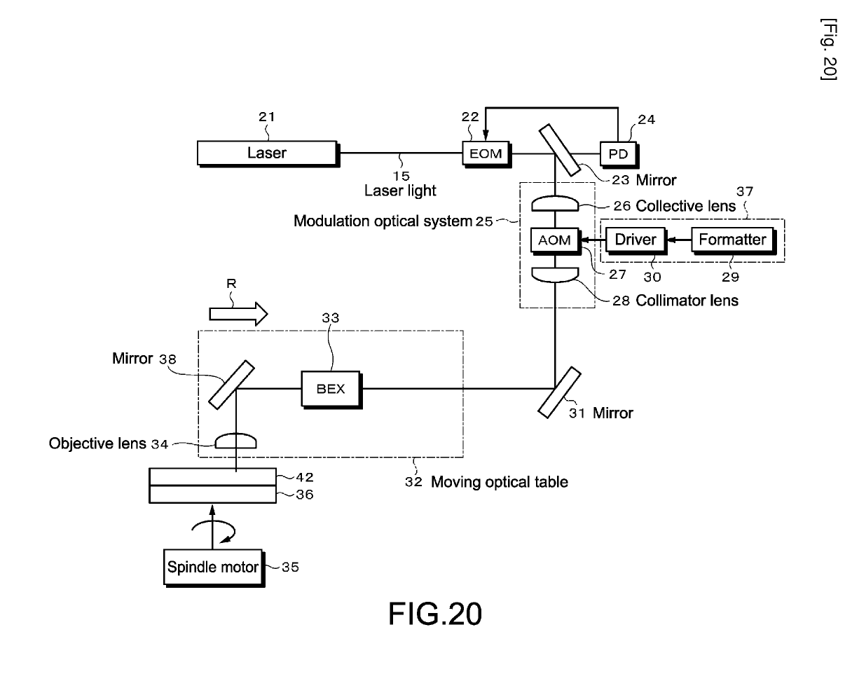

First, referring to FIG. 20, an exposure apparatus used for producing a disc master 41 having the structure described above will be described.

The moving optical table 32 includes the beam expander 33, a mirror 38, and the objective lens 34. The laser light 15 guided to the moving optical table 32 is shaped into a predetermined beam shape by the beam expander 33 and irradiated onto a resist layer on the disc-like matrix 42 via the mirror 38 and the objective lens 34 after that. The matrix 42 is placed on a turntable (not shown) connected to the spindle motor 35. Then, while causing the matrix 42 to rotate and moving the laser light 15 in a radial direction of the matrix 42, the laser light 15 is intermittently irradiated onto the resist layer on the matrix 42. Thus, the resist layer exposure step is performed. The formed latent image has approximately an oval shape that has a long axis in a circumferential direction. The movement of the laser light 15 is performed by a movement of the moving optical table 32 in a direction indicated by the arrow R.

The exposure apparatus shown in FIG. 20 includes the control mechanism 37 for forming a latent image corresponding to a two-dimensional hexagonal lattice or quasi-hexagonal lattice pattern shown in FIG. 18B on the resist layer. The control mechanism 37 includes the formatter 29 and the driver 30. The formatter 29 includes a polarity reversion portion which controls an irradiation timing of the laser light 15 with respect to the resist layer. The driver 30 controls the acoustic optical device 27 upon receiving an output of the polarity reversion portion.

The control mechanism 37 synchronizes an intensity modulation of the laser light 15 by the acoustic optical device 27, a driving rotational velocity of the spindle motor 35, and a movement velocity of the moving optical table 32 for each track so as to spatially link the two-dimensional patterns as the latent image. The matrix 42 is controlled to rotate at a constant angular velocity (CAV). Then, patterning is performed with an appropriate rpm of the matrix 42 by the spindle motor 35, an appropriate frequency modulation of a laser intensity of the laser light 15 by the acoustic optical device 27, and an appropriate feeding pitch of the laser light 15 by the moving optical table 32. As a result, a latent image of the hexagonal lattice pattern or the quasi-hexagonal lattice pattern is formed on the resist layer.

Furthermore, a control signal of the polarity reversion portion is gradually changed so that the spatial frequency becomes uniform (pattern density of latent image, P1: 330 nm and P2: 300 nm, P1: 315 nm and P2: 275 nm, or P1: 300 nm and P2: 265 nm). More specifically, an exposure is performed while changing the irradiation cycle of the laser light 15 with respect to the resist layer for each track, and a frequency modulation of the laser light 15 is performed in the control mechanism 37 such that P1 in each track T becomes approximately 330 nm (or 315 nm, 300 nm). In other words, the modulation is controlled such that the irradiation cycle of the laser light becomes shorter as the position of the track moves farther away from the center of the disc-like matrix 42. As a result, a nanopattern having a uniform spatial frequency can be formed on the entire surface of the substrate.

Hereinafter, an example of the method of producing a conductive optical device according to the third embodiment will be described.

First, using the exposure apparatus having the structure described above, the disc master 41 is produced in the same manner as in the first embodiment except that the resist layer formed on the disc-like matrix is exposed. Next, the disc master 41 and the substrate 2 such as an acrylic sheet onto which an ultraviolet-curable resin has been applied are brought into close contact with each other and irradiated with ultraviolet rays to thus cure the ultraviolet-curable resin. After that, the substrate 2 is peeled off from the disc master 41. As a result, a disc-like optical device in which a plurality of structures 3 are arranged on the surface can be obtained. Next, on a concavoconvex surface of the optical device in which the plurality of structures 3 are formed, a transparent conductive layer 4 is deposited after a metal film 5 is deposited as necessary. As a result, a disc-like conductive optical device 1 can be obtained. Subsequently, the conductive optical device 1 of a predetermined shape such as a rectangle is cut out from the disc-like conductive optical device 1. As a result, a desired conductive optical device 1 is produced.

According to the third embodiment, a conductive optical device 1 having a high productivity and excellent antireflection characteristics can be obtained as in the case where the structures 3 are arranged linearly.

### 4. Fourth Embodiment

FIG. 21A is a schematic plan view showing a structural example of a conductive optical device according to a fourth embodiment. FIG. 21B is a partially-enlarged plan view showing the conductive optical device shown in FIG. 21A.

The conductive optical device 1 of the fourth embodiment is different from that of the first embodiment in that the structures 3 are arranged meanderingly on the tracks (hereinafter, referred to as wobble track). It is desirable for the wobbles of the tracks on the substrate 2 to be synchronized. In other words, it is desirable for the wobbles to be synchronized wobbles. By thus synchronizing the wobbles, a unit cell configuration of a hexagonal lattice or a quasi-hexagonal lattice can be maintained, and the filling rate can be kept high. As a waveform of the wobble tracks, a sine curve or a triangular wave can be used, for example. The waveform of the wobble tracks is not limited to a cyclic waveform and may be a noncyclic waveform. A wobble amplitude of the wobble tracks is set to, for example, about ±10 μm.

Structures of the fourth embodiment other than that described above are the same as those of the first embodiment.

According to the fourth embodiment, since the structures 3 are arranged on the wobble tracks, it is possible to suppress unevenness in terms of an external appearance.

### 5. Fifth Embodiment

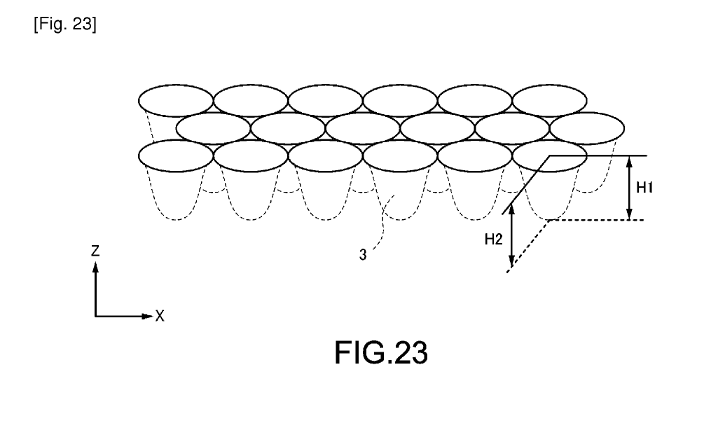

FIG. 22A is a schematic plan view showing a structural example of a conductive optical device according to a fifth embodiment. FIG. 22B is a partially-enlarged plan view of the conductive optical device shown in FIG. 22A. FIG. 22C is a cross-sectional diagram of tracks T1, T3, . . . of FIG. 22B. FIG. 22D is a cross-sectional diagram of tracks T2, T4, . . . of FIG. 22B. FIG. 23 is a partially-enlarged perspective view of the conductive optical device shown in FIG. 22A.

The conductive optical device 1 of the fifth embodiment is different from that of the first embodiment in that a large number of structures 3 as concave portions are arranged on the surface of the substrate. The structures 3 have a concave shape obtained by inverting the convex shape of the structures 3 of the first embodiment. It should be noted that when the structures 3 are formed as concave portions as described above, an opening of the structures 3 as the concave portions (entrance portion of concave portions) is defined as a lower portion, whereas a lowermost portion of the structures 3 in the depth direction (deepest portion of concave portions) is defined as an apex portion. In other words, the apex portion and the lower portion are defined by the structures 3 as an immaterial space. Moreover, since the structures 3 are concave portions in the fifth embodiment, the height H of the structures 3 in Expression (1) and the like become a depth H of the structures 3.

Structures of the fifth embodiment other than that described above are the same as those of the first embodiment.

Since the shape of the convex structures 3 of the first embodiment is inverted in the fifth embodiment, the fifth embodiment bears the same effect as the first embodiment.

### 6. Sixth Embodiment

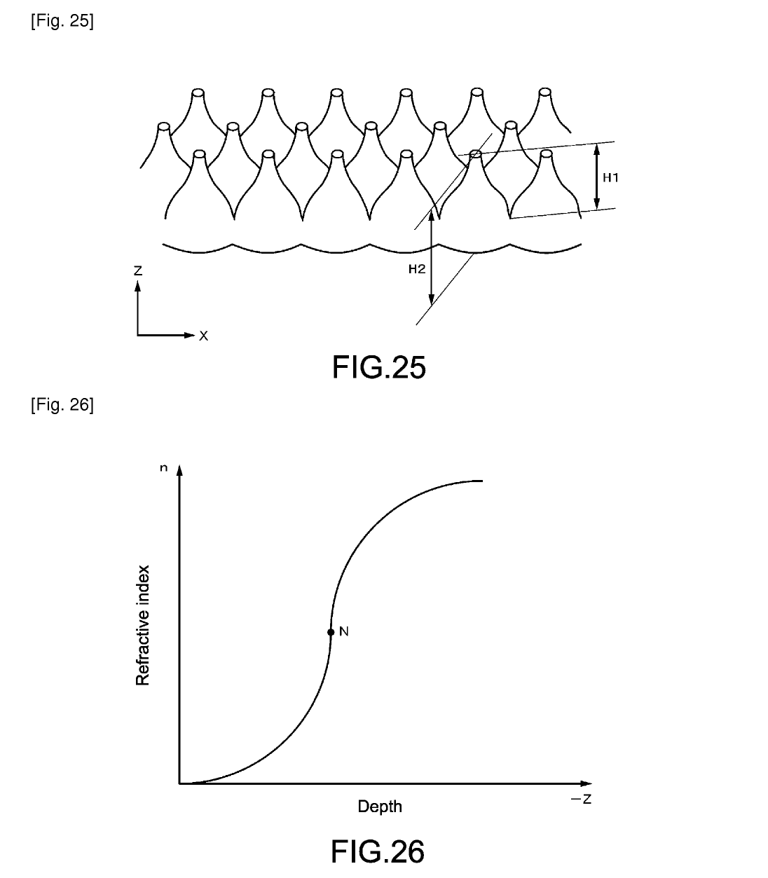

FIG. 24A is a schematic plan view showing a structural example of a conductive optical device according to a sixth embodiment. FIG. 24B is a partially-enlarged plan view of the conductive optical device shown in FIG. 24A. FIG. 24C is a cross-sectional diagram of tracks T1, T3, . . . of FIG. 24B. FIG. 24D is a cross-sectional diagram of tracks T2, T4, . . . of FIG. 24B. FIG. 25 is a partially-enlarged perspective view of the conductive optical device shown in FIG. 24A.

The conductive optical device 1 includes the substrate 2, the plurality of structures 3 formed on the surface of the substrate 2, and the transparent conductive layer 4 formed on the structures 3. It is desirable to additionally provide the metal film 5 between the structures 3 and the transparent conductive layer 4 in view of improving a surface resistance. The structures 3 are convex portions each having a pyramid shape. Lower portions of adjacent structures 3 are bonded to one another while overlapping one another. Of the adjacent structures 3, the most-adjacent structures 3 are desirably arranged in the track direction. This is because it is easy to arrange the most-adjacent structures 3 at such positions in the production method to be described later. The conductive optical device 1 has a function of preventing a reflection of light that enters the surface of the substrate on which the structures 3 are formed. In descriptions below, two axes orthogonal within, one main surface of the substrate 2 will be referred to as X axis and Y axis, respectively, and an axis vertical to the main surface of the substrate 2 will be referred to as Z axis. Moreover, when there are void portions 2a among the structures 3, it is desirable to form a minute concavoconvex configuration on the void portions 2a. By providing such a minute concavoconvex configuration, the reflectance of the conductive optical device 1 can be additionally reduced.

FIG. 26 shows an example of a refractive'index profile of the conductive optical device according to the sixth embodiment. As shown in FIG. 26, an effective index of the structure 3 with respect to the depth direction (−Z direction in FIG. 24A) gradually increases toward the substrate 2 in an S-curve. Specifically, the refractive index profile includes one inflection point N. The inflection point N corresponds to a side surface configuration of the structure 3. By thus changing the effective index, it becomes possible to reduce a reflection since boundaries become unclear for light and improve antireflection characteristics of the conductive optical device 1. It is desirable for the change of the effective index with respect to the depth direction to be a monotonic increase. Here, the S-curve includes an inverted-S-curve, that is, a Z-curve.

Moreover, it is desirable for the change of the effective index with respect to the depth direction to be sharper than a mean value of the tilt of the effective indices on at least one of the apex portion side and the substrate side of the structure 3, more desirably, sharper than a mean value of the tilt of the effective indices on both of the apex portion side and the substrate side of the structure 3. As a result, excellent antireflection characteristics can be obtained.

The lower portion of the structure 3 is bonded to the lower portion of a part or all of the adjacent structures 3, for example. By thus bonding the lower portions of the structures to one another, the change of the effective index of the structures 3 with respect to the depth direction can be made smooth. As a result, an S-shaped refractive index profile becomes possible. Further, by bonding the lower portions of the structures to one another, the filling rate of the structures can be increased. It should be noted that in FIG. 24B, positions of the bonding portions in a state where all the adjacent structures 3 are bonded to one another are indicated by black dots “•”. Specifically, the bonding portions are formed among all the adjacent structures 3, between adjacent structures 3 in the same track (e.g., between a1 to a2), or among the structures 3 across adjacent tracks (e.g., among a1 to a7 or a2 to a7). For realizing a smooth refractive index profile and obtaining excellent antireflection characteristics, it is desirable to form the bonding portions among all the adjacent structures 3. For easily forming the bonding portions in the production method to be described later, it is desirable to form the bonding portions between the adjacent structures 3 in the same track. When the structures 3 are arranged cyclically in a hexagonal lattice pattern or a quasi-hexagonal lattice pattern, the bonding portions are bonded in a direction in which the structures 3 are in a six-fold symmetry.

It is desirable to bond the structures 3 so that lower portions thereof overlap one another. By thus bonding the structures 3, an S-shaped refractive index profile can be obtained, and the filling rate of the structures 3 can be increased. It is desirable for the structures to be bonded at portions corresponding to ¼ or less the maximum value of the wavelength band of light under a usage environment in an optical path length that takes a refractive index into account. As a result, excellent antireflection characteristics can be obtained.

The height of the structures 3 is desirably set as appropriate in accordance with a wavelength range of light to be transmitted. Specifically, it is desirable for the height of the structures 3 to be 5/14 or more and 10/7 or less the maximum value of the wavelength band of light under a usage environment. When visible light is caused to transmit through the structures 3, the height of the structures 3 is desirably 100 nm to 280 nm. It is desirable to set the aspect ratio of the structures 3 (height H/arrangement pitch) to be within the range of 0.5 to 1.46. When the aspect ratio is below 0.5, the reflection characteristics and transmission characteristics tend to deteriorate, and when the aspect ratio exceeds 1.46, peeling characteristics of the structures 3 tend to deteriorate in the production of the conductive optical device 1, with the result that a replica cannot be copied beautifully.

As the material of the structures 3, a material that contains, as a main component, an ultraviolet-curable resin that cures by ultraviolet rays, an ionizing-radiation-curable resin that cures by electron beams, or a heat-curable resin that cures by heat is desirable, and a material that contains the ultraviolet-curable resin that cures by ultraviolet rays as a main component is most desirable.

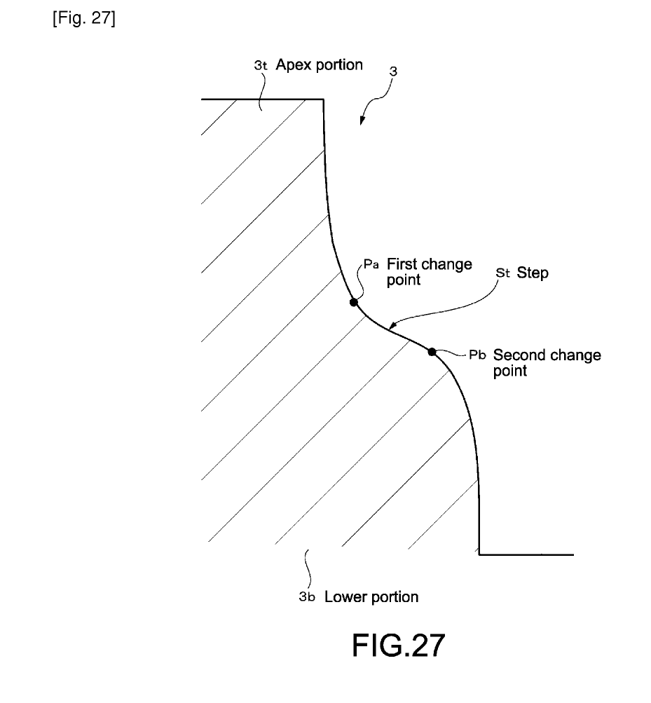

FIG. 27 is an enlarged cross-sectional diagram showing an example of the shape of the structure. It is desirable for the side surface of the structure 3 to gradually widen toward the substrate 2 in a shape of a square root of the S-curve shown in FIG. 26. With such a side surface configuration, excellent antireflection characteristics can be obtained, and a transferability of the structures 3 can be improved.

An apex portion 3t of the structure 3 has a planar shape or a convex shape that becomes thinner toward a tip end. When the apex portion 3t of the structure 3 has a planar shape, it is desirable for an area ratio of an area St of a plane of the apex portion of the structure to the area S of the unit cell (St/S) to decrease as the height of the structure 3 increases. With such a structure, the antireflection characteristics of the structures 3 can be improved. Here, the unit cell is, for example, a hexagonal lattice or a quasi-hexagonal lattice. An area ratio of the bottom surface of the structure (area ratio of area Sb of bottom surface of structure to area S of unit cell (Sb/S)) is desirably close to the area ratio of the apex portion 3t. Moreover, a low-refractive-index layer having a lower refractive index than the structures 3 may be formed at the apex portion 3t of the structures 3. By thus forming a low-refractive-index layer, the reflectance can be lowered.

It is desirable for the side surface of the structure 3 excluding the apex portion 3t and the lower portion 3b to have a pair of first change point Pa and second change point Pb in the stated order from the apex portion 3t to the lower portion 3b. Accordingly, the effective index of the structure 3 with respect to the depth direction (−Z direction in FIG. 24A) can have one inflection point.

Here, the first change point and the second change point are defined as follows.

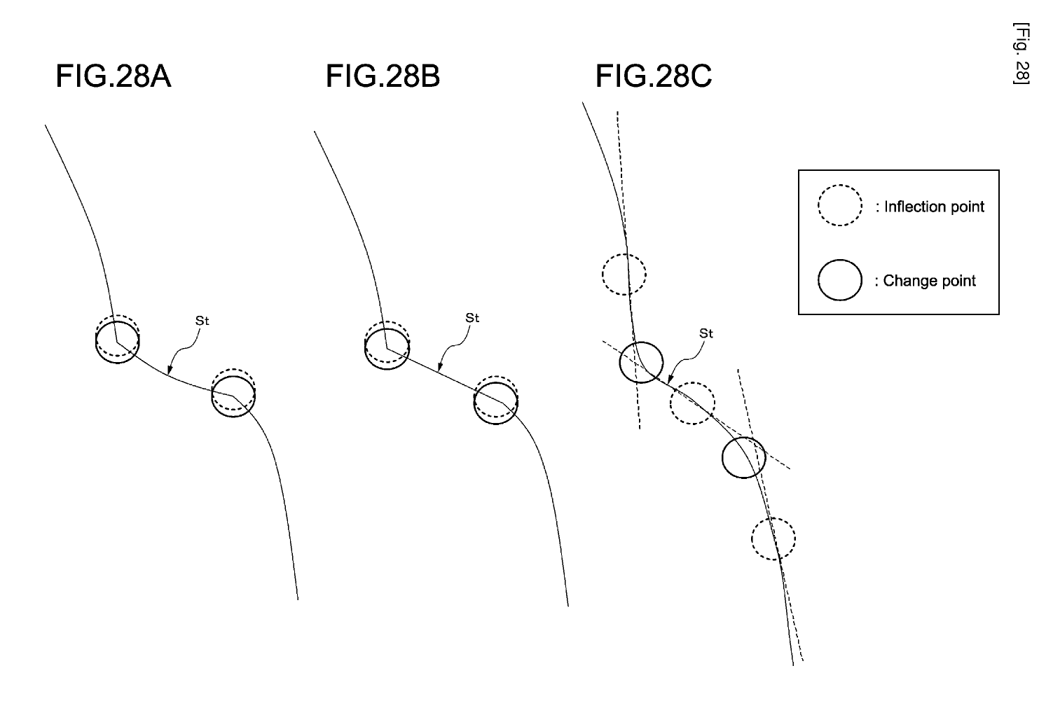

As shown in FIGS. 28A and 28B, when the side surface of the structure 3 between the apex portion 3t and the lower portion 3b is formed by discontinuously connecting a plurality of smooth curves from the apex portion 3t of the structure 3 to the lower portion 3b thereof, the connection points become the change points. The change points coincide with the inflection point. Although a differential cannot be performed at the connection points to be exact, such an inflection point as a limit is also referred to as inflection point in this case. When the structure 3 has the curved surface as described above, it is desirable for the tilt of the structure 3 from the apex portion 3t to the lower portion 3b to be gradual from the first change point Pa and become sharper from the second change point Pb.

When the side surface of the structure 3 between the apex portion 3t and the lower portion 3b is formed by continuously connecting a plurality of smooth curves from the apex portion 3t of the structure 3 to the lower portion 3b thereof as shown in FIG. 28C, the change points are defined as follows. A point closest to, in a curve, an intersection of two intersecting tangents at each of the two change points on the side surface of the structure as shown in FIG. 28C becomes the change point.

It is desirable for the structure 3 to have, on the side surface thereof between the apex portion 3t and the lower portion 3b, on step St. By thus providing one step St, the refractive index profile described above can be realized. In other words, the effective index of the structure 3 with respect to the depth direction can be gradually increased toward the substrate 2 in an S-curve. Examples of the step include an inclined step and a parallel step, but the inclined step is desirable. When the step St is an inclined step, the transferability can be made more favorable than in the case where the step St is a parallel step.

The inclined step refers to a step in which a side surface is not parallel to the surface of the substrate, but widened from the apex portion of the structure 3 toward the lower portion. The parallel step refers to a step parallel to the surface of the substrate. Here, the step St is a section set by the first change point Pa and the second change point Pb described above. It should be noted that the step St does not include a plane of the apex portion 3t and a curve or plane among structures.

It is desirable for the structure 3 to have a pyramid shape that is axisymmetric except the lower portion bonded to an adjacent structure 3 or a pyramid shape obtained by extending or contracting the pyramid shape in the track direction in view of formability. Examples of the pyramid shape include a cone shape, a cone trapezoid shape, an elliptic cone shape, and an elliptic cone trapezoid shape. Here, the pyramid shape conceptually includes, in addition to the cone shape and the cone trapezoid shape, the elliptic cone shape and the elliptic cone trapezoid shape as described above. Moreover, the cone trapezoid shape refers to a shape obtained by cutting of an apex portion of the cone shape, and the elliptic cone trapezoid shape refers to a shape obtained by cutting off an apex portion of an elliptic cone. It should be noted that the entire shape of the structure 3 is not limited to those shapes and only needs to be a shape in which the effective index of the structure 3 with respect to the depth direction gradually increases toward the substrate 2 in an S-curve. Moreover, the pyramid shape includes not only a complete pyramid shape but also a pyramid shape that includes the step St on a side surface thereof as described above.

The structure 3 having an elliptic cone shape is a convex pyramid structure in which a bottom surface has an oval shape or an egg shape having long and short axes and an apex portion becomes thinner toward a tip end. The structure 3 having an elliptic cone trapezoid shape is a pyramid structure in which a bottom surface has an oval shape or an egg shape having long and short axes and an apex portion is flat. When the structure 3 is formed in an elliptic cone shape or an elliptic cone trapezoid shape, it is desirable to form the structures 3 on the surface of the substrate such that the long-axis direction of the bottom surface of the structure 3 coincides with the track extension direction (X direction).

A cross-sectional area of the structure 3 changes with respect to the depth direction of the structure 3 so as to correspond to the refractive index profile described above. The cross-sectional area of the structure 3 desirably increases monotonically in the depth direction of the structure 3. Here, the cross-sectional area of the structure 3 refers to an area of a cross section parallel to the surface of the substrate on which the structures 3 are formed. It is desirable to change the cross-sectional area of the structures 3 in the depth direction so that a ratio of the cross-sectional areas of the structures 3 at positions with different depths corresponds to the effective index profile corresponding to those positions.

The structure 3 having the step described above is obtained by transferring a configuration using a matrix produced as described below, for example. Specifically, a matrix in which a step is formed on a side surface of a structure (concave portion) is produced by appropriately adjusting a processing time of the etching processing and the ashing processing in the etching step in the matrix production.

According to the sixth embodiment, the structures 3 each have a pyramid shape, and the effective index of the structures 3 with respect to the depth direction gradually increases toward the substrate 2 in an S-curve. As a result, a reflection can be reduced since boundaries become unclear for light by the shape effect of the structures 3. Thus, excellent antireflection characteristics can be obtained. Excellent antireflection characteristics can be obtained particularly when the height of the structures 3 is large. Moreover, since the lower portions of the adjacent structures 3 are bonded to one another while overlapping one another, the filling rate of the structures 3 can be increased, and formability of the structures 3 can be improved.

It is desirable to change the effective index profile of the structures 3 with respect to the depth direction in an S-curve and arrange the structures in a (quasi-)hexagonal lattice pattern or a (quasi-)tetragonal lattice pattern. Moreover, it is desirable for the structures 3 to have an axisymmetric structure or a structure in which the axisymmetric structure is extended or contracted in the track direction. Furthermore, it is desirable to bond the adjacent structures 3 near the substrate. With such a structure, high-performance antireflection structures that can be produced more easily can be produced.

When the conductive optical device 1 is produced by the method in which the optical disc matrix production process and the etching process are combined, a time required for the matrix production process (exposure time) can be significantly shortened as compared to the case of producing the conductive optical device 1 by an electron beam exposure. Therefore, a productivity of the conductive optical device 1 can be significantly improved.

When the apex portion of the structures 3 is not sharp and is flat, durability of the conductive optical device 1 can be improved. Moreover, the peeling characteristics of the structures 3 with respect to the roll master 11 can also be improved. When the step of the structure 3 is an inclined step, a transferability can be improved as compared to the case where the step is a parallel step.

### 7. Seventh Embodiment

FIG. 29 is a cross-sectional diagram showing a structural example of a conductive optical device according to a seventh embodiment. As shown in FIG. 29, the conductive optical device 1 of the seventh embodiment is different from that of the first embodiment in that the structures 3 are also formed on the other main surface (second main surface) on the other side of the main surface on which the structures 3 have been formed (first main surface).

The arrangement pattern, aspect ratio, and the like of the structures 3 do not need to be the same for both main surfaces of the conductive optical device 1, and different arrangement pattern and aspect ratio may be selected in accordance with desired characteristics. For example, the arrangement pattern of one main surface may be a quasi-hexagonal lattice pattern, and the arrangement pattern of the other main surface may be a quasi-tetragonal lattice pattern.

Since the plurality of structures 3 are formed on both main surfaces of the substrate 2 in the seventh embodiment, an antireflection function can be imparted to both a light-incident surface and a light-emitting surface of the conductive optical device 1. As a result, transmission characteristics can be additionally improved.

### 8. Eighth Embodiment

FIG. 30 is a cross-sectional diagram showing a structural example of a conductive optical device according to an eighth embodiment. As shown in FIG. 30, the conductive optical device 1 is different from that of the first embodiment in that a transparent conductive layer 8 is formed on the substrate 2 and a large number of structures 3 having a transparent electrical conductivity are formed on a surface of the transparent conductive layer 8. The transparent conductive layer 8 includes at least one type of material selected from the group consisting of a conductive polymer, a conductive filler, a carbon nanotube, and a conductive powder. As the conductive filler, a silver-based filler can be used, for example. As the conductive powder, an ITO powder can be used, for example.

The eighth embodiment bears the same effect as the first embodiment above.

### 9. Ninth Embodiment

FIG. 31A is a cross-sectional diagram showing a structural example of a touch panel according to a ninth embodiment. This touch panel is a so-called resistance-film-type touch panel. As the resistance-film-type touch panel, either an analog resistance-film-type touch panel or a digital resistance-film-type touch panel may be used. M shown in FIG. 31A, a touch panel 50 as an information input apparatus includes a first conductive base material 51 including a touch surface to which information is input (input surface) and a second conductive base material 52 opposed to the first conductive base material 51. It is desirable for the touch panel 50 to additionally include, on a touch-side surface of the first conductive base material 51, a hard coat layer or an antifouling hard coat layer. Moreover, a front panel may be additionally provided on the touch panel 50 as necessary. The touch panel 50 is attached to a display apparatus 54 via an adhesive layer 53, for example.

Examples of the display apparatus include various display apparatuses such as a liquid crystal display, a CRT (Cathode Ray Tube) display, a plasma display (PDP: Plasma Display Panel), an EL (Electro Luminescence) display, and an SED (Surface-conduction Electron-emitter Display).

Any of the conductive optical devices 1 according to the first to sixth embodiments is used as at least one of the first conductive base material 51 and the second conductive base material 52. When any of the conductive optical devices 1 according to the first to sixth embodiments is used for the first conductive base material 51 and the second conductive base material 52, the conductive optical devices 1 of the same embodiment or different embodiments can be used for the conductive base materials.

It is desirable to form the structures 3 on at least one of the two opposing surfaces of the first conductive base material 51 and the second conductive base material 52, or, in view of the antireflection characteristics and the transmission characteristics, form the structures 3 on both of the opposing surfaces.

It is desirable to form a single-layer or multilayer antireflection layer on the touch-side surface of the first conductive base material 51 for reducing the reflectance and improving visibility.

### Modified Example

FIG. 31B is a cross-sectional diagram showing a modified example of the structure of the touch panel according to the ninth embodiment. As shown in FIG. 31B, the conductive optical device I of the seventh embodiment is used as at least one of the first conductive base material 51 and the second conductive base material 52.

A plurality of structures 3 are formed on at least one of the opposing surfaces of the first conductive base material 51 and the second conductive base material 52. In addition, a plurality of structures 3 are also formed on at least one of the touch-side surface of the first conductive base material 51 and the surface of the second conductive base material 52 on the display apparatus 54 side. In view of the antireflection characteristics and the transmission characteristics, it is desirable to form the structures 3 on both surfaces.

Since the conductive optical device 1 is used as at least one of the first conductive base material 51 and the second conductive base material 52 in the ninth embodiment, a touch panel 50 having excellent antireflection characteristics and transmission characteristics can be obtained. Thus, visibility of the touch panel 50, particularly visibility of the touch panel 50 outside can be improved.

### 10. Tenth Embodiment

FIG. 32A is a perspective view showing a structural example of a touch panel according to a tenth embodiment. FIG. 32B is a cross-sectional diagram showing an example of the structure of the touch panel according to the tenth embodiment. The touch panel of this embodiment is different from that of the ninth embodiment in that a hard coat layer 7 formed on the touch surface is additionally provided.

The touch panel 50 includes the first conductive base material 51 including the touch surface to which information is input (input surface) and the second conductive base material 52 opposed to the first conductive base material 51. The first conductive base material 51 and the second conductive base material 52 are attached to each other via a bonding layer 55 provided between at peripheral portions thereof. As the bonding layer 55, an adhesive paste or an adhesive tape is used, for example. It is desirable to impart an antifouling property to a surface of the hard coat layer 7. The touch panel 50 is attached to the display apparatus 54 via the adhesive layer 53, for example. As the material of the adhesive layer 53, an acrylic adhesive, a rubber adhesive, and a silicon adhesive can be used, for example, but the acrylic adhesive is desirable in view of a transparency.

Since the hard coat layer 7 is formed on the touch-side surface of the first conductive base material 51 in the tenth embodiment, an abrasion resistivity of the touch surface of the touch panel 50 can be improved.

### 11. Eleventh Embodiment

FIG. 33A is a perspective view showing a structural example of a touch panel according to an eleventh embodiment. FIG. 33B is a cross-sectional diagram showing an example of the structure of the touch panel according to the eleventh embodiment. The touch panel 50 of the eleventh embodiment is different from that of the ninth embodiment in that a polarizer 58 attached to the touch-side surface of the first conductive base material 51 via a bonding layer 60 is additionally provided. When the polarizer 58 is provided as described above, it is desirable to use a λ/4-phase difference film as the substrate 2 of the first conductive base material 51 and the second conductive base material 52. By thus adopting the polarizer 58 and the substrate 2 as the λ/4-phase difference film, the reflectance can be reduced, and visibility can be improved.

It is desirable to form a single-layer or multilayer antireflection layer (not shown) on the touch-side surface of the first conductive base material 51 for reducing the reflectance and improving visibility. Moreover, a front panel (surface member) 59 attached to the touch-side surface of the first conductive base material 51 via a bonding layer 61 or the like may be additionally provided. As in the first conductive base material 51, a large number of structures 3 may be formed on at least one of the main surfaces of the front panel 59. FIG. 33 show an example in which the large number of structures 3 are formed on a light-incident surface of the front panel 59. Moreover, a glass substrate 56 may be attached to the surface of the second conductive base material 52 on a side that is attached to the display apparatus 54 or the like via a bonding layer 57 or the like.

It is desirable to also form a plurality of structures 3 on a peripheral portion of at least one of the first conductive base material 51 and the second conductive base material 52 since adhesiveness between the first conductive base material 51 or the second conductive base material 52 and the bonding layer 55 can be improved by an anchor effect.

Furthermore, it is desirable to also form a plurality of structures 3 on the surface of the second conductive base material 52 that is attached to the display apparatus 54 or the like since adhesiveness between the touch panel 50 and the bonding layer 57 can be improved by the anchor effect of the plurality of structures 3.

### 12. Twelfth Embodiment

FIG. 34 is a cross-sectional diagram showing a structural example of a touch panel according to a twelfth embodiment. The touch panel 50 of the twelfth embodiment is different from that of the ninth embodiment in that at least one of the first conductive base material 51 and the second conductive base material 52 includes the plurality of structures 3 on a peripheral portion thereof. The peripheral portions of the first conductive base material 51 and the second conductive base material 52 each include at least one of a wiring layer 71 having a predetermined pattern, an insulation layer 72 that covers the wiring layer 71, and the bonding layer 5.5 for bonding the base materials. Further, out of the main surfaces of the second conductive base material 52, a large number of dot spacers 73 are formed on the surface opposed to the first conductive base material 51.

The wiring layer 71 is used for forming a parallel electrode, a handling circuit, or the like and contains, as a main component, a wiring material such as a thermal-dry-type or heat-curable conductive paste. As the conductive paste, a silver paste can be used, for example. The insulation layer 72 is used for securing an insulation property of the wiring layer 71 of each of the base materials and preventing a short circuit from occurring, and is formed of an insulation material such as an ultraviolet-curable or heat-curable insulation paste or an insulation tape. The bonding layer 55 is used for bonding the base materials and contains, as a main component, an adhesive such as an ultraviolet-curable or heat-curable adhesive paste. The dot spacers 73 are used for securing a gap between the base materials and preventing the base materials from coming into contact with each other and contain, as a main component, an ultraviolet-curable, heat-curable, or photolithography-type dot spacer paste.

Since at least one of the first conductive base material 51 and the second conductive base material 52 includes the plurality of structures 3 at the peripheral portion in the twelfth embodiment, an anchor effect can be obtained. Therefore, adhesiveness of the wiring layer 71, the insulation layer 72, and the bonding layer 55 can be improved. Moreover, when a large number of structures 3 are formed on an electrode surface of the second conductive base material 52 to be a lower electrode, adhesiveness of the dot spacers 73 can be improved.

Moreover, it is desirable to also form the plurality of structures 3 on the surface of the second conductive base material 52 bonded to the display apparatus 54 as shown in FIG. 34 since adhesiveness of the touch panel 50 and the display apparatus 54 can be improved by the anchor effect of the plurality of structures 3.

### 13. Thirteenth Embodiment

FIG. 35 is a cross-sectional diagram showing a structural example of a liquid crystal display apparatus according to a thirteenth embodiment. As shown in FIG. 35, a liquid crystal display apparatus 70 of the thirteenth embodiment includes a liquid crystal panel (liquid crystal layer) 71 including first and second main surfaces, a first polarizer 72 formed on the first main surface, a second polarizer 73 formed on the second main surface, and the touch panel 50 interposed between the liquid crystal panel 71 and the first polarizer 72. The touch panel 50 is a liquid-crystal-display-integrated touch panel (so-called inner touch panel). A large number of structures 3 may be directly formed on a surface of the first polarizer 72. When the first polarizer 72 has a protection layer such as a TAC (triacetyl cellulose) film on the surface, it is desirable to directly form the large number of structures 3 on the protection layer. By thus forming the large number of structures 3 on the first polarizer 72, the liquid crystal display apparatus 70 can be made thinner.

(Liquid Crystal Panel)

As the liquid crystal panel 71, a panel in a display mode such as a TN (Twisted Nematic) mode, an STN (Super Twisted Nematic) mode, a VA (Vertically Aligned) mode, an IPS (In-Plane Switching) mode, an OCB (Optically Compensated Birefringence) mode, an FLC (Ferroelectric Liquid Crystal) mode, a PDLC (Polymer Dispersed Liquid Crystal) mode, and a PCGH (Phase Change Guest Host) mode can be used.

(Polarizer)

The first polarizer 72 and the second polarizer 73 are bonded to the first and second main surfaces of the liquid crystal panel 71 via bonding layers 74 and 75 such that transmission axes thereof become mutually orthogonal. The first polarizer 72 and the second polarizer 73 transmit only one of the orthogonal polarization components out of incident light and blocks the other polarization component by absorption. As the first polarizer 72 and the second polarizer 73, those obtained by arranging an iodine complex or a dichroic dye on a polyvinyl alcohol (PVA) film can be used, for example. It is desirable to provide a protection layer such as a TAC (triacetyl cellulose) film on both surfaces of the first polarizer 72 and the second polarizer 73.

(Touch Panel)

Any of the touch panels according to the ninth to twelfth embodiments can be used as the touch panel 50.

Since the first polarizer 72 is shared by the liquid crystal panel 71 and the touch panel 50 in the eleventh embodiment, optical characteristics can be improved.

### 14. Fourteenth Embodiment

FIG. 36A is a cross-sectional diagram showing a first example of a structure of a touch panel according to a fourteenth embodiment. FIG. 36B is a cross-sectional diagram showing a second example of the structure of the touch panel according to the fourteenth embodiment. The touch panel 50 of the fourteenth embodiment is a so-called capacitance-type touch panel, and a large number of structures 3 are formed on at least one of a surface or an inner portion thereof. The touch panel 50 is bonded to the display apparatus 54 via the adhesive layer 53, for example.

(First Structural Example)

As shown in FIG. 36A, the touch panel 50 of the first structural example includes the substrate 2, the transparent conductive layer 4 formed on the substrate 2, and a protection layer 9. A large number of structures 3 are formed on at least one of the substrate 2 and the protection layer 9 at minute pitches equal to or smaller than the wavelength of visible light. It should be noted that FIG. 36A shows an example in which the large number of structures 3 are formed on the surface of the substrate 2. As the capacitance-type touch panel, any of a surface-capacitance-type touch panel, an inner-capacitance-type touch panel, and a projection-capacitance-type touch panel may be used. When a peripheral member such as a wiring layer is formed on the peripheral portion of the substrate 2, it is desirable to also form the large number of structures 3 on the peripheral portion of the substrate 2 as in the twelfth embodiment since adhesiveness of the peripheral member such as a wiring layer and the substrate 2 can be improved.

The protection layer 9 is a dielectric layer that contains a dielectric material such as SiO2 as a main component. The transparent conductive layer 4 has a structure that differs depending on the type of the touch panel 50. For example, when the touch panel 50 is a surface-capacitance-type touch panel or an inner-capacitance-type touch panel, the transparent conductive layer 4 is a thin film having a substantially uniform thickness. When the touch panel 50 is a projection-capacitance-type touch panel, the transparent conductive layer 4 is a transparent electrode pattern such as a lattice shape arranged at predetermined pitches. The same material as the transparent conductive layer 4 of the first embodiment can be used as the material of the transparent conductive layer 4 of the first structural example. Other than that are the same as those of the ninth embodiment.

(Second Structural Example)

As shown in FIG. 36B, the touch panel 50 of the second structural example is different from that of the first structural example in that the large number of structures 3 are formed on the surface of the protection layer 9, that is, the touch surface at minute pitches equal to or smaller than the wavelength of visible light, instead of the inner portion of the touch panel 50. It should be noted that it is also possible to form the large number of structures 3 on the back surface on a side that is bonded to the display apparatus 54.

Since the large number of structures 3 are formed on at least one of the surface or inner portion of the capacitance-type touch panel 50 in the fourteenth embodiment, the fourteenth embodiment bears the same effect as the eight embodiment.

### EXAMPLES

Hereinafter, the embodiments will be described in detail by means of examples, but the embodiments are not limited to those examples.

The examples and experimental examples will be described in the following order.

1. Optical characteristics of conductive optical sheet

2. Relationship of structure with optical characteristics and surface resistance

3. Relationship of thickness of transparent conductive layer with optical characteristics and surface resistance

4. Comparison with other types of low-reflection conductive film

5. Relationship between structure and optical characteristics

6. Relationship between shape and optical characteristics of transparent conductive layer

7. Relationship among filling rate, diameter ratio, and reflectance characteristics (simulation)

8. Optical characteristics of touch panel that uses conductive optical sheet

9. Improvement of adhesiveness by moth-eye structures

(Height H, arrangement pitch P, and aspect ratio (H/P))

In the following examples, the height H, the arrangement pitch P, and the aspect ratio (H/P) of the structures of the conductive optical sheet were determined as follows.

First, a surface configuration of an optical sheet was photographed by an AFM (Atomic Force Microscope) in a state where a transparent conductive layer is not deposited. Then, the arrangement pitch P and the height H of the structures were obtained from the photographed AFM image and a cross-sectional profile thereof. Next, the arrangement pitch P and the height H were used to obtain an aspect ratio (H/P).

(Mean Film Thickness of Transparent Conductive Layer)

In the following examples, the mean film thickness of the transparent conductive layer was obtained as follows.

First, the conductive optical sheet was cut in the track extension direction so as to include an apex portion of the structures, and a cross section thereof was photographed by a TEM (Transmission Electron Microscope). The film thickness D1 of the transparent conductive layer at the apex portion of the structures was measured from the photographed TEM photograph. This measurement was repeated at 10 spots randomly selected from the conductive optical sheet, and the measurement values were simply averaged (arithmetic mean) to obtain a mean film thickness Dm1 which was used as the mean film thickness of the transparent conductive layer.

Further, the mean film thickness Dm1 of the transparent conductive layer at the apex portion of the structure as a convex portion, the mean film thickness Dm2 of the transparent conductive layer at the slanted surface of the structure as a convex portion, and the mean film thickness Dm3 of the transparent conductive layer between adjacent structures as convex portions were obtained as follows.

First, the conductive optical sheet was cut in the track extension direction so as to include an apex portion of the structures, and a cross section thereof was photographed by a TEM. The film thickness D1 of the transparent conductive layer at the apex portion of the structures was measured from the photographed TEM photograph. Then, the film thickness D2 at half the height (H/2) of the structure 3 was measured out of the positions on the slanted surface of the structure 3. Subsequently, the film thickness D3 at a position at which the depth of the concave portion becomes largest out of the positions of the concave portion between the structures was measured. Then, the film thicknesses D1, D2, and D3 were repetitively measured at 10 spots randomly selected from the conductive optical sheet, and the measured values D1, D2, and D3 were simply averaged (arithmetic mean) to obtain mean film thicknesses Dm1, Dm2, and Dm3.

Moreover, the mean film thickness Dm1 of the transparent conductive layer at the apex portion of the structure as a concave portion, the mean film thickness Dm2 of the transparent conductive layer at the slanted surface of the structure as a concave portion, and the mean film thickness Dm3 of the transparent conductive layer between adjacent structures as concave portions were obtained as follows.

First, the conductive optical sheet was cut in the track extension direction so as to include an apex portion of the structures, and a cross section thereof was photographed by a TEM. The film thickness D1 of the transparent conductive layer at the apex portion of the structures as an immaterial space was measured from the photographed TEM photograph. Then, the film thickness D2 at half the height (H/2) of the structure was measured out of the positions on the slanted surface of the structure. Subsequently, the film thickness D3 at a position at which the height of the convex portion becomes largest out of the positions of the convex portion between the structures was measured. Then, the film thicknesses D1, D2, and D3 were repetitively measured at 10 spots randomly selected from the conductive optical sheet, and the measured values D1, D2, and D3 were simply averaged (arithmetic mean) to obtain mean film thicknesses Dm1, Dm2, and Dm3.

<1. Optical Characteristics of Conductive Optical Sheet>

### Example 1

First, a glass roll matrix having an outer diameter of 126 mm was prepared, and a resist layer was deposited on a surface of the glass matrix as follows. Specifically, the resist layer was deposited by diluting a photoresist to 1/10 by a thinner and applying the diluted resist onto a columnar surface of the glass roll matrix by a thickness of about 70 nm by dipping. Next, the glass roll matrix as a recording medium was conveyed to the roll matrix exposure apparatus shown in FIG. 11 so that the resist layer is exposed. As a result, a latent image as a single spiral string, that forms a hexagonal lattice pattern across three adjacent tracks is patterned on the resist layer.

Specifically, laser light having power of 0.50 mW/m that exposes even the surface of the glass roll matrix was irradiated onto an area in which the hexagonal lattice pattern is to be formed, to thus form a concave hexagonal lattice pattern. It should be noted that the thickness of the resist layer in the track row direction was about 60 nm, and the thickness thereof in the track extension direction was about 50 nm.

Next, the resist layer on the glass roll matrix was subjected to development processing in which the resist layer at the exposed portion was melted and developed. Specifically, an undeveloped glass roll matrix was placed on a turntable of a developing machine (not shown), and a developer was dropped onto the surface of the glass roll matrix while rotating the whole turntable, to thus develop the resist layer on the surface of the matrix. As a result, a resist glass matrix in which the resist layer is opened in a hexagonal lattice pattern was obtained.

Subsequently, plasma etching was carried out in a CHF3 gas atmosphere using a roll etching apparatus. Accordingly, the etching progressed in only the portion that is exposed from the resist layer and corresponds to the hexagonal lattice pattern on the surface of the glass roll matrix, and other areas were not etched since the resist layer functions as a mask, with the result that concave portions having an elliptic cone shape were obtained. An etching amount (depth) in the patterning at this time was changed by the etching time. Finally, by completely removing the resist layer by O2 ashing, a concave hexagonal lattice moth-eye glass roll master was obtained. A depth of the concave portion in the row direction was deeper than that of the concave portion in the track extension direction.

Next, the moth-eye glass roll master and an acrylic sheet onto which an ultraviolet-curable resin has been applied are brought into close contact with each other, and the acrylic sheet was peeled off while being irradiated with ultraviolet rays to be cured. As a result, an optical sheet on which a plurality of structures are arranged on one main surface was obtained. Next, an IZO film having a film thickness of 30 nm was deposited on the structures by a sputtering method.

The target conductive optical sheet was produced by the method described above.

### Example 2

A conductive optical sheet was produced by the same method as in Example 1 except that the IZO film having a film thickness of 160 nm was formed on the structures.

### Example 3

First, an optical sheet on which a plurality of structures are arranged was produced on one surface by the same method as in Example 1. Next, a plurality of structures were formed on the other main surface of the optical sheet by a method that is the same as the method of forming a plurality of structures on one main surface. As a result, an optical sheet on which a plurality of structures are formed on both surfaces was produced. Next, an IZO film having a mean film thickness of 30 nm was deposited on the structures formed on one main surface by a sputtering method. As a result, a conductive optical sheet on which the plurality of structures are formed on both surfaces was produced.

### Comparative Example 1

An optical sheet was produced by the same method as Example 1 except that the step of depositing an IZO film was omitted.

### Comparative Example 2

A conductive optical sheet was produced by depositing an IZO film having a film thickness of 30 nm on a surface of a smooth acrylic sheet by a sputtering method.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 1.

(Surface Resistance Evaluation)

A surface resistance of the conductive optical sheets produced as described above was measured by a four-terminal method (JIS K 7194). The results are shown in Table 1.

(Reflectance/Transmittance Evaluation)

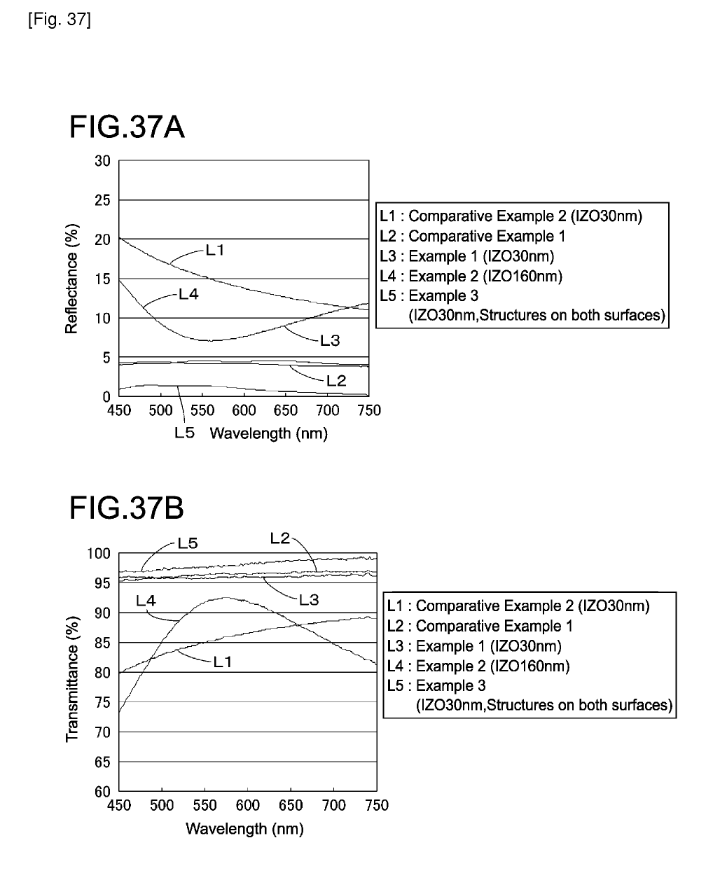

A reflectance and transmittance of the conductive optical sheets produced as described above were evaluated using an evaluation apparatus (V-550) available from JASCO Corporation. The results are shown in FIGS. 37A and 37B.

TABLE 1

| | | | | Compar- | Compar- |
|---|---|---|---|---|---|
| | Example | Example | Example | ative | ative Ex- |
| | 1 | 2 | 3 | Example 1 | ample 2 |
| Arrangement | Hexagonal | Hexagonal | Hexagonal | Hexagonal | — |
| pattern | lattice | lattice | lattice | lattice | |
| Structure | Cone | Cone | Cone | Cone | — |
| shape | shape | shape | shape | shape | |
| Concavity | Convex | Convex | Convex | Convex | — |
| and convexity | shape | shape | shape | shape | |
| of structures | | | | | |
| Structure | One | One | Both | One | — |
| forming | surface | surface | surfaces | surface | |
| surface | | | | | |
| Pitch (mm) | 250 | 250 | 250 | 250 | — |
| Height (nm) | 300 | 300 | 300 | 300 | — |
| Aspect ratio | 1.2 | 1.2 | 1.2 | 1.2 | — |
| Mean film | 30 | 160 | 30 | — | 30 |
| thickness (nm) | | | | | |
| Surface | 4000 | 2000 | 2000 | 2000 | 270 |
| resistance | | | | | |
| (Ω/□) | | | | | |

It should be noted that in Table 1, a conic shape refers to an elliptic cone shape having a curved apex portion.

The following can be found from the evaluation result above.

The surface resistance in Comparative Example 2 was 270Ω/□ when measured by the four-terminal method (JIS K 7194). On the other hand, in Example 1 in which a moth-eye structure is formed on the surface, when a transparent conductive layer (IZO film) having a resistance of 2.0*10-4 Ωcm is deposited to have a film thickness of 30 nm by a plate conversion, the mean film thickness becomes about 30 nm. The surface resistance at this time becomes 4000Ω/□ even when an increase of a surface area is taken into account. This level is of no problem as a resistance-film-type touch panel.

As shown in FIGS. 37A and 37B, Example 1 has characteristics that are of an equivalent level as Comparative Example 1 in which the transparent conductive layer is not formed and only the moth-eye structures are formed on the surface. Moreover, in Example 1, more excellent optical characteristics are obtained than in Comparative Example 1 in which the transparent conductive layer having a comparable level of surface resistance is deposited on a smooth sheet.

Since a transparent conductive layer (IZO film) having a thickness of 160 nm in a plate conversion (mean film thickness) is deposited in Example 2, the transmittance tends to be lowered. This is considered to be because, since the transparent conductive layer is formed to be excessively thick, the moth-eye structures lose their shapes, and it thus becomes difficult to maintain a desired shape. In other words, by forming the transparent conductive layer to be excessively thick, it becomes difficult to cause a thin film to grow while maintaining the shape of the moth-eye structures. However, even when the shape is not maintained as described above, the optical characteristics are more excellent than those of Comparative Example 2 in which only the transparent conductive layer is deposited on a smooth sheet.

In Example 3 in which the moth-eye structures are formed on both surfaces, the antireflection function is improved as compared to Example 1 in which the moth-eye structures are formed on one surface. It can be seen from FIG. 37B that characteristics in which the transmittance is as high as 97% to 99% are realized.

<2. Relationship of Structure with Optical Characteristics and Surface Resistance>

### Examples 4 to 6

A conductive optical sheet was produced by the same method as in Example 1 except that a hexagonal lattice pattern was recorded onto a resist layer by adjusting a frequency of a polarity reversion formatter signal, an rpm of a roll, and a feeding pitch for each track and patterning the resist layer.

### Example 7

A conductive optical sheet in which a plurality of concave structures (structures of reverse pattern) are formed on a surface was produced by the same method as in Example 1 except that the concavities and convexities of Example 6 were inversed.

### Comparative Example 3

A conductive optical sheet was produced by the same method as in Example 4 except that the deposition of an IZO film was omitted.

### Comparative Example 4

A conductive optical sheet was produced by the same method as in Example 6 except that the deposition of an IZO film was omitted.

### Comparative Example 5

A conductive optical sheet was produced by depositing an IZO film having a film thickness of 40 nm on a smooth acrylic sheet by a sputtering method.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 2.

(Surface Resistance Evaluation)

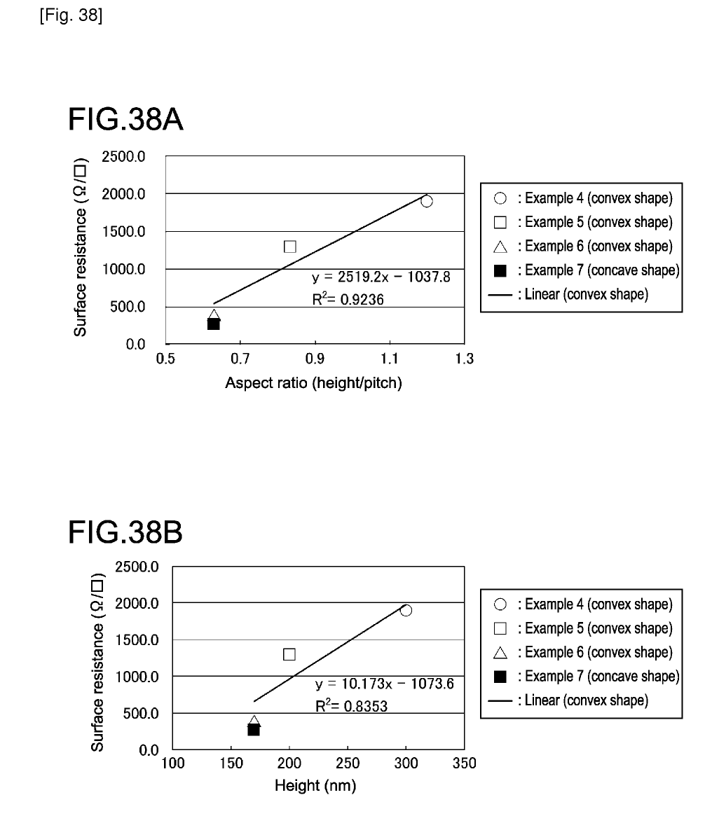

A surface resistance of the conductive optical sheets produced as described above was measured by a four-terminal method. The results are shown in Table 2. Moreover, FIG. 38A shows a relationship between the aspect ratio and the surface resistance. FIG. 38B shows a relationship between the height of the structures and the surface resistance.

(Reflectance/Transmittance Evaluation)

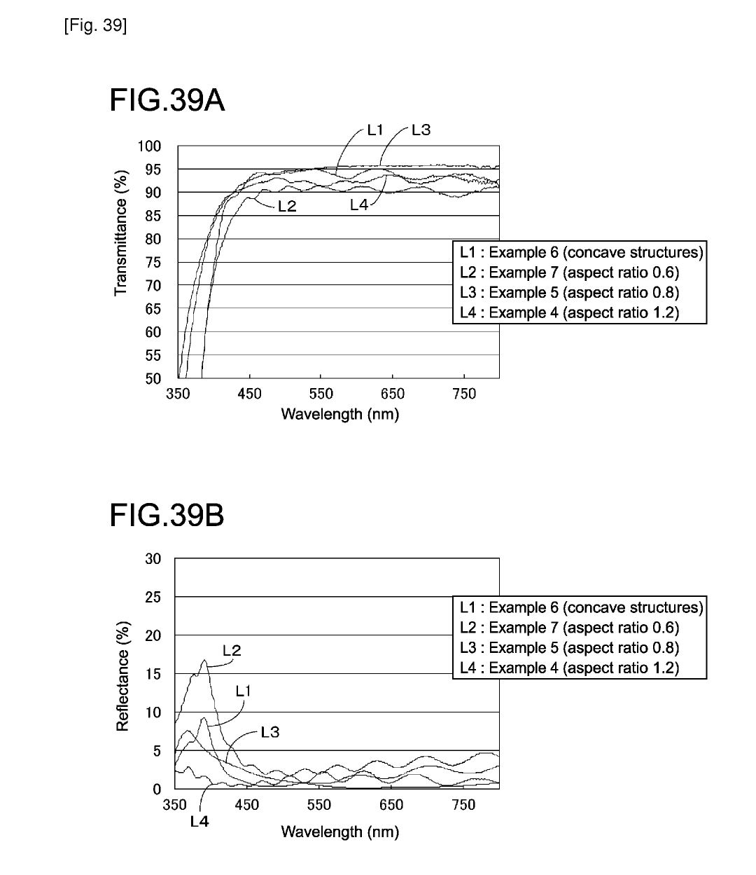

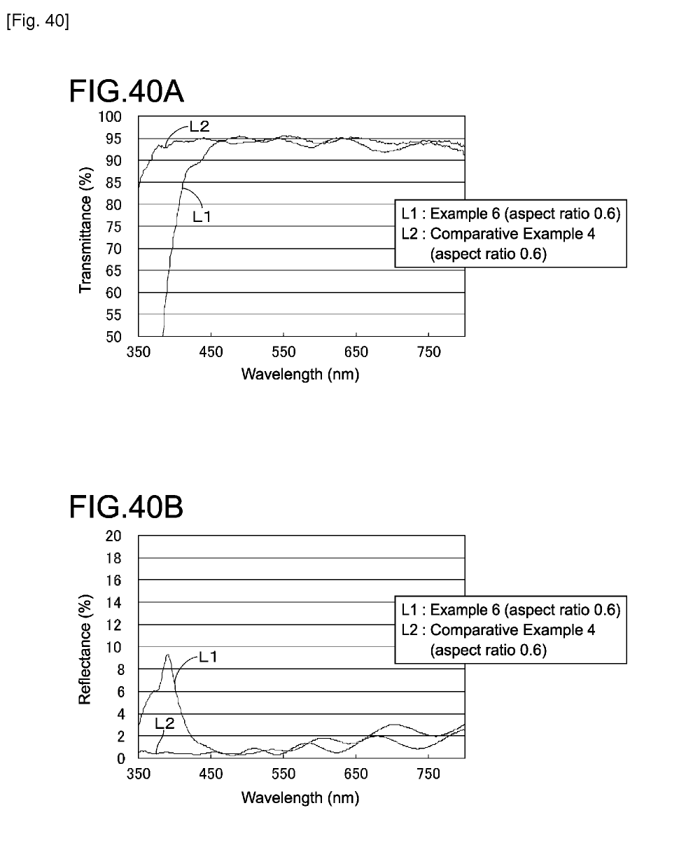

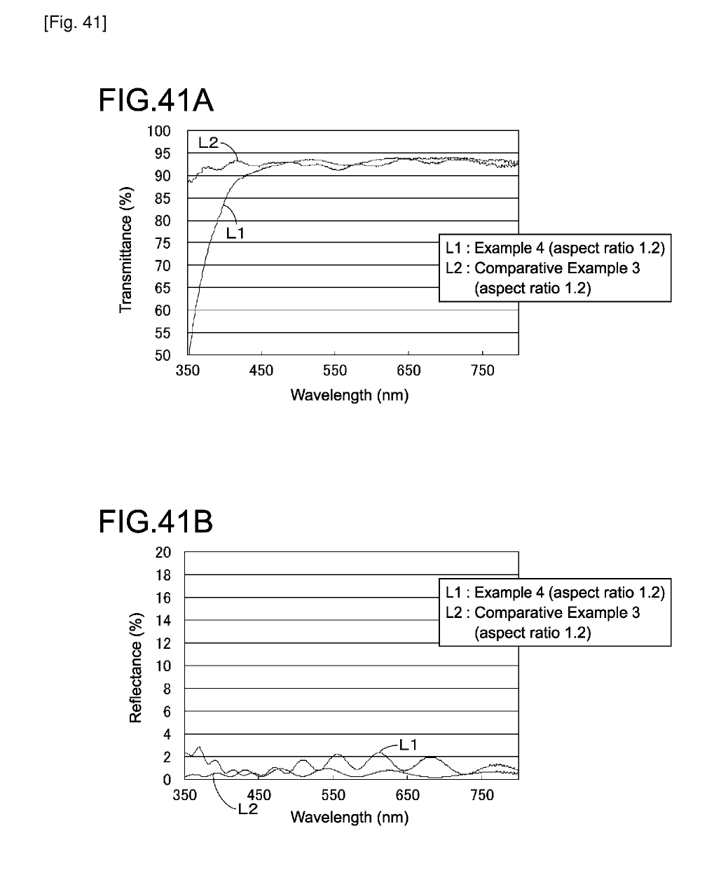

A reflectance and transmittance of the conductive optical sheets produced as described above were evaluated using an evaluation apparatus (V-550) available from JASCO Corporation. The results are shown in FIGS. 39A and 39B. Moreover, FIGS. 40A and 40B respectively show transmission characteristics and reflection characteristics of Example 6 and Comparative Example 4, and FIGS. 41A and 41B respectively show transmission characteristics and reflection characteristics of Example 4 and Comparative Example 3.

TABLE 2

| | | | | | Comparative | Comparative | Comparative |
|---|---|---|---|---|---|---|---|
| | Example 4 | Example 5 | Example 6 | Example 7 | Example 3 | Example 4 | Example 5 |
| Arrangement pattern | Hexagonal | Hexagonal | Hexagonal | Hexagonal | Hexagonal | Hexagonal | — |
| | lattice | lattice | lattice | lattice | lattice | lattice | |
| Structure shape | Cone | Cone | Cone | Cone | Cone | Cone | — |
| | shape | shape | shape | shape | shape | shape | |
| Concavity and convexity | Convex | Convex | Convex | Concave | Convex | Convex | — |
| of structures | shape | shape | shape | shape | shape | shape | |
| Structure forming | One | One | One | One | One | One | — |
| surface | surface | surface | surface | surface | surface | surface | |
| Pitch (mm) | 250 | 240 | 270 | 270 | 250 | 270 | — |
| Height (nm) | 300 | 200 | 170 | 170 | 300 | 170 | — |
| Aspect ratio | 1.2 | 0.8 | 0.6 | 0.6 | 1.2 | 0.6 | — |
| Mean film thickness | 40 | 40 | 40 | 40 | — | — | 40 |
| (nm) | | | | | | | |
| Surface resistance | 1900.0 | 1300.0 | 395.0 | 269.0 | — | — | 122.0 |
| (Ω/□) | | | | | | | |

It should be noted that in Table 2, a conic shape refers to an elliptic cone shape having a curved apex portion.

The following can be found from FIGS. 38A and 38B.

The aspect ratio of the structures and the surface resistance are in a correlation, and the surface resistance tends to increase almost proportional to the value of the aspect ratio. This is considered to be because the film thickness of the transparent conductive layer decreases as the slanted surfaces of the structures become steeper, or the surface area increases as the height or depth of the structures increases, thus resulting in a high resistance.

Since the touch panel is generally required to have a surface resistance of 500 to 300Ω/□, it is desirable to appropriately adjust the aspect ratio so that a desired resistance value can be obtained when applying the present embodiment to a touch panel.

The following can be found from FIGS. 39A, 39B, 40A, and 40B.

Although the transmittance tends to decrease when the wavelength is shorter than 450 nm, excellent transmission characteristics can be obtained when the wavelength is within the range of 450 nm to 800 nm. In addition, a decrease of the transmittance on the shorter-wavelength side can be suppressed more as the aspect ratio of the structures increases.

Although the reflectance tends to increase when the wavelength is shorter than 450 nm, excellent reflection characteristics can be obtained when the wavelength is within the range of 450 nm to 800 nm. In addition, an increase of the reflectance on the shorter-wavelength side can be suppressed more as the aspect ratio of the structures increases.

Optical characteristics of Example 6 in which the convex structures are formed are more excellent than those of Example 7 in which the concave structures are formed.

The following can be found from FIGS. 41A and 41B.

In Example 4 in which the aspect ratio is 1.2, a change of the optical characteristics is suppressed low as compared to Example 6 in which the aspect ratio is 0.6. This is considered to be because the surface area of Example 4 in which the aspect ratio is 1.2 is larger than that of Example 6 in which the aspect ratio is 0.6, and the film thickness of the transparent conductive layer with respect to the structures is thin.

<3. Relationship of Thickness of Transparent Conductive Layer with Optical Characteristics and Surface Resistance>

### Example 8

A conductive optical sheet was produced by the same method as in Example 6 except that the mean film thickness of the IZO film was set to be 50 nm.

### Example 9

A conductive optical sheet was produced by the same method as in Example 6.

### Example 10

A conductive optical sheet was produced by the same method as in Example 6 except that the mean film thickness of the IZO film was set to be 30 nm.

### Comparative Example 6

A conductive optical sheet was produced by the same method as in Example 6 except that the deposition of an IZO film was omitted.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 3.

(Surface Resistance Evaluation)

A surface resistance of the conductive optical sheets produced as described above was measured by a four-terminal method (JIS K 7194). The results are shown in Table 3.

(Reflectance/Transmittance Evaluation)

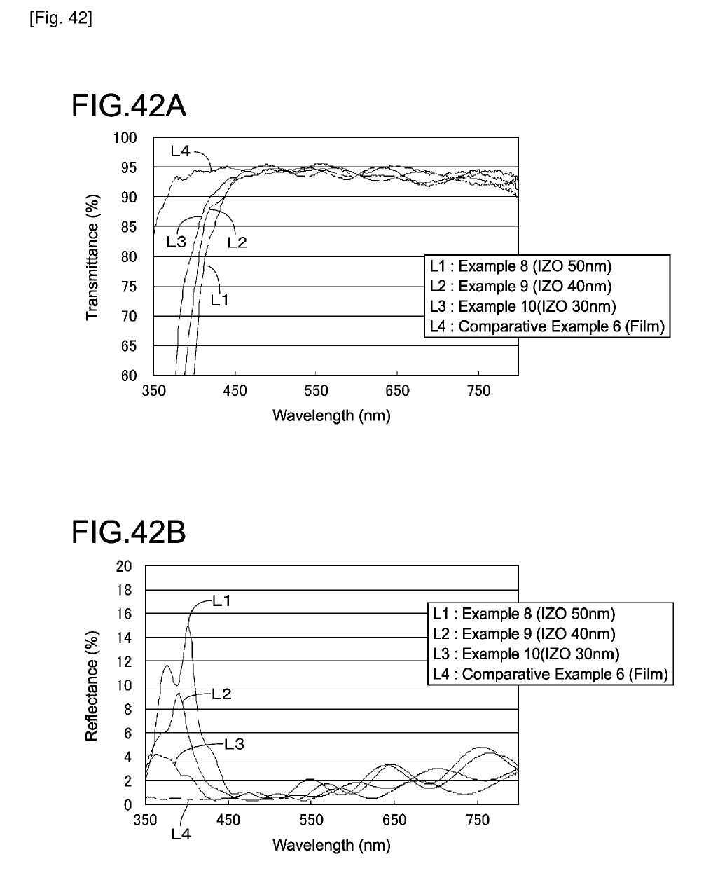

A reflectance and transmittance of the conductive optical sheets produced as described above were evaluated using an evaluation apparatus (V-550) available from JASCO Corporation. The results are shown in FIGS. 42A and 42B.

TABLE 3

| | | | | Comparative |
|---|---|---|---|---|
| | Example | Example | Example | Example |
| | 8 | 9 | 10 | 6 |
| Arrangement | Hexagonal | Hexagonal | Hexagonal | Hexagonal |
| pattern | lattice | lattice | lattice | lattice |
| Structure | Cone | Cone | Cone | Cone |
| shape | shape | shape | shape | shape |
| Concavity | Convex | Convex | Convex | Convex |
| and convexity | shape | shape | shape | shape |
| of structures | | | | |
| Structure | One | One | One | One |
| forming | surface | surface | surface | surface |
| surface | | | | |
| Pitch (mm) | 270 | 270 | 270 | 270 |
| Height (nm) | 170 | 170 | 170 | 170 |
| Aspect ratio | 0.6 | 0.6 | 0.6 | 0.6 |
| Mean film | 50 | 40 | 30 | — |
| thickness (nm) | | | | |
| Surface | 270(77) | 395(122) | 590(169) | — |
| resistance | | | | |
| (Ω/□) | | | | |

It should be noted that the resistance values in parentheses are values obtained by measuring resistance values of the IZO films each deposited on a smooth sheet under the same deposition condition.

The following can be found from FIGS. 42A and 42B.

The reflectance and transmittance on the shorter-wavelength side with respect to 450 nm tend to decrease as the mean film thickness increases.

Summing up the evaluation results of <2. Relationship of structure with optical characteristics and surface resistance> and <3. Relationship of thickness of transparent conductive layer with optical characteristics and surface resistance>, the following can be found.

The optical characteristics on the longer-wavelength side hardly change before and after the deposition of the transparent conductive layer on the structures, whereas the optical characteristics on the shorter-wavelength side tend to change before and after the deposition of the transparent conductive layer on the structures.

Although the optical characteristics are favorable when the structures have a shape with a high aspect ratio, the surface resistance tends to increase.

The reflectance on the shorter-wavelength side tends to increase as the film thickness of the transparent conductive layer increases.

The surface resistance and the optical characteristics are in a trade-off relationship.

<4. Comparison with other Types of Low-Reflection Conductive Film>

### Example 11

A conductive optical sheet was produced by the same method as in Example 5.

### Example 12

A conductive optical sheet was produced by the same method as in Example 6 except that the film thickness of the IZO film was set to be 30 nm.

### Comparative Example 7

A conductive optical sheet was produced by depositing an IZO film having a film thickness of 30 nm on a surface of a smooth acrylic sheet by a sputtering method.

### Comparative Example 8

An optical film having N of about 2.0 and an optical film having N of about 1.5 were sequentially deposited on a film by a PVD method, and a conductive film was additionally deposited thereon.

### Comparative Example 9

An optical film having N of about 2.0 and an optical film having N of about 1.5 were sequentially deposited on a film in four layers by a PVD method, and a conductive film was additionally deposited thereon.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 4.

(Reflectance/Transmittance Evaluation)

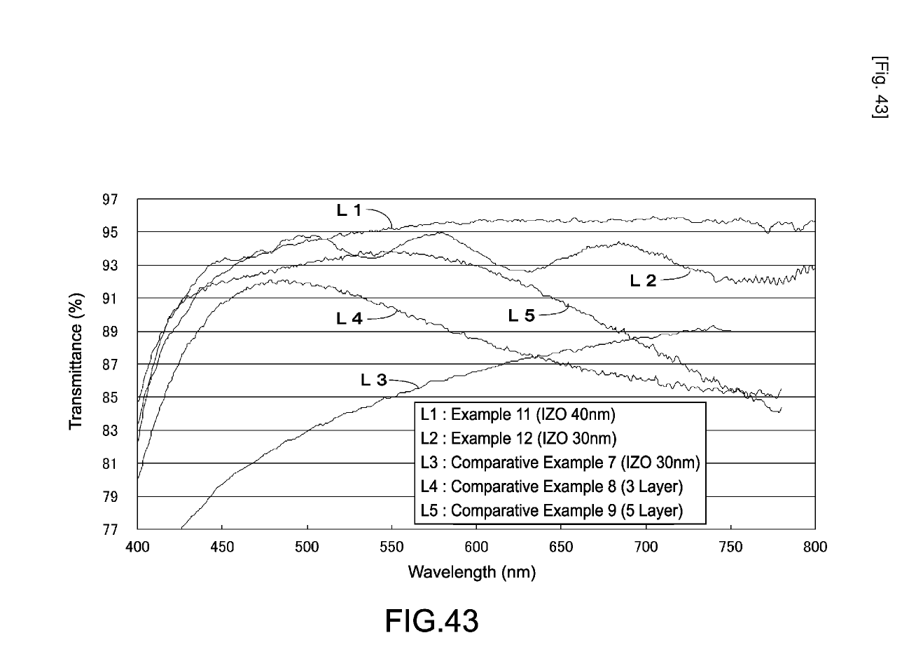

A transmittance of the conductive optical sheets produced as described above was evaluated using an evaluation apparatus (V-550) available from JASCO Corporation. The results are shown in FIG. 43.

TABLE 4

| | | | Compar- | Compar- | Compar- |
|---|---|---|---|---|---|
| | Example | Example | ative | ative | ative |
| | 11 | 12 | Example 7 | Example 8 | Example 9 |
| Arrangement | Hexa- | Hexa- | — | — | — |
| pattern | gonal | gonal | | | |
| | lattice | lattice | | | |
| Structure | Cone | Cone | — | — | — |
| shape | shape | shape | | | |
| Concavity | Convex | Convex | — | — | — |
| and convexity | shape | shape | | | |
| of structures | | | | | |
| Structure | One | One | — | — | — |
| forming | surface | surface | | | |
| surface | | | | | |
| Pitch (mm) | 240 | 270 | — | — | — |
| Height (nm) | 200 | 170 | — | — | — |
| Aspect ratio | 0.8 | 0.6 | — | — | — |
| Mean film | 40 | 30 | — | — | — |
| thickness (nm) | | | | | |
| Surface | 300.0 | 300 | 250 | 400 | 500 |
| resistance | | | | | |
| (Ω/□) | | | | | |

The following can be found from FIG. 43.

In Examples 11 and 12 in which the transparent conductive layers are deposited on the structures, transmission characteristics within the wavelength band of 400 nm to 800 nm are more excellent than those of Comparative Example 7 in which the transparent conductive layer is deposited on the smooth sheet.

Transmission characteristics of Comparative Examples 8 and 9 each having a multilayer structure are excellent up to the wavelength of about 500 nm, but transmission characteristics of Examples 11 and 12 in which the transparent conductive layers are deposited on the structures are more excellent than those of Comparative Examples 8 and 9 each having a multilayer structure in the entire wavelength band of 400 nm to 800 nm.

<5. Relationship Between Structure and Optical Characteristics>

### Example 13

A hexagonal lattice pattern was recorded onto a resist layer by adjusting a frequency of a polarity reversion formatter signal, an rpm of a roll, and a feeding pitch for each track and patterning the resist layer. An IZO film having a mean film thickness of 20 nm was formed on the structures. Other than that, an optical sheet was produced by the same method as in Example 1.

An optical sheet was produced by the same method as in Example 1 except that a hexagonal lattice pattern was recorded onto a resist layer by adjusting a frequency of a polarity reversion formatter signal, an rpm of a roll, and a feeding pitch for each track and patterning the resist layer.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 5.

(Surface Resistance Evaluation)

A surface resistance of the conductive optical sheets produced as described above was measured by a four-terminal method (JIS K 7194). The results are shown in Table 5.

(Reflectance/Transmittance Evaluation)

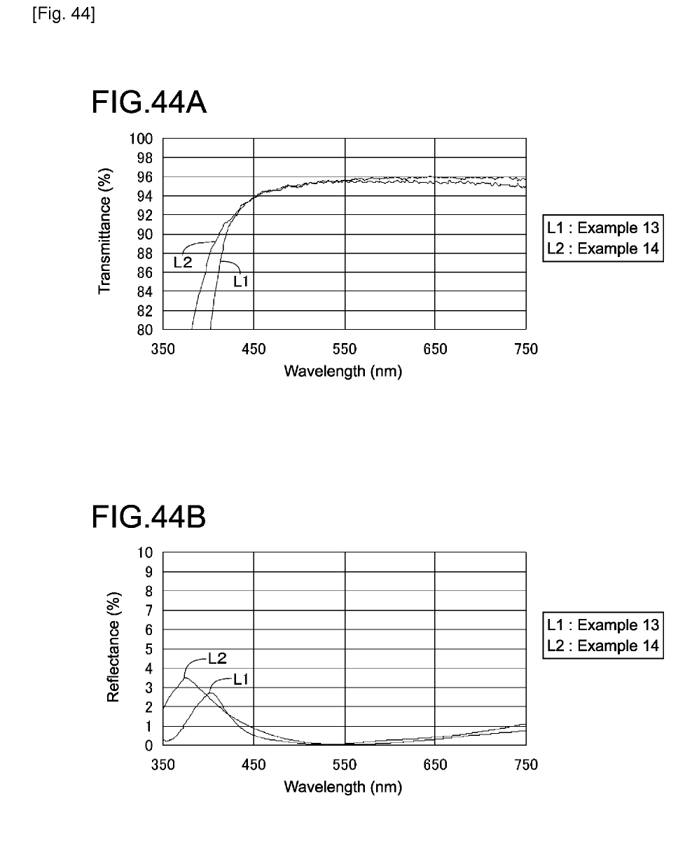

A reflectance and transmittance of the conductive optical sheets produced as described above were evaluated using an evaluation apparatus (V-550) available from JASCO Corporation. The results are shown in FIGS. 44A and 44B.

TABLE 5

| | Example 13 | Example 14 |
|---|---|---|
| Arrangement pattern | Hexagonal lattice | Hexagonal lattice |
| Structure shape | Cone shape | Cone shape |
| Concavity and convexity | Convex shape | Convex shape |
| of structures | | |
| Structure forming | One surface | One surface |
| surface | | |
| Pitch (mm) | 300 | 240 |
| Height (nm) | 200 | 200 |
| Aspect ratio | 0.67 | 0.83 |
| Mean film thickness (nm) | 20 | 30 |
| Surface resistance (Ω/□) | 550 | 550 |

It should be noted that in Table 5, a conic shape refers to an elliptic cone shape having a curved apex portion.

The following can be found from FIGS. 44A and 44B.

By lowering an aspect ratio, it is possible to suppress deterioration of the optical characteristics on the shorter-wavelength side with respect to 450 nm. Since the transmission characteristics are improved, it is presumed that absorption characteristics are improved.

<6. Relationship Between Shape and Optical Characteristics of Transparent Conductive Layer>

### Example 15

A conductive optical sheet was produced by the same method as in Example 14 except that the mean film thickness of the IZO film was set to be 30 nm.

### Comparative Example 10

An optical sheet was produced by the same method as in Example 15 except that the deposition of an IZO film was omitted.

### Example 16

A conductive optical sheet was produced by the same method as in Example 12 except that the mean film thickness of the IZO film was set to be 20 nm.

### Comparative Example 11

An optical sheet was produced by the same method as in Example 16 except that the deposition of an IZO film was omitted.

### Example 17

The concavities and convexities of Example 4 were inversed. A conductive optical sheet in which a mean film thickness of an IZO film is 30 nm was produced. Processes other than that were performed by the same method as in Example 4, and a conductive optical sheet in which a plurality of concave structures (structures of reverse pattern) are formed on a surface was produced.

### Comparative Example 12

An optical sheet was produced by the same method as in Example 17 except that the deposition of an IZO film was omitted.

### Example 18

An optical sheet in which an IZO film having a mean film thickness of 30 nm is formed on structures whose change ratio of a curved line of the cross-sectional profile is varied was produced.

### Comparative Example 13

An optical sheet was produced by the same method as in Example 18 except that the deposition of an IZO film was omitted.

(Shape Evaluation)

A surface configuration of the optical sheets was observed by an AFM (Atomic Force Microscope) in a state where an IZO film is not deposited. After that, heights and the like of the structures of the examples were obtained from a cross-sectional profile of the AFM. The results are shown in Table 6.

(Surface Resistance Evaluation)

A surface resistance of the conductive optical sheets produced as described above was measured by a four-terminal method (JIS K 7194). The results are shown in Table 6.

(Evaluation of Transparent Conductive Layer)

The optical sheet was cut in a cross-sectional direction of the conductive film formed on the structures, and a cross-sectional image of the structures and conductive film adhering thereto was observed using a TEM (Transmission Electron Microscope).

(Reflectance Evaluation)

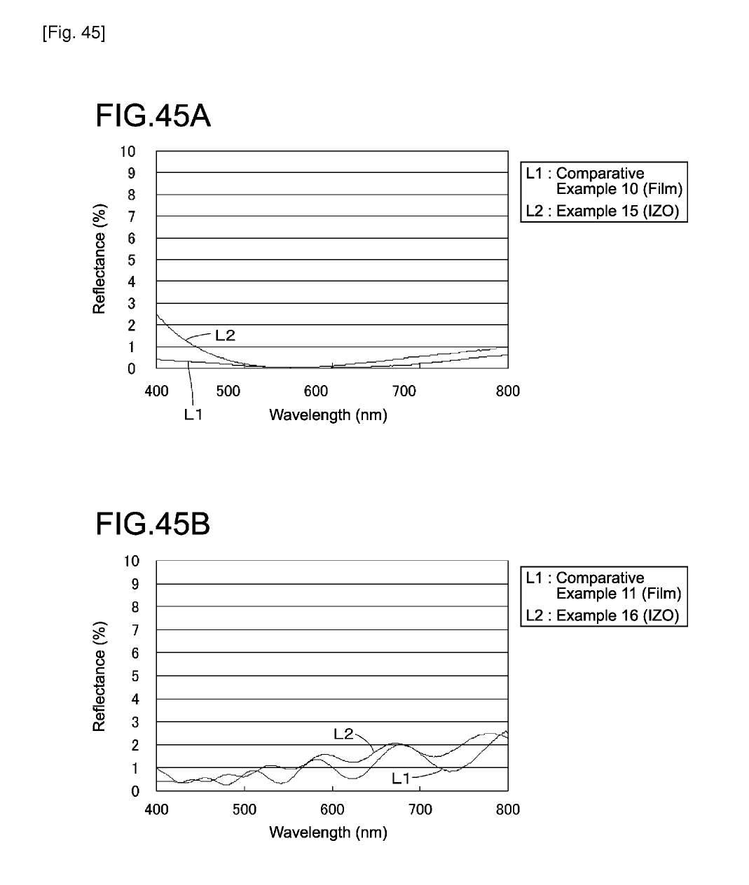

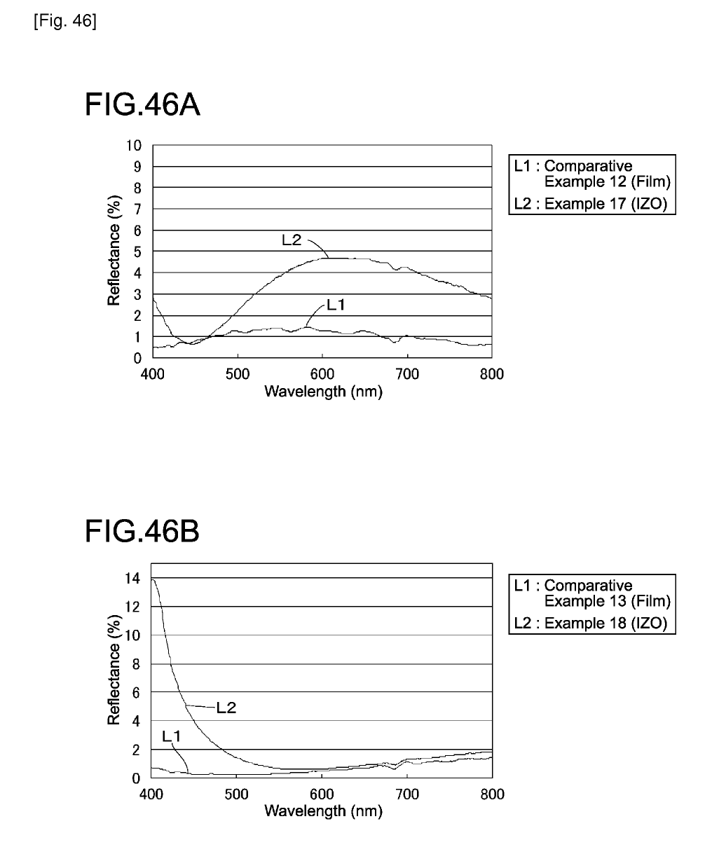

A reflectance of the conductive optical sheets produced as described above was evaluated using an evaluation apparatus (V-550) available from JASCO Corporation. The results are shown in FIGS. 45A to 46B.

TABLE 6

| | | Comparative | | Comparative | | Comparative | | Comparative |
|---|---|---|---|---|---|---|---|---|
| | Example | Example | Example | Example | Example | Example | Example | Example |
| | 15 | 10 | 16 | 11 | 17 | 12 | 18 | 13 |
| Arrangement pattern | Hexagonal | Hexagonal | Hexagonal | Hexagonal | Hexagonal | Hexagonal | Hexagonal | Hexagonal |
| | lattice | lattice | lattice | lattice | lattice | lattice | lattice | lattice |
| Structure shape | Cone | Cone | Cone | Cone | Cone | Cone | S-shaped | S-shaped |
| | shape | shape | shape | shape | shape | shape | refractive | refractive |
| | | | | | | | index | index |
| | | | | | | | profile | profile |
| Concavity and convexity | Convex | Convex | Convex | Convex | Concave | Concave | Convex | Convex |
| of structures | shape | shape | shape | shape | shape | shape | shape | shape |
| Structure forming | One | One | One | One | One | One | One | One |
| surface | surface | surface | surface | surface | surface | surface | surface | surface |
| Pitch (mm) | 240 | 240 | 270 | 270 | 250 | 250 | 250 | 250 |
| Height (nm) | 200 | 200 | 170 | 170 | 300 | 300 | 200 | 200 |
| Aspect ratio | 0.83 | 0.83 | 0.6 | 0.6 | 1.2 | 1.2 | 0.8 | 0.8 |
| Mean film thickness | 30 | — | 20 | — | 30 | — | 30 | — |
| (nm) | | | | | | | | |
| Surface resistance | 550 | — | 400 | — | 500 | — | 500 | — |
| (Ω/□) | | | | | | | | |

It should be noted that in Table 6, a conic shape refers to an elliptic cone shape having a curved apex portion.

The following can be found from the shape evaluation and the reflectance evaluation of the transparent conductive layer.

It was found that in Example 15, a mean film thickness D1 at a tip end portion of each structure, a mean film thickness D2 at a slanted surface of the structure, and a mean film thickness D3 between bottom portions of the structures have the following relationship.

D1(=38 nm)>D3(=21 nm)>D2(=14 nm to 17 nm)

Since IZO has a refractive index of about 2.0, only the tip end portion of the structure has an increased effective ‘index. Accordingly, the reflectance is increased by the deposition of the IZO film as shown in FIG. 45A.

It was found in Example 16 that the IZO film is deposited on the structures almost uniformly. Accordingly, a change in the reflectance before and after the deposition is small as shown in FIG. 45B.

It was found in Example 16 that the mean film thickness of the bottom portion of the concave structures and the top portion of the concave structures is markedly larger than those of other portions. In particular, it was found that the IZO film is prominently large mean film thickness at the top portion. In such a deposition state, the change in the reflectance tends to show a complicated behavior as shown in FIG. 46A and also tends to increase.

It was found in Example 17 that similar to Example 15, the mean film thickness D1 at the tip end portion of the structure, the mean film thickness D2 at the slanted surface of the structure, and the mean film thickness D3 between bottom portions of the structures have the following relationship.

D1(=36 nm)>D2(=20 nm)>D3(=18 nm)

However, the reflectance tends to increase sharply when the wavelength is shorter than about 500 nm. This is considered to be because the tip end portion of the structure is flat and an area of the tip end portion is large.

Accordingly, there is a tendency that the transparent conductive layer adheres less to a precipitous slanted surface and adheres more to a flatter surface.

Further, when film is deposited uniformly over the entire structures, the change in optical characteristics before and after the deposition tends to be small.

Furthermore, the transparent conductive layer tends to adhere to the entire structures more uniformly as the structures have a configuration closer to a free-form surface.

<7. Relationship Among Filling Rate, Diameter Ratio, and Reflectance Characteristics>

Next, a relationship between a ratio (2r/P1)*100) and anti-reflection characteristics was discussed by an RCWA (Rigorous Coupled Wave Analysis) simulation.

### Experimental Example 1

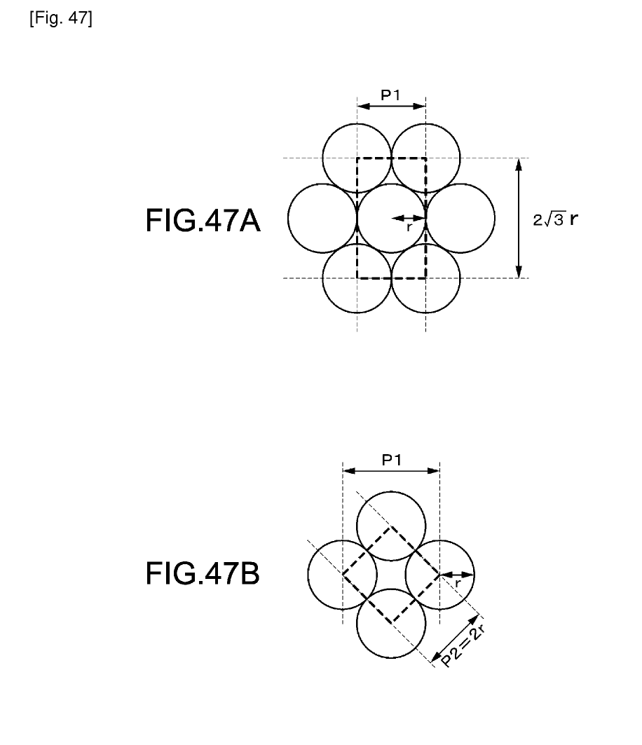

FIG. 47A is a diagram for explaining a filling rate at a time the structures are arranged in a hexagonal lattice pattern. A filling rate obtained when a ratio ((2r/P1)*100) (P1: arrangement pitch of structures in the same track, r: radius of bottom surface of structure) is changed in a case where the structures are arranged in a hexagonal lattice pattern as shown in FIG. 47A was obtained by Expression (2) below.

Filling rate=(S(hex.)/S(unit))*100 (2)

Unit cell area: S(unit)=2r*(2√3)r

Area of bottom surfaces of structures within unit cell: S(hex.)=2*πr2

(provided that filling rate is obtained from drawings when 2r>P1)

For example, when the arrangement pitch P1 is 2 and a radius r of a bottom surface of a structure is 1, S(unit), S(hex.), a ratio ((2r/P1)*100), and a filling rate take the following values.

S(unit)=6.9282

S(hex.)=6.28319

(2r/P1)*100=100.0%

Filling rate=(S(hex.)/S(unit))*100=90.7%

Table 7 shows a relationship between the filling rate and the ratio ((2r/P1)*100) obtained by Expression (2) above.

TABLE 7

| (2r/P1) × 100 | Filling rate |
|---|---|
| 115.4% | 100.0% |
| 100.0% | 90.7% |
| 99.0% | 88.9% |
| 95.0% | 81.8% |
| 90.0% | 73.5% |
| 85.0% | 65.5% |
| 80.0% | 58.0% |
| 75.0% | 51.0% |

### Experimental Example 2

FIG. 47B is a diagram for explaining a filling rate at a time the structures are arranged in a tetragonal lattice pattern. A filling rate obtained when a ratio ((2r/P1)*100) and a ratio ((2r/P2)*100) (P1: arrangement pitch of structures in the same track, P2: arrangement pitch in 45-degree direction with respect to track, r: radius of bottom surface of structure) is changed in a case where the structures are arranged in a tetragonal lattice pattern as shown in FIG. 47B was obtained by Expression (3) below.

Filling rate=(S(tetra.)/S(unit))*100 (3)

Unit cell area: S(unit)=2r*2r

Area of bottom surfaces of structures within unit cell: S(tetra)=πr2

(provided that filling rate is obtained from drawings when 2r>P1)

For example, when the arrangement pitch P2 is 2 and a radius r of a bottom surface of a structure is 1, S(unit), S(tetra), a ratio ((2r/P1)*100), a ratio ((2r/P1)*100), and a filling rate take the following values.

S(unit)=4

S(tetra)=3.14159

(2r/P1)*100=70.7%

(2r/P2)*100=100.0%

Filling rate=(S(tetra)/S(unit))*100=78.5%

Table 8 shows a relationship among the filling rate, the ratio ((2r/P1)*100), and the ratio (2r/P2)*100 obtained by Expression (3) above.

Further, a relationship between the arrangement pitches P1 and P2 of the tetragonal lattice becomes P1=∞2*P2.

TABLE 8

| (2r/P1) × 100 | (2r/P2) × 100 | Filling rate |
|---|---|---|
| 100.0% | 141.4% | 100.0% |
| 84.9% | 120.0% | 95.1% |
| 81.3% | 115.0% | 92.4% |
| 77.8% | 110.0% | 88.9% |
| 74.2% | 105.0% | 84.4% |
| 70.7% | 100.0% | 78.5% |
| 70.0% | 99.0% | 77.0% |
| 67.2% | 95.0% | 70.9% |
| 63.6% | 90.0% | 63.6% |
| 60.1% | 85.0% | 56.7% |
| 56.6% | 80.0% | 50.3% |
| 53.0% | 75.0% | 44.2% |

### Experimental Example 3

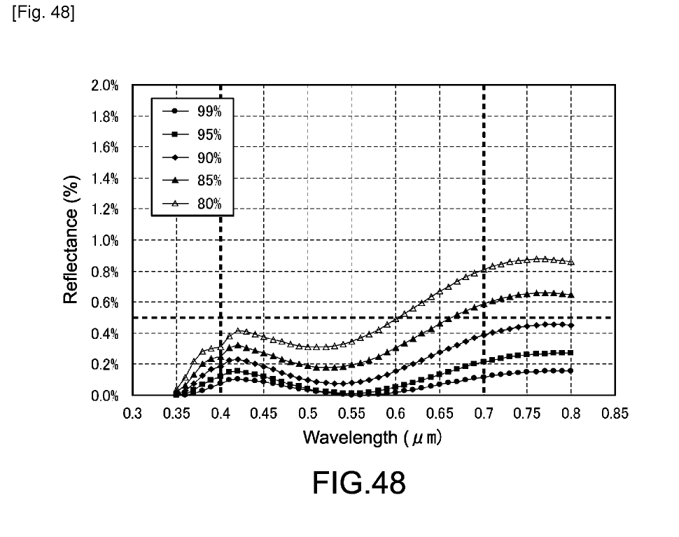

By setting the ratio ((2r/P1)*100) of a diameter 2r of the structure bottom surface with respect to the arrangement pitch P1 to be 80%, 85%, 90%, 95%, and 99%, a reflectance was obtained by simulations under the following conditions. FIG. 48 is a graph showing the results.

Shape of structure: Bell shape

Polarization: Absence

Refractive index: 1.48

Arrangement pitch P1: 320 nm

Height of structure: 415 nm

Aspect ratio: 1.30

Arrangement of structure: Hexagonal lattice

It can be seen from FIG. 48 that, with the ratio ((2r/P1)*100) of 85% or more, an average reflectance R is R<0.5% in a visible wavelength range (0.4 to 0.7 μm) and a sufficient anti-reflection effect is obtained. In this case, a filling rate of the bottom surface is 65% or more. With the ratio ((2r/P1)*100) of 90% or more, the average reflectance R is R<0.3% in the visible wavelength range and an anti-reflection effect with higher performance is obtained. In this case, the filling rate of the bottom surface is 73% or more, and the performance is increased as the filling rate becomes higher with the upper limit thereof as 100%. In a case where the structures overlap each other, the height of the structure is assumed to be a height from a lowest portion. Further, it was confirmed that tendencies of the filling rate and the reflectance were the same in the tetragonal lattice.

(Optical Characteristics of Touch Panel that uses Conductive Optical Sheet)

### Comparative Example 14

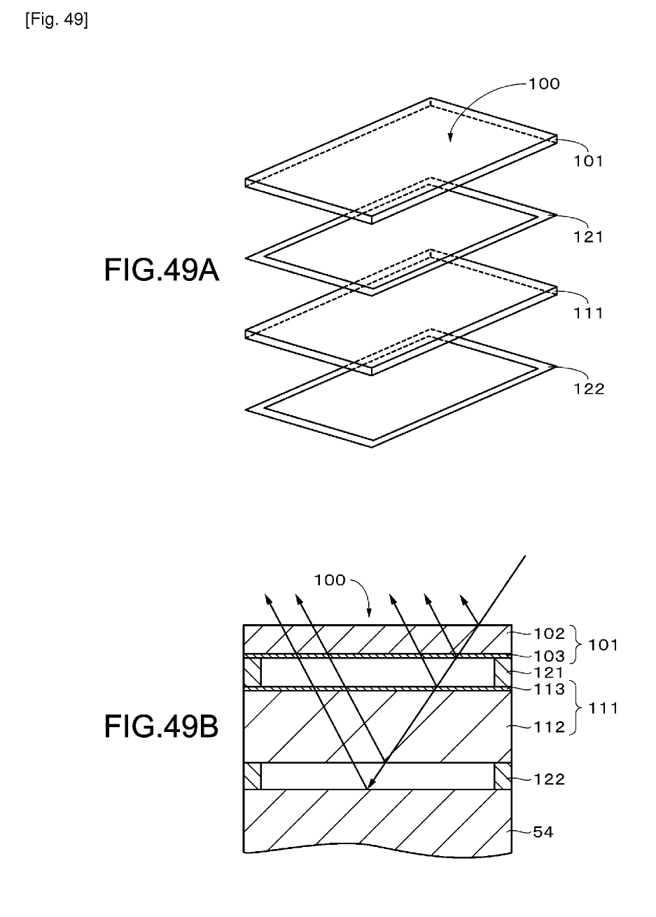

FIG. 49A is a perspective view showing a structure of a resistance-film-type touch panel of Comparative Example 14. FIG. 49B is a cross-sectional diagram showing the structure of the resistance-film-type touch panel of Comparative Example 14. It should be noted that arrows in FIG. 49B indicate incident light that enters the touch panel and reflecting light reflected on interfaces. It should be noted that arrows in cross-sectional diagrams showing the structure of the resistance-film-type touch panels of Comparative Examples 15 and 16 and Examples 19 to 22 to be described later indicate the same.

First, an ITO film 103 having a thickness of 26 nm was deposited on a main surface of a PET (Polyethylene terephthalate) film 102 by a sputtering method, with the result that a first conductive base material 101 to be a touch side was produced. Next, an ITO film 113 having a thickness of 26 nm was deposited on a main surface of a glass substrate 112 by the sputtering method, with the result that a second conductive base material 111 to be a display apparatus side was produced. Next, the first conductive base material 101 and the second conductive base material 111 were arranged so that the ITO films thereof were opposed to each other and an air layer was formed between the base materials, and circumferential portions of the base materials were bonded to each other by a pressure-sensitive adhesive tape 121. Thus, a resistance-film-type touch panel 100 was obtained.

(Reflectance/Transmittance Evaluation)

A reflectance of the resistance-film-type touch panel 100 obtained as described above was measured according to JIS-Z8722. Further, a transmittance of the resistance-film-type touch panel 100 attached to the liquid crystal display apparatus 54 was measured according to JIS-K7105.

(Visibility Evaluation)

Visibility of the resistance-film-type touch panel 100 obtained as described above was evaluated as follows. The resistance-film-type touch panel 100 was placed below a normal fluorescent lamp, a glare due to the fluorescent lamp was visually checked, and visibility was evaluated based on the following criteria.

a: Outline of fluorescent lamp is clear

b: Outline of fluorescent lamp is blurry to a certain extent

c: Outline of fluorescent lamp is unclear and reflecting light is obviously weak

d: Outline of fluorescent lamp cannot be seen and blurry light is reflected

### Comparative Example 15

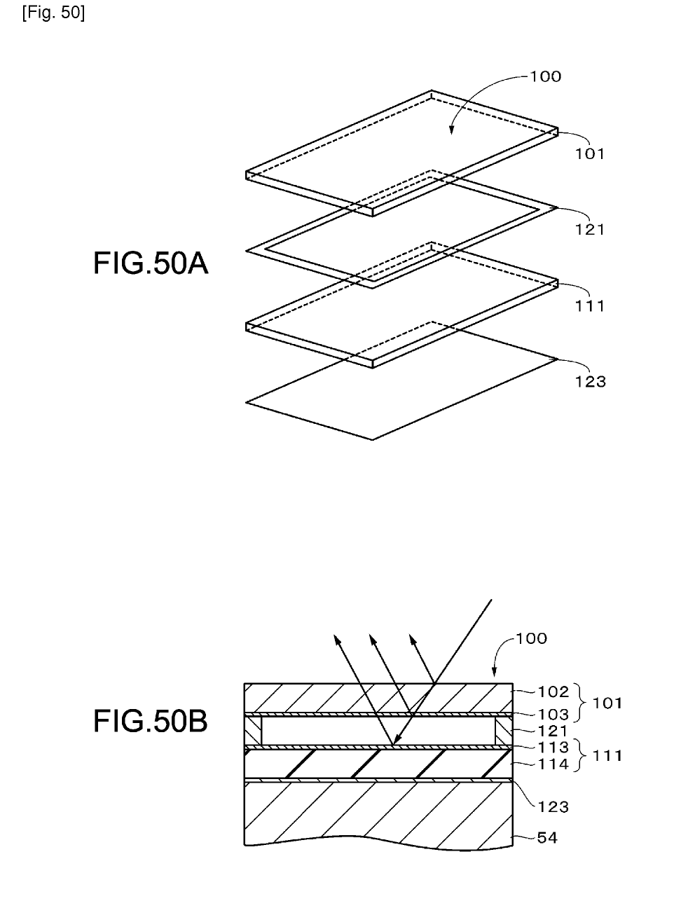

FIG. 50A is a perspective view showing a structure of a resistance-film-type touch panel of Comparative Example 15. FIG. 50B is a cross-sectional diagram showing the structure of the resistance-film-type touch panel of Comparative Example 15.

The resistance-film-type touch panel 100 was obtained by the same method of Comparative Example 1 except that a base material obtained by depositing an ITO film 113 having a thickness of 26 nm on a main surface of a PET (Polyethylene terephthalate) film 114 was used as the second conductive base material 111. Then, as in the case of Comparative Example 14, a reflectance/transmittance and visibility were evaluated.

### Comparative Example 16

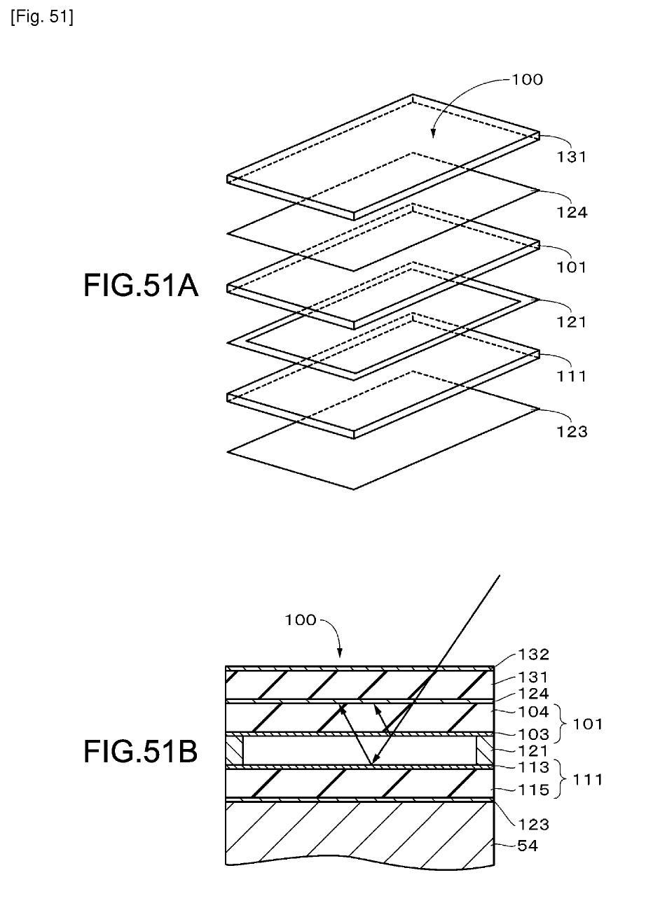

FIG. 51A is a perspective view showing a structure of a resistance-film-type touch panel of Comparative Example 16. FIG. 51B is a cross-sectional diagram showing the structure of the resistance-film-type touch panel of Comparative Example 16.

First, an ITO film 103 having a thickness of 26 nm was deposited on a main surface of a λ/4 phase difference film 104 by sputtering, to thereby produce a first conductive base material 101 to be a touch side. Next, an ITO film 113 having a thickness of 26 nm was deposited on a main surface of a λ/4 phase difference film 115 by a sputtering method, to thereby produce a second conductive base material 111 to be a display apparatus side. Next, the first conductive base material 101 and the second conductive base material 111 were arranged so that the ITO films thereof were opposed to each other and an air layer was formed between both the base materials, and circumferential portions of the base materials were attached to each other by a pressure-sensitive adhesive tape 121.

Next, a polarizer 131 having a main surface on which an AR (Anti-reflection) layer 132 is formed was prepared, and the polarizer 131 was attached to a touch surface side of the first conductive base material 101 via a pressure-sensitive adhesive tape 124. In this case, a position of the polarizer 131 was adjusted so that transmission axes of the polarizer 131 and a polarizer provided on a display surface side of the liquid crystal display apparatus 54 became parallel to each other. Thus, a resistance-film-type touch panel 100 was obtained. Next, as in the case of Comparative Example 14, a reflectance/transmittance and visibility were evaluated.

### Comparative Example 19

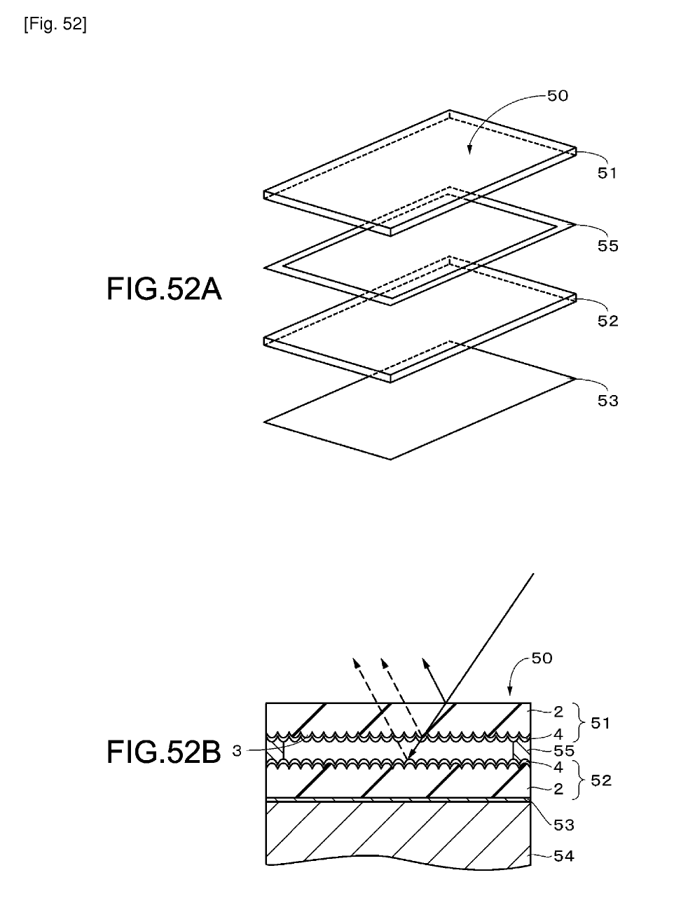

FIG. 52A is a perspective view showing a structure of a resistance-film-type touch panel of Example 19. FIG. 52B is a cross-sectional diagram showing the structure of the resistance-film-type touch panel of Example 19.

An optical sheet 2 was obtained by the same method as in Comparative Example 1 except that conditions on the exposure and etching were adjusted so that a plurality of structures 3 having the following structure were formed. It should be noted that a PET film was used as a film to become a substrate.

Arrangement pattern: Hexagonal lattice

Concavity and convexity of structure: Convex shape

Structure forming surface: One surface

Pitch P1: 270 nm

Pitch P2: 270 nm

Height: 160 nm

It should be noted that the pitch, height, and aspect ratio of the structures 3 are obtained from the observation results using the AFM (Atomic Force Microscope).

Next, an ITO film 4 having a mean film thickness of 26 nm was deposited by a sputtering method on a main surface of the optical sheet 2 on which the plurality of structures 3 are formed, to thereby produce a first conductive base material 51. Next, a second conductive base material 52 was obtained by the same method as in the case of producing the first conductive base material 51 except that the PET film was used. Then, the first conductive base material 51 and the second conductive base material 52 were arranged so that the ITO films thereof were opposed to each other and an air layer was formed between both the base materials, and circumferential portions of both the base materials were attached to each other by a pressure-sensitive adhesive tape 55. Thus, a resistance-film-type touch panel 50 was obtained. Subsequently, a reflectance/transmittance and visibility were evaluated as in Comparative Example 14.

### Example 20

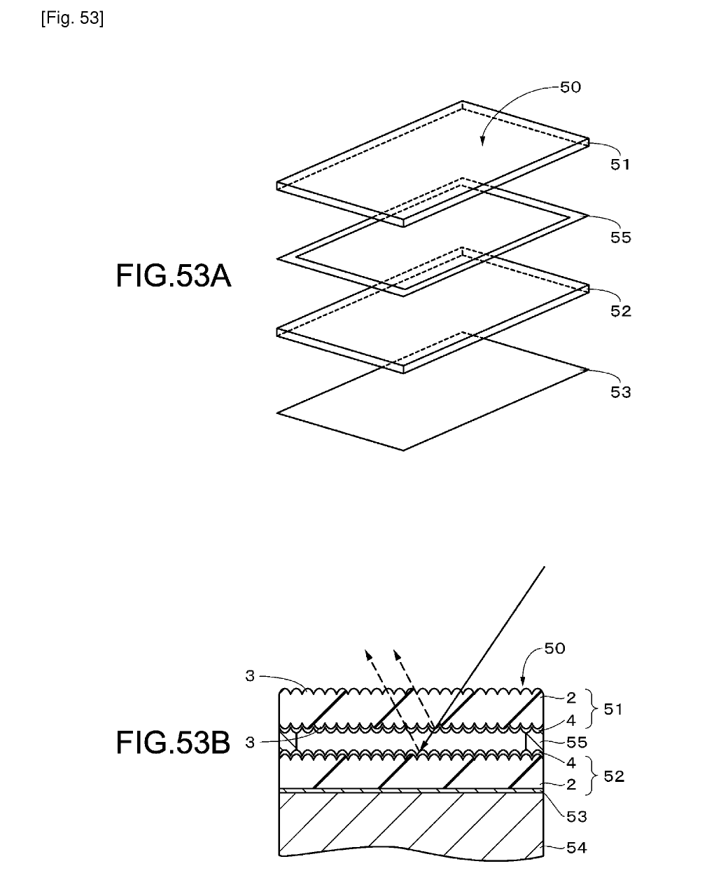

FIG. 53A is a perspective view showing a structure of a resistance-film-type touch panel of Example 20. FIG. 53B is a cross-sectional diagram showing the structure of the resistance-film-type touch panel of Example 20.

First, as in Example 19, an optical sheet 51 having a main surface on which a plurality of structures are arranged was formed. Next, in the same manner, a plurality of structures 3 were formed on the other main surface of the optical sheet 51. Accordingly, the optical sheet 2 having both main surfaces on which the plurality of structures 3 are formed was produced. Thus, a resistance-film-type touch panel 50 was obtained by the same method as in Example 19 except that the first conductive base material 51 was produced using the optical sheet 2. Subsequently, a reflectance/transmittance and visibility were evaluated as in Comparative Example 14.

### Example 21

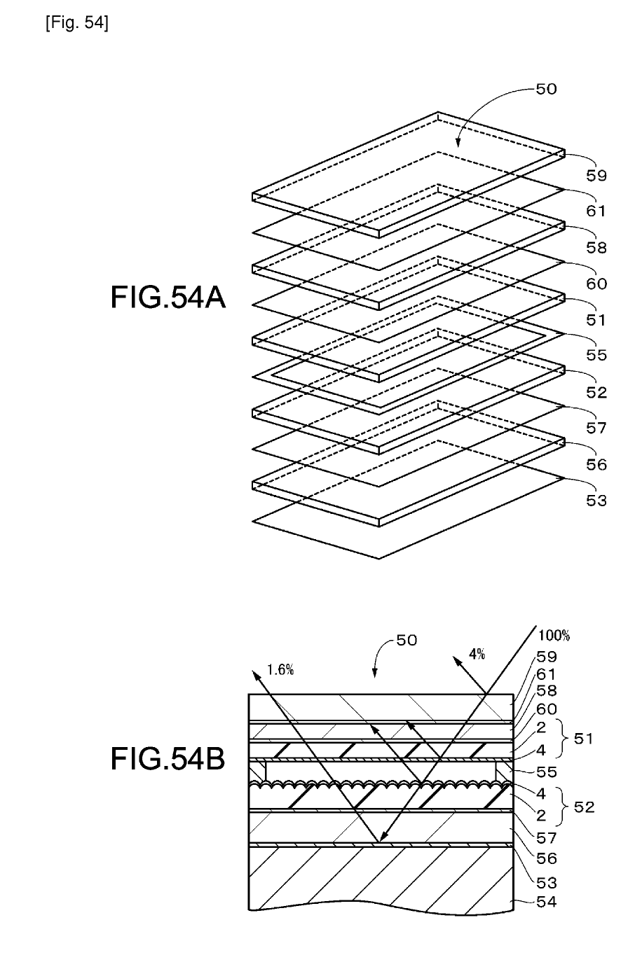

FIG. 54A is a perspective view showing a structure of a resistance-film-type touch panel of Example 21. FIG. 54B is a cross-sectional diagram showing the structure of the resistance-film-type touch panel of Example 21.

First, an ITO film 4 having a thickness of 26 nm was deposited on a main surface of a λ/4 phase difference film 2 by a sputtering method, to thereby produce a first conductive base material 51 to be a touch side. Next, a second conductive base material 52 was produced as in the case of Example 19 except that the 214 phase difference film 2 was used as a film to become a substrate. Next, the first conductive base material 51 and the second conductive base material 52 were arranged so that the ITO films thereof were opposed to each other and an air layer was formed between both the base materials, and circumferential portions of both the base materials were attached to each other by a pressure-sensitive adhesive tape 55. A polarizer 58 was attached to the surface of the first conductive base material 51 on the touch side via a pressure-sensitive adhesive tape 60, and then a top plate (front surface member) 59 was attached on the polarizer 58 via pressure-sensitive adhesive tape 61. Next, a glass substrate 56 was attached to the second conductive base material 52 via a pressure-sensitive adhesive tape 57. Thus, a resistance-film-type touch panel 50 was obtained. Next, a reflectance/transmittance and a visibility were evaluated as in Comparative Example 14.

### Example 22

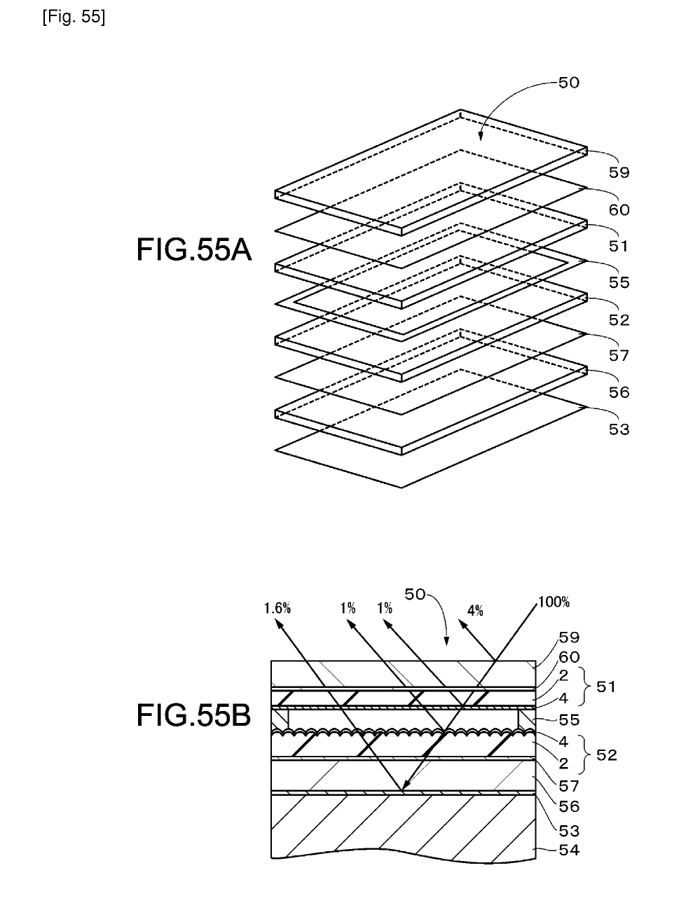

FIG. 55A is a perspective view showing a structure of a resistance-film-type touch panel of Example 22. FIG. 55B is a cross-sectional diagram showing the structure of the resistance-film-type touch panel of Example 22.

A resistance-film-type touch panel 50 was obtained by the same method as in Example 19 except that, out of the two opposed surfaces of the first conductive base material 51 and the second conductive base material 52, only the opposed surface of the second conductive base material 52 was formed with the plurality of structures 3. Next, a top plate (front surface member) 59 was attached to a surface to become a touch side of the resistance-film-type touch panel 50 via a pressure-sensitive adhesive tape 60, and thereafter a glass substrate 56 was attached to the second conductive base material 52 via a pressure-sensitive adhesive tape 57. Subsequently, a reflectance/transmittance and visibility were evaluated as in Comparative Example 14.

Table 9 shows evaluation results of the touch panels of Comparative Examples 14 to 16 and Examples 19 to 22.

TABLE 9

| | Structure of | | Reflectance | Transmittance |
|---|---|---|---|---|
| | touch panel | Visibility | [%] | [%] |
| Comparative | F/G | a | 19 | 85(85) |
| Example 14 | | | | |
| Comparative | F/F | a | 15 | 82(82) |
| Example 15 | | | | |
| Comparative | AR/Po/Re/Re | d | ~1 | 40(80) |
| Example 16 | | | | |
| Example 19 | MF/MF | c | 6 | 92(92) |
| Example 20 | BMF/MF | d | 2 | 92(92) |
| Example 21 | TP/Po/Re/MRe | c | 6 | 84 |
| Example 22 | TP/F/MF | b | 10 | 90 |

F: PET film
G: Glass substrate
AR: AR layer
Po: Polarizer
Re: λ/4 phase difference film
MF: Moth-eye film having moth-eye structure on one surface
BMF: Moth-eye film having moth-eye structure on both surfaces
TP: Top plate
MRe: λ/4 phase difference film having moth-eye structure on one surface
a: Fairly poor visibility regardless of state of external light
b: Poor visibility depending on state of external light
c: Good visibility with small amount of external light
d: Favorable visibility regardless of state of external light

It should be noted that reflectances and transmittances shown in Table 9 are transmittances corrected in terms of sunlight and reflectances in terms of luminous reflectance after the measurement of all wavelengths from 380 nm to 780 nm.

The following can be found from Table 9.

In Example 19 in which the plurality of structures 3 are formed on the opposed surfaces of the first and second conductive base materials 51 and 52, a reflectance can be reduced largely and a transmittance can be increased largely as compared to Comparative Examples 14 and 15 in which the moth-eye structures 3 as described above are not formed on the opposed surfaces.

In Example 20 in which the plurality of structures 3 are formed on both surfaces of the first conductive base material 51 to become a touch side, a reflectance can be reduced without causing a significant reduction of a transmittance as in Comparative Example 16 in which the polarizer 131 and the AR layer 132 are laminated on the surface of the touch side.

In Example 21 in which the polarizer 58 is arranged on the surface of the first conductive base material 51 to be the touch side, a reflectance can be reduced as compared to Example 22 in which the polarizer 58 is not arranged on the surface of the first conductive base material 51 to be the touch side.

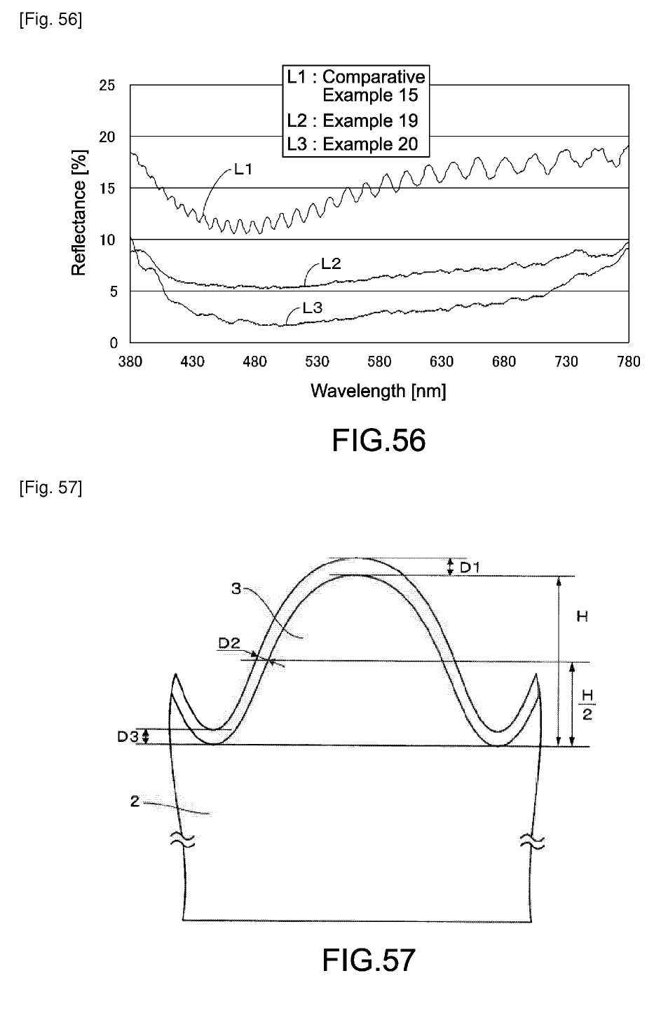

FIG. 56 is a graph showing reflection characteristics of the resistance-film-type touch panels of Examples 19 and 20 and Comparative Example 15. The following can be found from FIG. 56.

In Examples 19 and 20 in which the plurality of structures 3 are formed on the opposed surfaces of the first and second conductive base materials 51 and 52, a reflectance in a wavelength range of 380 nm to 780 nm can be reduced as compared to Comparative Example 15 in which the moth-eye structures 3 as described above are not formed on the opposed surfaces.

Specifically, low reflectance characteristics of 6% or lower can be realized in a wavelength of 550 nm at which a human luminosity factor is highest in Examples 19 and 20, whereas low reflectance characteristics of only about 15% are obtained in a wavelength of 550 nm in Comparative Example 15.

Wavelength dependency in Examples 19 and 20 is smaller than that in Comparative Example 15. In particular, in Example 20 in which the plurality of structures 3 are formed on both main surfaces of the first conductive base material 51 to become the touch side, the wavelength dependency is small and the reflection characteristics are almost flat in the wavelength range of 380 nm to 780 nm.

<9. Improvement of Adhesiveness by Moth-Eye Structures>

### Example 23

A conductive optical sheet was produced by the same method as in Example 1 except that the conditions on the exposure step and the etching step were adjusted and the structures having the following structure were arranged in a hexagonal lattice pattern.

Height H: 240 nm

Arrangement pitch P: 220 nm

Aspect ratio (H/P): 1.09

### Example 24

A conductive optical sheet was produced by the same method as in Example 1 except that the conditions on the exposure step and the etching step were adjusted and the structures having the following structure were arranged in a hexagonal lattice pattern.

Height H: 170 nm

Arrangement pitch P: 270 nm

Aspect ratio (H/P): 0.63

### Comparative Example 17

A conductive optical sheet was produced by sequentially laminating a hard coat layer and an ITO film on a PET film.

### Comparative Example 18

A conductive optical sheet was produced by sequentially laminating a hard coat layer containing a filler and an ITO film on a PET film.

(Adhesiveness Evaluation)

After a silver past is applied onto an electrode surface of the conductive optical sheet produced as described above, the silver paste was calcined for 30 minutes under an environment of 130° C. Next, a peel-off test of a cross-cut tape was carried out. A polyimide tape having high adhesiveness was used as the tape. Results of the test are shown in Table 10.

TABLE 10

| | | | Comparative | Comparative |
|---|---|---|---|---|
| | Example 23 | Example 24 | Example 17 | Example 18 |
| Peeled-off | 0/25 | 0/25 | 5/25~6/25 | 18/25~24/25 |
| amount | | | | |
| (Out of 25) | | | | |
| Full light beam | 96% | 95% | 90% | 87% |
| transmittance | | | | |

The following can be found from Table 10.

It is found that the tape is not peeled off in Examples 23 and 24. In contrast, five to six squares are peeled off in Comparative Example 17, and 18 to 24 squares in Comparative Example 18.

While a high transmittance of 95 to 96% is obtained in Examples 23 and 24, only a transmittance of 87 to 90% is obtained in Comparative Examples 17 and 18.

As described above, by forming the moth-eye structures on the entire surface of the film as the substrate, it is possible to realize a transparent conductive layer that has excellent adhesiveness with respect to a wiring material such as a conductive paste and a high transmittance. Further, by forming the moth-eye structures, an improvement in adhesiveness with respect to a pressure-sensitive adhesive such as a pressure-sensitive adhesive paste, an insulating material such as an insulating paste, a dot spacer, and the like can be expected.

Numerical values, configurations, materials, and structures used in the embodiments and examples described above are mere examples, and numerical values, configurations, materials, and structures that are different from those above may be used as appropriate.

Further, the structures of the embodiments described above can be used in combination.

Further, the optical device 1 may further include a low refractive index layer on the concavo-convex surface on the side on which the structures 3 are formed in the embodiments described above. The low refractive index layer desirably includes, as a main component, a material having a refractive index lower than the materials constituting the substrate 2, the structure 3, and the protrusion 5. As the material of such a low refractive index layer, an organic material such as a fluorine-based resin or an inorganic low refractive index material such as LiF and MgF2 is used, for example.

Further, in the embodiments described above, the optical device may be produced by thermal transfer. Specifically, a method of producing the optical device 1 by heating a substrate formed of a thermoplastic resin as a main component and pressing a seal (mold) such as the roll master 11 and the disk master 41 against the substrate that is sufficiently soft by the heat may be used.

Though examples applied to the resistance-film-type touch panel have been described in the embodiments described above, the embodiments are also applicable to a capacitance-type touch panel, an ultrasonic-type touch panel, an optical-type touch panel, and the like.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A conductive optical device comprising:
a base member; and
a transparent conductive film formed on the base member, a surface structure of the transparent conductive film including a plurality of convex portions having antireflective properties and arranged at a pitch equal to or smaller than a wavelength of visible light.

2. The conductive optical device according to claim 1, wherein the base member includes a plurality of convex structures that correspond to the convex portions of the transparent conductive film.

3. The conductive optical device according to claim 2, wherein the convex structures of the base member are configured to prevent light that has transmitted through the base member in a direction that is at least substantially perpendicular to the base member from being reflected at an interface between the convex structures and the transparent conductive film.

4. The conductive optical device according to claim 1, further comprising a conductive metal film formed between the base member and the transparent conductive film.

5. The conductive optical device according to claim 2, wherein an aspect ratio of the convex structures ranges from 0.2 to 1.78.

6. The conductive optical device according to claim 1, wherein a film thickness of the transparent conductive film ranges from 9 nm to 50 nm.

7. The conductive optical device according to claim 2, wherein a film thickness of the transparent conductive film at an apex portion of the convex structures is D1, a film thickness of the transparent conductive film at a slanted portion of the convex structures is D2, and a film thickness of the transparent conductive film between adjacent convex structures is D3, and D1, D2 and D3 satisfy the relationship that D1>D3>D2.

8. The conductive optical device according to claim 7, wherein D1 ranges from 25 nm to 50 nm, D2 ranges from 9 nm to 30 nm, and D3 ranges from 9 nm to 50 nm.

9. The conductive optical device according to claim 2, wherein an average arrangement pitch of the convex structures ranges from 110 nm to 280 nm.

10. The conductive optical device according to claim 2, wherein the convex structures are arranged so as to form a plurality of rows of tracks.

11. The conductive optical device according to claim 2, wherein the convex structures are arranged so as to form a hexagonal lattice pattern or a quasi-hexagonal lattice pattern.

12. The conductive optical device according to claim 10, wherein the convex structures have a pyramid shape or a pyramid shape that is elongated or contracted in a track direction.

13. The conductive optical device according to claim 12, wherein the pyramid shape is selected from the group consisting of a cone shape, a cone trapezoid shape, and elliptical cone shape, and an elliptical cone trapezoid shape.

14. The conductive optical device according to claim 2, wherein lower portions of adjacent convex structures are bonded together in an overlapping manner.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A method of producing a conductive optical device, the method comprising:
forming a base member including a plurality of convex structures; and
forming a transparent conductive film on the base member such that a surface structure of the transparent conductive film includes a plurality of convex portions corresponding to the convex structures of the base member,
wherein the convex structures have antireflective properties and arranged at a pitch equal to or smaller than a wavelength of visible light.

44. The method of producing a conductive optical device according to claim 43, wherein forming the base member includes:
providing a roll master having a plurality of concave structures;
applying a transfer material to a substrate;
bringing the substrate into contact with the roll master;
curing the transfer material; and
peeling the cured transfer material and substrate from the roll master,
wherein the concave structures of the roll master correspond to the convex structures of the base member.

45. A transparent conductive film having a surface structure including a plurality of convex portions having antireflective properties and arranged at a pitch equal to or smaller than a wavelength of visible light.

46. The transparent conductive film according to claim 45, wherein the transparent conductive film comprises at least one material selected from the group consisting of ITO, AZO, SZO, FTO, SnO2, GZO and IZO.

47. The transparent conductive film according to claim 45, further comprising a metal film as a base layer of the transparent conductive film.
